(19) United States
(12) Patent Application Publication
(10) Pub. No.: US 2012/0250771 A1
(43) Pub. Date: Oct. 4, 2012

(54) IMAGE PROCESSING APPARATUS AND METHOD AS WELL AS PROGRAM

(75) Inventor: Kenji Kondo, Tokyo (JP)

(73) Assignee: SONY CORPORATION, Tokyo (JP)

(21) Appl. No.: 13/515,467

(22) PCT Filed: Dec. 14, 2010
(86) PCT No.: PCT/JP2010/072435

§ 371 Date: Jun. 12, 2012

(30) Foreign Application Priority Data
Dec. 24, 2009 (JP) 2009-292902

(51) Int. Cl. H04N 7/32

(52) U.S. Cl. 375/240.16; 375/E07.027; 375/E07.124

(57) ABSTRACT

An image processing apparatus and method that can be applied to an image encoding apparatus that carries out encoding in accordance with, for example, a H.264/AVC method. A high-symmetry interpolation filter of variable filter coefficients has a number of pixels, to which symmetry determined in advance is applied, greater than that of a low-symmetry interpolation filter. The high-symmetry interpolation filter carries out a filter process for a reference image from a frame memory using filter coefficients calculated by a high-symmetry filter coefficient calculation portion and outputs the reference image after the variable filter process to a selector. The selector selects, when a slice of a processing object is a B slice, the reference image after the variable filter from the high-symmetry interpolation filter and outputs the selected image to a motion prediction second and a motion compensation portion under control of a control part.

### TECHNICAL FIELD

The present invention relates to an image processing apparatus and method and a program, and particularly to an image processing apparatus and method and a program which can reduce, in the case of a B slice, the overhead and improve the encoding efficiency.

### BACKGROUND ART

As standard specifications for compressing image information, H.264 and MPEG-4 Part 10 (Advanced Video Coding, hereinafter referred to as H.264/AVC) are available.

In H.264/AVC, inter prediction with attention paid to a correlation between frames or fields is carried out. And, in a motion compensation process carried out in the inter prediction, a prediction image (hereinafter referred to as inter prediction image) by the inter prediction is produced using part of a region of an image which is stored already and can be referred to.

For example, in the case where five frames of an image which are stored already and can be referred to are determined as reference frames as seen in FIG. 1, part of an inter prediction image of a frame (original frame) to be inter predicted is configured referring to part of an image (hereinafter referred to as reference image) of one of the five reference frames. It is to be noted that the position of part of the reference image to be used as the part of the inter prediction image is determined by a motion vector detected based on images of the reference frame and the original frame.

More particularly, as seen in FIG. 2, in the case where the face 11 in the reference frame moves in a rightwardly downward direction in the original frame and a lower portion of approximately ⅓ of the face 11 is hidden, a motion vector which represents a leftwardly upward direction opposite to the rightwardly downward direction is detected. Then, the part 12 of the face 11 which is hidden in the original frame is configured referring to part 13 of the face 11 in the reference frame at a position to which the part 12 is moved by a motion represented by the motion vector.

Further, in H.264/AVC, it is expected to enhance, in a motion compensation process, the resolution of the motion vector fractional accuracy such as ½ or ¼.

In such a motion compensation process in fractional accuracy as described above, a pixel at a virtual fractional position called Sub pel is set between adjacent pixels, and a process of producing such a Sub pel (hereinafter referred to as interpolation) is carried out additionally. In other words, in a motion compensation process in fractional accuracy, the minimum resolution of a motion vector is a pixel at a fractional position, and therefore, interpolation for producing a pixel at a fractional position is carried out.

FIG. 3 shows pixels of an image in which the number of pixels in the vertical direction and the horizontal direction is increased to four times by interpolation. It is to be noted that, in FIG. 3, a blank square represents a pixel at an integral position (Integer pel (Int. pel)), and a square to which slanting lines are applied represents a pixel at a fractional position (Sub pel). Further, an alphabetical letter in a square represents a pixel value of a pixel represented by the square.

Pixel values b, h, j, a, d, f and r of pixels at fractional positions produced by interpolation are represented by the expressions (1) given below.

b=(E−5F+20G+20H−5I+j)/32

h=(A−5C+20G+20M−5R+T)/32

j=(aa−5bb+20b+20s−5gg+hh)/32

a=(G+b)/2

d=(G+h)/2

f=(b+j)/2

r=(m+s)/2 (1)

It is to be noted that the pixel values aa, bb, s, gg and hh can be determined similarly to b; cc, dd, m, ee and ff similarly to h; the pixel value c can be determined similarly to a; the pixel values f, n and q can be determined similarly to d; and e, p and g similarly to r.

The expression (1) given above is expressions adopted in interpolation in H.264/AVC and so forth, and although the expressions differ depending upon differences in standard, the object of the expressions is same. The expressions can be implemented by a finite impulse response (FIR (Finit-duration Impulse Response)) filter having an even number of taps. For example, in H.264/AVC, an interpolation filter having six taps is used.

Meanwhile, in Non-Patent Documents 1 to 3, an adaptive interpolation filter (AIF) is listed in a recent research report. In a motion compensation process in which this AIF is used, by adaptively changing the filter coefficients of a FIR filter which are used in interpolation and have an even number of taps, the influence of aliasing or encoding distortion can be reduced to reduce errors in motion compensation.

AIF has some variations based on the difference of the filter structure. As a representative, a Separable adaptive interpolation filter (hereinafter referred to as Separable AIF) disclosed in Non-Patent Document 2 is described with reference to FIG. 4. It is to be noted that, in FIG. 4, a square to which slanting lines are applied represents a pixel at an integral position (Integer pel (Int. pel)), and a blank square represents a pixel at a fractional position (Sub pel). Further, an alphabetical letter in a square represents a pixel value of a pixel represented by the square.

In the Separable AIF, interpolation of non-integral positions in the horizontal direction is carried out as a first step, and interpolation in a non-integral direction in the vertical direction is carried out as a second step. It is to be noted that also it is possible to reverse the processing order for the horizontal and vertical directions.

First, at the first step, the pixel valves a, b and c of pixels at fractional positions are calculated in accordance with the following expression (2) from the pixel values E, F, G, H, I and J of pixels at integral positions by means of a FIR filter. Here, h[pos][n] is a filter coefficient, and pos represents the position of a sub pel shown in FIG. 3 while n represents the number of the filter coefficient. This filter coefficient is included in stream information and used on the decoding side.

a=h[a][0]×E+h1[a][1]×F+h2[a][2]×G+h[a][3]×H+h[a][4]×I+h[a][5]×J

b=h[b][0]×E+h1[b][1]×F+h2[b][2]×G+h[b][3]×H+h[b][4]×I+h[b][5]×J

c=h[c][0]×E+h1[c][1]×F+h2[c][2]×G+h[c][3]×H+h[c][4]×I+h[c][5]×J (2)

It is to be noted that also pixel values (a1, b1, c1, a2, b2, c2, a3, b3, c3, a4, b4, c4, a5, b5, c5) of pixels at fractional positions of a row of pixel values G1, G2, G3, G4, G5 can be determined similarly to the pixel values a, b, c.

Then, as the second step, the pixel values d to o other than the pixel values a, b, c are calculated in accordance with the following expressions (3).

d=h[d][0]×G1+h[d][1]×G2+h[d][2]×G+h[d][3]×G3+h[d][4]*G4+h[d][5]×G5

h=h[h][0]×G1+h[h][1]×G2+h[h][2]×G+h[h][3]×G3+h[h][4]*G4+h[h][5]×G5

l=h[l][0]×G1+h[l][1]×G2+h[l][2]×G+h[l][3]×G3+h[l][4]*G4+h[l][5]×G5

e=h[e][0]×a1+h[e][1]×a2+h[e][2]×a+h[e][3]×a3+h[e][4]*a4+h[e][5]×a5

j=h[j][0]×a1+h[j][1]×a2+h[j][2]×a+h[j][3]×a3+h[j][4]*a4+h[j][5]×a5

m=h[m][0]×a1+h[m][1]×a2+h[m][2]×a+h[m][3]×a3+h[m][4]*a4+h[m][5]×a5

f=h[f][0]×b1|h[f][1]×b2|h[f][2]×b|h[f][3]×b3|h[f][4]*b4|h[f][5]×b5

j=h[j][0]×b1+h[j][1]×b2+h[j][2]×b+h[j][3]×b3+h[j][4]*b4+h[j][5]×b5

n=h[n][0]×b1+h[n][1]×b2+h[n][2]×b+h[n][3]×b3+h[n][4]*b4+h[n][5]×b5

g=h[g][0]×c1+h[g][1]×c2+h[g][2]×c+h[g][3]×c3+h[g][4]*c4+h[c][5]×c5

k=h[k][0]×c1+h[k][1]×c2+h[k][2]×c+h[k][3]×c3+h[k][4]*c4+h[k][5]×c5

o=h[o][0]×c1+h[o][1]×c2+h[o][2]×c+h[o][3]×c3+h[o][4]*c4+h[o][5]×c5 (3)

It is to be noted that, while all of the filter coefficients in the method described above are independent of each other, the following expression (4) is indicated in Non-Patent Document 2.

a=h[a][0]×E+h1[a][1]×F+h2[a][2]×G+h[a][3]×H+h[a][4]×I+h[a][5]×J

b=h[b][0]×E+h1[b][1]×F+h2[b][2]×G+h[b][3]×H+h[b][1]×I+h[b][5]×J

c=h[c][0]×E+h1[c][1]×F+h2[c][2]×G+h[c][3]×H+h[c][4]×I+h[c][5]×J

d=h[d][0]×G1+h[d][1]×G2+h[d][2]×G+h[d][3]×G3+h[d][4]*G4+h[d][5]×G5

h=h[h][0]×G1+h[h][1]×G2+h[h][2]×G+h[h][2]×G3+h[h][4]*G4+h[h][0]×G5

l=h[d][5]×G1+h[d][4]×G2+h[d][3]×G+h[d][2]×G3+h[d][1]*G4+h[d][0]×G5

e=h[e][0]×a1|h[e][1]×a2|h[e][2]×a|h[e][3]×a3|h[e][4]*a4|h[e][5]×a5

j=h[j][0]×a1+h[j][1]×a2+h[j][2]×a+h[j][2]×a3+h[j][1]*a4+h[j][0]×a5

m=h[e][5]×a1+h[e][4]×a2+h[e][3]×a+h[e][2]×a3+h[e][1]*a4+h[e][0]×a5

f=h[f][0]×b1+h[f][1]×b2+h[f][2]×b+h[f][3]×b3+h[f][4]*b4+h[f][0]×b5

j=h[j][0]×b1+h[j][1]×b2+h[j][2]×b+h[j][2]×b3+h[j][1]*b4+h[j][0]×b5

n=h[f][5]×b1+h[f][4]×b2+h[f][3]×b+h[f][2]×b3+h[f][1]*b4+h[f][0]×b5

g=h[g][0]×c1+h[g][1]×c2+h[g][2]×c+h[g][3]×c3+h[g][4]*c4+h[g][5]×c5

k=h[k][0]×c1+h[k][1]×c2+h[k][2]×c+h[k][2]×c3+h[k][1]*c4+h[k][0]×c5

o=h[g][5]×c1+h[g][4]×c2+h[g][3]×c+h[g][2]×c3+h[g][1]*c4+h[g][0]×c5 (4)

For example, one filter coefficient h[b][3] for calculating the pixel value b is replaced with h[b][2]. In the case where all filter coefficients are fully independent of each other as in the former case, while the totaling number of filter coefficients is 90, the number of filter coefficients is decreased to 51 by the method of Non-Patent Document 2.

Although the AIF described above improves the performance of the interpolation filter, since the filter coefficients are included into stream information, an overhead exists, and according to circumstances, it may possibly occur that the encoding efficiency is deteriorated. Therefore, in Non-Patent Document 3, symmetry of filter coefficients is used to reduce filter coefficients to reduce the overhead. On the encoding side, it is investigated which Sub pel exhibits filter coefficients proximate to those of a different Sub pel, and the proximate filter coefficients are aggregated to one. A descriptor of the symmetry which indicates in what manner the filter coefficients are aggregated is placed into stream information and sent to the decoding side. On the decoding side, the descriptor of the symmetry is received, and it can be known in what manner the filter coefficients are aggregated.

Incidentally, in the H.264/AVC method, the macro block size is 16×16 pixels. However, to set the macro block size to 16×16 pixels is not optimum to such a large picture frame as that of UHD (Ultra High Definition: 400×2000 pixels) which becomes an object of the next generation encoding method.

Therefore, in Non-Patent Document 4 and so forth, it is proposed to expand the macro block size to such a great size as, for example, 32×32 pixels.

It is to be noted that the figures of the conventional technologies described above are suitably used for description of the invention of the present application.

### PRIOR ART DOCUMENTS

### Non-Patent Documents

Non-Patent Document 1: Yuri Vatis, Joern Ostermann, “Prediction of P-B-Frames Using a Two-dimensional Non-separable Adaptive Wiener Interpolation Filter for H.264/AVC,” ITU-T SG16 VCEG 30th Meeting, Hangzhou China, October 2066
Non-Patent Document 2: Steffen Wittmann, Thomas Wedi, “Separable adaptive inerpolation filte,” ITU-T SG16COM16-C219-E, June 2007
Non-Patent Document 3: Dmytro Rusanovskyy, et al., “Improvements on Enhanced Directional Adaptive Filtering (EDAIF-2),” COM 16-C125-E, January 2009
Non-Patent Document 4: “Video Coding Using Extended Block Sizes,” VCEG-AD09, ITU-Telecommunications Standardization Sector STURY GROUP Question 16-Contribution 123, January 2009

### SUMMARY OF INVENTION

### Technical Problems

As described above, if an AIF is used, then the filter coefficients of the interpolation filter can be changed in a unit of a slice. However, the filter coefficient information must be included in the stream information, and there is the possibility that the bit amount of the filter coefficient information may become an overhead and the encoding efficiency may be deteriorated.

Particularly to the B picture, the overhead becomes comparatively great. For example, in the case where, in regard to the picture types, the P picture is disposed at every two pictures in the order of B, P, B, P, B, P, . . . while the B picture is disposed between the P pictures, the amount of bits generated in the B picture is frequently small in comparison with the P picture. Although it is considered that this arises from the fact that, since a reference image which is small in temporal distance can be used or bidirectional prediction can be used, the picture quality of inter prediction of the B picture is enhanced, at any rate, the rate of the overhead of the B picture is greater than that of the P picture.

As a result, with the B picture, the effect of the AIF is restricted. In particular, although the performance of the interpolation filter is improved by the AIF, the overhead by the filter coefficient information becomes a load, and this increases an opportunity in which the encoding efficiency is lost.

Meanwhile, in the method disclosed in Non-Patent Document 3, while the number of filter coefficients can be adaptively varied, it is necessary for the encoding side to include a descriptor of symmetry into stream information in order to notify the decoding side of in what manner the number of filter coefficients varies. However, since also the descriptor of the symmetry becomes an overhead, this results in loss of the encoding efficiency.

Further, in the method disclosed in Non-Patent Document 3, the arithmetic operation amount increases. In particular, in order to grasp symmetry in regard to whether filter coefficients are similar or not, filter coefficients of sub pels are first calculated individually without assuming the symmetry, and the Euclidian distance between the filter coefficients of the sub pels is calculated. Further, when any value of the Euclidian distance is lower than a threshold value, in order to aggregate the filter coefficients, it is necessary to merge statistics information and calculate filter coefficients again. Therefore, the arithmetic operation amount increases in order to obtain a descriptor of symmetry and final filter coefficients.

The present invention has been made in view of such a situation as described above, and can reduce the overhead and improve the encoding efficiency.

### Technical Solutions

An image processing apparatus according to a first aspect of the present invention, includes: an interpolation filter for interpolating pixels of a reference image corresponding to an encoded image with fractional accuracy, the interpolation filter using, in the case where symmetry determined in advance is applied to a first pixel position of fractional accuracy and a second pixel position of fractional accuracy, the same filter coefficient as filter coefficients for determining a pixel at the first pixel position of the fractional accuracy and another pixel at the second pixel position of the fractional accuracy; decoding means for decoding the encoded image, a motion vector corresponding to the encoded image and filter coefficients of the interpolation filter; and motion compensation means for producing a predicted image using the reference image interpolated by the interpolation filter of the filter coefficients decoded by the decoding means and the motion vector decoded by the decoding means.

The image processing apparatus is capable of further including selection means for selecting, based on a kind of a slice of an image of an encoding object, pixel positions of the fractional accuracy at which same filter coefficients are to be individually used for pixels in a unit of a slice.

The interpolation filter can further use, as the filter coefficients for determining the pixel at the first pixel position of the fractional accuracy and the pixel at the second pixel position of the fractional accuracy, also filter coefficients reversed around a center position between the pixels at integral positions used by the interpolation filter.

In the case where different symmetry determined in advance and different from the first-mentioned symmetry is applied to the first pixel position of the fractional accuracy and the second pixel position of the fractional accuracy, the interpolation filter can further use, as the filter coefficients for determining the pixel at the first pixel position of the fractional accuracy and the pixel at the second pixel position of the fractional accuracy, also filter coefficients reversed around the center position between the pixels at the integral positions used by the interpolation filter.

The image processing apparatus is capable of further including storage means for storing determined filter coefficients; wherein in the case where a slice of the image of the encoding object is a slice which does not use the filter coefficients decoded by the decoding means, the interpolation filter uses the filter coefficients stored in the storage means and the motion compensation means uses the reference image interpolated by the interpolation filter of the filter coefficients stored in the storage means and the motion vector decoded by the decoding means to produce a predicted image.

The image processing apparatus is capable of further including arithmetic operation means for adding an image decoded by the decoding means and the predicted image produced by the motion compensation means to produce a decoded image.

An image processing method according to the first aspect of the present invention, includes the steps, carried out by an image processing apparatus, of: decoding an encoded image, a motion vector corresponding to the encoded image and filter coefficients of an interpolation filter which interpolates pixels of a reference image corresponding to the encoded image with fractional accuracy and uses, in the case where symmetry determined in advance is applied to a first pixel position of fractional accuracy and a second pixel position of the fractional accuracy, the same filter coefficient as filter coefficients for determining a pixel at the first pixel position of the fractional accuracy and another pixel at the second pixel position of the fractional accuracy; and producing a predicted image using the reference image interpolated by the interpolation filter of the decoded filter coefficients and the decoded motion vector.

A program, according to the first aspect of the present invention, causes a computer to function as: decoding means for decoding an encoded image, a motion vector corresponding to the encoded image and filter coefficients of an interpolation filter which interpolates pixels of a reference image corresponding to the encoded image with fractional accuracy and uses, in the case where symmetry determined in advance is applied to a first pixel position of fractional accuracy and a second pixel position of the fractional accuracy, the same filter coefficient as filter coefficients for determining a pixel at the first pixel position of the fractional accuracy and another pixel at the second pixel position of the fractional accuracy; and motion compensation means for producing a predicted image using the reference image interpolated by the interpolation filter of the filter coefficients decoded by the decoding means and the motion vector decoded by the decoding means.

An image processing apparatus according to a second aspect of the present invention, includes: motion prediction means for carrying out motion prediction between an image of an encoding object and a reference image to detect a motion vector; an interpolation filter for interpolating pixels of the reference image with fractional accuracy, the interpolation filter using, in the case where symmetry determined in advance is applied to a first pixel position of fractional accuracy and a second pixel position of the fractional accuracy, the same filter coefficient as filter coefficients for determining a pixel at the first pixel position of the fractional accuracy and another pixel at the second pixel position of the fractional accuracy; coefficient calculation means for calculating filter coefficients of the interpolation filter using the image of the encoding object, reference image and motion vector detected by the motion prediction means; and motion compensation means for producing a predicted image using the reference image interpolated by the interpolation filter of the filter coefficients calculated by the coefficient calculation means and the motion vector detected by the motion prediction means.

The image processing apparatus is capable of further including selection means for selecting, based on a kind of a slice of the image of the encoding object, pixel positions of the fractional accuracy at which same filter coefficients are to be individually used for pixels in a unit of a slice.

The interpolation filter can further use, as the filter coefficients for determining the pixel at the first pixel position of the fractional accuracy and the pixel at the second pixel position of the fractional accuracy, also filter coefficients reversed around a center position between the pixels at integral positions used by the interpolation filter.

The interpolation filter can further use, in the case where different symmetry determined in advance and different from the first-mentioned symmetry is applied to the first pixel position of the fractional accuracy and the second pixel position of the fractional accuracy, also filter coefficients reversed around the center position between the pixels at the integral positions used by the interpolation filter as the filter coefficients for determining the pixel at the first pixel position of the fractional accuracy and the pixel at the second pixel position of the fractional accuracy.

The image processing apparatus is capable of further including storage means for storing determined filter coefficients; wherein in the case where a slice of the image of the encoding object is a slice which does not use the filter coefficients calculated by the coefficient calculation means, the interpolation filter uses the filter coefficients stored in the storage means and the motion compensation means uses the reference image interpolated by the interpolation filter of the filter coefficients stored in the storage means and the motion vector detected by the motion prediction means to produce a predicted image.

The image processing apparatus is capable of further including: encoding means for encoding a difference between the predicted image produced by the motion compensation means and the image of the encoding object and the motion vector detected by the motion prediction means.

An image processing method according to the second aspect of the present invention, includes the steps, carried out by an image processing apparatus, of: carrying out motion prediction between an image of an encoding object and a reference image to detect a motion vector; calculating filter coefficients of an interpolation filter which interpolates pixels of the reference image using the image of the encoding object, the reference image and the motion vector detected by the motion prediction means with fractional accuracy and uses, in the case where symmetry determined in advance is applied to a first pixel position of fractional accuracy and a second pixel position of the fractional accuracy, the same filter coefficient as filter coefficients for determining a pixel at the first pixel position of the fractional accuracy and another pixel at the second pixel position of the fractional accuracy; and producing a predicted image using the reference image interpolated by the interpolation filter of the calculated filter coefficients and the motion vector detected by the motion prediction means.

A program, according to the second aspect of the present invention, causes a computer to function as: motion prediction means for carrying out motion prediction between an image of an encoding object and a reference image to detect a motion vector; coefficient calculation means for calculating filter coefficients of an interpolation filter which interpolates pixels of the reference image using the image of the encoding object, the reference image and the motion vector detected by the motion prediction means with fractional accuracy and uses, in the case where symmetry determined in advance is applied to a first pixel position of the fractional accuracy and a second pixel position of the fractional accuracy, the same filter coefficient as filter coefficients for determining the pixel at the first pixel position of the fractional accuracy and the pixel at the second pixel position of the fractional accuracy; and motion compensation means for producing a predicted image using the reference image interpolated by the interpolation filter of the filter coefficients calculated by the coefficient calculation means and the motion vector detected by the motion prediction means.

According to the first aspect of the present invention, an encoded image, a motion vector corresponding to the encoded image, and filter coefficients of an interpolation filter which interpolates pixels of a reference image corresponding to the encoded image with fractional accuracy and uses, in the case where symmetry determined in advance is applied to a first pixel position of fractional accuracy and a second pixel position of the fractional accuracy, the same filter coefficient as filter coefficients for determining a pixel at the first pixel position of the fractional accuracy and another pixel at the second pixel position of the fractional accuracy, are decoded. Moreover, a predicted image is produced by using the reference image interpolated by the interpolation filter of the decoded filter coefficients and the decoded motion vector.

According to the second aspect of the present invention, motion prediction is carrying out between an image of an encoding object and a reference image to detect a motion vector; and filter coefficients of an interpolation filter which interpolates pixels of the reference image using the image of the encoding object, the reference image and the motion vector detected by the motion prediction means with fractional accuracy and uses, in the case where symmetry determined in advance is applied to a first pixel position of the fractional accuracy and a second pixel position of the fractional accuracy, the same filter coefficient as filter coefficients for determining the pixel at the first pixel position of the fractional accuracy and the pixel at the second pixel position of the fractional accuracy, is calculated. In addition, a predicted image is produced using the reference image interpolated by the interpolation filter of the calculated filter coefficients and the detected motion vector.

It is to be noted that the image processing apparatus described above may individually be provided as apparatus independent of each other or may be configured each as an internal block which configures one image encoding apparatus or one image decoding apparatus.

### Advantageous Effect

With the present invention, the overhead can be reduced and the encoding efficiency can be improved. Further, with the present invention, in the case of a B picture, the overhead can be reduced and the encoding efficiency can be improved.

### BRIEF DESCRIPTION OF DRAWINGS

FIG. 1 is a view illustrating conventional inter prediction.

FIG. 2 is a view illustrating the conventional inter prediction particularly.

FIG. 3 is a view illustrating interpolation.

FIG. 4 is a view illustrating a Separable AIF.

FIG. 5 is a block diagram showing a configuration of a first embodiment of an image encoding apparatus to which the present invention is applied.

FIG. 6 is a block diagram showing an example of a configuration of a motion prediction and compensation section.

FIG. 7 is a view illustrating the number of filter coefficients.

FIG. 8 is a view illustrating calculation of a filter coefficient in a horizontal direction.

FIG. 9 is a view illustrating calculation of a filter coefficient in a vertical direction.

FIG. 10 is a view illustrating an example of symmetry of fractional pixel positions.

FIG. 11 is a view illustrating another example of symmetry of fractional pixel positions.

FIG. 12 is a view illustrating a further example of symmetry of fractional pixel positions.

FIG. 13 is a view illustrating a still further example of symmetry of fractional pixel positions.

FIG. 14 is a flow chart illustrating an encoding process of the image encoding apparatus of FIG. 8.

FIG. 15 is a flow chart illustrating a motion prediction and compensation process at step S22 of FIG. 14.

FIG. 16 is a block diagram showing an example of the first embodiment of an image decoding apparatus to which the present invention is applied.

FIG. 17 is a block diagram showing an example of a configuration of a motion compensation portion of FIG. 16.

FIG. 18 is a flow chart illustrating a decoding process of the image decoding apparatus of FIG. 16.

FIG. 19 is a flow chart illustrating a motion compensation process at step S139 of FIG. 18.

FIG. 20 is a view showing an example of a configuration of a motion prediction and compensation section of FIG. 5 in the case where a fixed interpolation filter is removed.

FIG. 21 is a flow chart illustrating a motion prediction and compensation process by the motion prediction and compensation section of FIG. 20.

FIG. 22 is a view showing an example of a configuration of the motion compensation portion of FIG. 16 in the case where a fixed interpolation filter is removed.

FIG. 23 is a flow chart illustrating a motion compensation process by the motion compensation portion of FIG. 22.

FIG. 24 is a view illustrating an example of an expanded block size.

FIG. 25 is a block diagram showing an example of a configuration of hardware of a computer.

FIG. 26 is a block diagram showing an example of a principal configuration of a television receiver to which the present invention is applied.

FIG. 27 is a block diagram showing an example of a principal configuration of a portable telephone set to which the present invention is applied.

FIG. 28 is a block diagram showing an example of a principal configuration of a hard disk recorder to which the present invention is applied.

FIG. 29 is a block diagram showing a configuration of a second embodiment of an image encoding apparatus to which the present invention is applied.

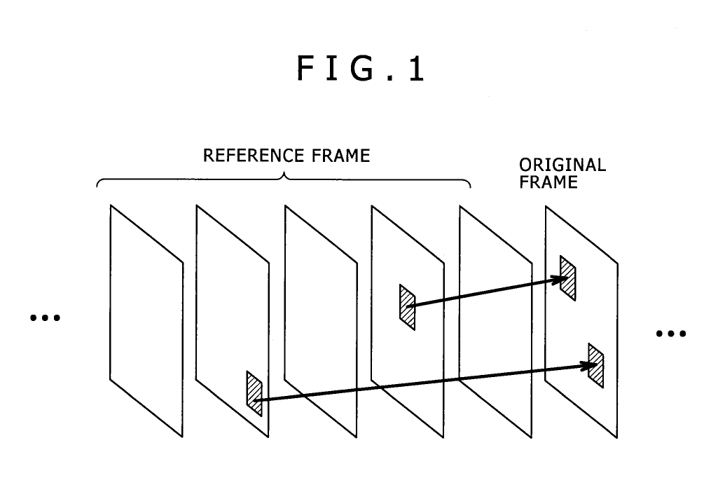

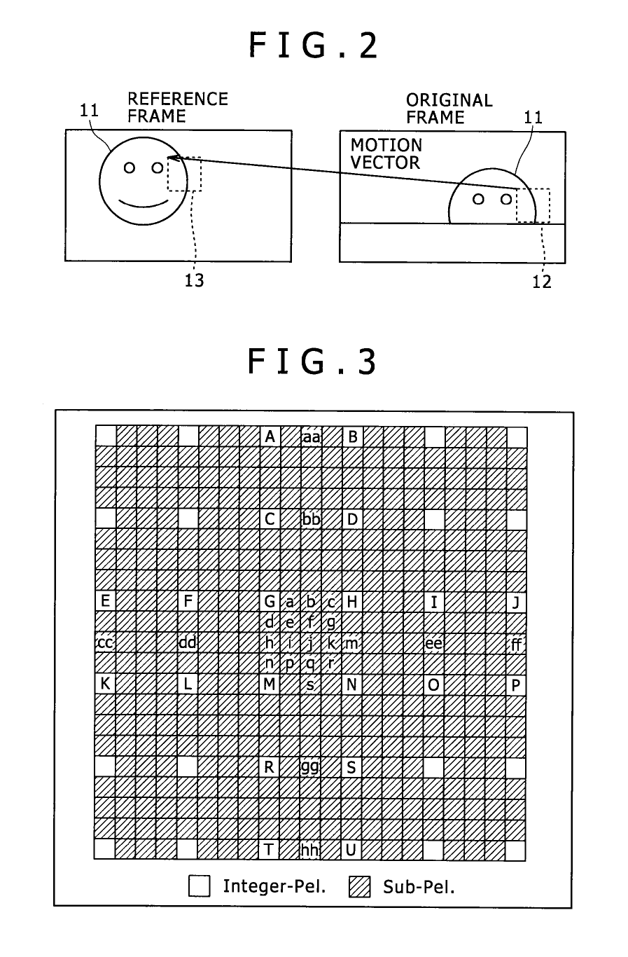

### MODES FOR CARRYING OUT THE INVENTION

In the following, embodiments of the present invention are described with reference to the drawings.

### [Example of the Configuration of the Image Encoding Apparatus]

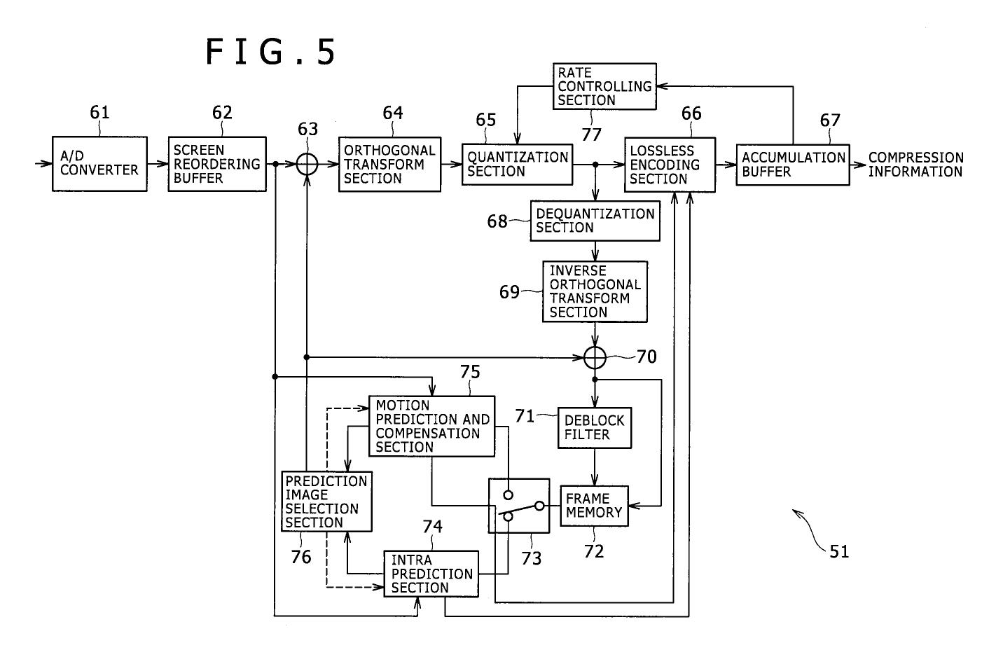

FIG. 5 shows a configuration of a first embodiment of an image encoding apparatus as an image processing apparatus to which the present invention is applied.

This image encoding apparatus 51 compression encodes an image inputted thereto on the basis of, for example, the H.264 and MPEG-4 Part 10 (Advanced Video Coding) (hereinafter referred to as H.264/AVC) method.

In the example of FIG. 5, the image encoding apparatus 51 is configured from an A/D converter 61, a screen reordering buffer 62, an arithmetic operation section 63, an orthogonal transform section 64, a quantization section 65, a lossless encoding section 66, an accumulation buffer 67, a dequantization section 68, an inverse orthogonal transform section 69, an arithmetic operation section 70, a deblock filter 71, a frame memory 72, a switch 73, an intra prediction section 74, a motion prediction and compensation section 75, a predicted image selection section 76 and a rate controlling section 77.

The A/D converter 61 A/D converts an image inputted thereto and outputs a resulting image to the screen reordering buffer 62 so as to be stored into the screen reordering buffer 62. The screen reordering buffer 62 rearranges images of frames in a displaying order stored therein into those in an order of frames for encoding in response to a GOP (Group of Picture).

The arithmetic operation section 63 subtracts a predicted image from the intra prediction section 74 or a predicted image from the motion prediction and compensation section 75 selected by the predicted image selection section 76 from an image read out from the screen reordering buffer 62 and outputs the difference information to the orthogonal transform section 64. The orthogonal transform section 64 carries out orthogonal transform such as discrete cosine transform or Karhunen-Lowe transform for the difference information from the arithmetic operation section 63 and outputs transform coefficients. The quantization section 65 quantizes the transform coefficients outputted from the orthogonal transform section 64.

Quantized transform coefficients outputted from the quantization section 65 are inputted to the lossless encoding section 66, by which lossless encoding such as variable length encoding or arithmetic encoding is carried out for the quantized transform coefficients and compression is carried out.

The lossless encoding section 66 acquires information indicative of intra prediction from the intra prediction section 74 and acquires information representative of an inter prediction mode or the like from the motion prediction and compensation section 75. It is to be noted that the information indicative of the intra prediction and the information indicative of the inter prediction are hereinafter referred to as intra prediction mode information and inter prediction mode information, respectively.

The lossless encoding section 66 encodes the quantized transform coefficients and encodes the information indicative of the intra prediction, the information indicative of the inter prediction mode and so forth, and uses resulting codes as part of header information of a compressed image. The lossless encoding section 66 supplies the encoded data to the accumulation buffer 67 so as to be accumulated into the accumulation buffer 67.

For example, the lossless encoding section 66 carries out a lossless encoding process such as variable length encoding or arithmetic encoding. As the variable length encoding, CAVLC (Context-Adaptive Variable Length Coding) prescribed in the H.264/AVC method or the like is available. As the arithmetic encoding, CABAC (Context-Adaptive Binary Arithmetic Coding) or the like is available.

The accumulation buffer 67 outputs data supplied thereto from the lossless encoding section 66 as an encoded compressed image, for example, to a recording apparatus or a transmission path not shown at the succeeding stage.

Meanwhile, the quantized transform coefficients outputted from the quantization section 65 are inputted also to the dequantization section 68, by which it is dequantized, and the dequantized transform coefficients are inversely orthogonally transformed by the inverse orthogonal transform section 69. The inversely orthogonally transformed output is added to a predicted image supplied from the predicted image selection section 76 by the arithmetic operation section 70 so that it is converted into a locally decoded image. The deblock filter 71 removes block distortion of the decoded image and supplies a resulting image to the frame memory 72 so as to be accumulated into the frame memory 72. Also the image before it is deblock filter processed by the deblock filter 71 is supplied to and accumulated into the frame memory 72.

The switch 73 outputs reference images accumulated in the frame memory 72 to the motion prediction and compensation section 75 or the intra prediction section 74.

In the image encoding apparatus 51, for example, I pictures, B pictures and P pictures from the screen reordering buffer 62 are supplied as images to be subjected to intra prediction (also referred to as intra process) to the intra prediction section 74. Further, B pictures and P pictures read out from the screen reordering buffer 62 are supplied as images to be subjected to inter prediction (also referred to as inter process) to the motion prediction and compensation section 75.

The intra prediction section 74 carries out an intra prediction process in all candidate intra prediction modes based on an image for intra prediction read out from the screen reordering buffer 62 and a reference image supplied from the frame memory 72 to produce a predicted image.

Thereupon, the intra prediction section 74 calculates a cost function value with regard to all candidate intra prediction modes and selects that one of the intra prediction modes which exhibits a minimum value among the calculated cost function values as an optimum intra prediction mode.

This cost function is also called RD (Rate Distortion) cost, and the value thereof is calculated based on such a technique as the High Complexity mode or the Low Complexity mode as are prescribed, for example, by the JM (Joint Model) which is reference software for the H.264/AVC method.

In particular, in the case where the High Complexity mode is adopted as the calculation technique for the cost function value, the processes up to the encoding process are carried out temporarily with regard to all candidate intra prediction modes, and a cost function represented by the following expression (5) is calculated with regard to the intra prediction modes.

Cost(Mode)=D+λ·R (5)

D is the difference (distortion) between the original image and the decoded image, R a generated code amount including up to orthogonal transform coefficients, and λ the Lagrange's multiplier given as a function of a quantization parameter QP.

On the other hand, in the case where the Low Complexity mode is adopted as the calculation technique for the cost function value, production of an intra prediction image and calculation of header bits of information representative of an intra prediction mode and so forth are carried out with regard to all candidate intra prediction modes, and a cost function represented by the following expression (6) is calculated with regard to the intra prediction modes.

Cost(Mode)=D+QPtoQuant(QP)·Header_Bit (6)

D is the difference (distortion) between the original image and the decoded image, Header_Bit a header bit for the intra prediction mode, and QPtoQuant a function given as a function of the quantization parameter QP.

In the Low Complexity mode, only it is necessary to produce an intra prediction image with regard to all intra prediction modes and there is no necessity to carry out an encoding process, and therefore, the amount of arithmetic operation may be small.

The intra prediction section 74 supplies the predicted image produced in the optimum intra prediction mode and the cost function value of the predicted image to the predicted image selection section 76. In the case where the predicted image produced in the optimum intra prediction mode is selected by the predicted image selection section 76, the intra prediction section 74 supplies information indicative of the optimum intra prediction mode to the lossless encoding section 66. The lossless encoding section 66 encodes this information and uses the encoded information as part of header information for the compressed image.

To the motion prediction and compensation section 75, an image read out from the screen reordering buffer 62 so as to be inter processed and a reference image from the frame memory 72 through the switch 73 are supplied. The motion prediction and compensation section 75 carries out a filter process of a reference image using a fixed interpolation filter. It is to be noted that the representation that a filter coefficient is fixed does not mean to fix a filter coefficient to one, but it signifies fixation against variation in the AIF (Adaptive Interpolation Filter) and naturally it is possible to replace the coefficient. In the following, a filter process by a fixed interpolation filter is referred to as fixed filter process.

The motion prediction and compensation section 75 carries out motion prediction of a block in all candidate inter prediction modes based on an image to be inter processed and a reference image after the fixed filter process to produce a motion vector for each block. Then, the motion prediction and compensation section 75 carries out a compensation process for the reference image after the fixed filter process to produce a predicted image. At this time, the motion prediction and compensation section 75 determines a cost function value of a block of a processing object with regard to all candidate inter prediction modes and determines a prediction mode, and determines a cost function value of a slice of a processing object in the determined prediction mode.

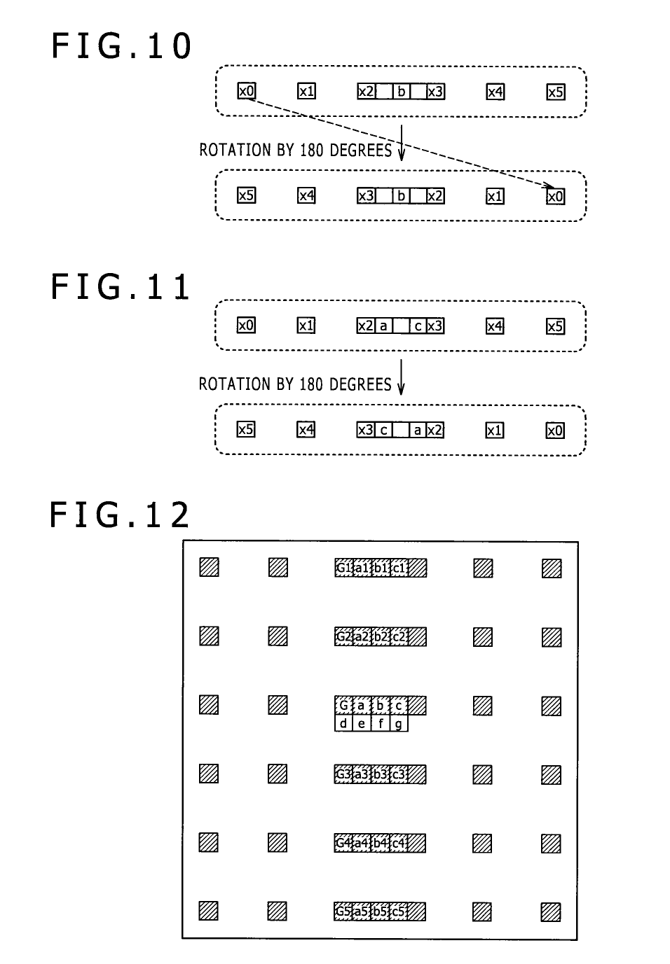

Further, the motion prediction and compensation section 75 selects, based on whether the object block is included in a P slice or a B slice, that is, based on a kind of the slice, pixel positions in fractional accuracy at which same filter coefficients are to be individually used for pixels. For example, in the case of the B slice, the symmetry is applied to a greater number of pixel positions of the fractional accuracy than that of the P slice (it is determined that the pixel positions have symmetry), and the same filter coefficients are used for the pixel positions. While details are hereinafter described referring to FIG. 10, this law of symmetry is assumed and determined in advance on the encoding side and the decoding side. In the following description, in the case where there are many pixels to which symmetry is to be applied, it is described also that the symmetry is high.

The motion prediction and compensation section 75 uses the produced motion vectors, the image to be inter processed and the reference image to determine filter coefficients of an interpolation filter (AIF (Adaptive Interpolation Filter)) which has variable coefficients configured by the filter coefficients suitable for the kind of the slice. Then, the motion prediction and compensation section 75 uses the filter of the determined filter coefficients to carry out a filter process for the reference image. It is to be noted that a filter process by the variable interpolation filter is hereinafter referred to also as variable filter process.

The motion prediction and compensation section 75 carries out motion prediction of blocks in all candidate inter prediction modes based on the image to be inter processed and the reference images after the variable filter process again to produce a motion vector for each block. Then, the motion prediction and compensation section 75 carries out a compensation process for the reference image after the variable filter process to produce a predicted image. At this time, the motion prediction and compensation section 75 determines a cost function value of a block of a processing object with regard to all candidate inter prediction modes and determines a prediction mode, and then determines a cost function value of a slice of the processing object in the determined prediction mode.

Then, the motion prediction and compensation section 75 compares the cost function value after the fixed filter process and the cost function value after the variable filter process. The motion prediction and compensation section 75 adopts that one of the cost function values which has a lower value and outputs the prediction image and the cost function value to the predicted image selection section 76, and sets an AIF use flag indicative of whether or not the slice of the processing object uses the AIF.

In the case where a prediction image of an object block in an optimum inter prediction mode is selected by the predicted image selection section 76, the motion prediction and compensation section 75 outputs information indicative of the optimum inter prediction mode (inter prediction mode information) to the lossless encoding section 66.

At this time, the motion vector information, reference frame information, information of the kind of the slice included in the slice header information for each slice, and AIF use flag as well as, in the case where the AIF is used, filter coefficients and so forth are outputted to the lossless encoding section 66. The lossless encoding section 66 carries out a lossless encoding process such as variable length encoding or arithmetic encoding again for the information from the motion prediction and compensation section 75 and inserts resulting information into the header part of the compressed image.

The predicted image selection section 76 determines an optimum prediction mode from an optimum intra prediction mode and an optimum inter prediction mode based on cost function values outputted from the intra prediction section 74 or the motion prediction and compensation section 75. Then, the predicted image selection section 76 selects a predicted image of the determined optimum prediction mode and supplies the prediction image to the arithmetic operation sections 63 and 70. At this time, the predicted image selection section 76 supplies a selection signal of the prediction image to the intra prediction section 74 or the motion prediction and compensation section 75 as indicated by a dotted line.

The rate controlling section 77 controls the rate of the quantization operation of the quantization section 65 based on compressed images accumulated in the accumulation buffer 67 so that an overflow or an underflow may not occur.

### [Example of the Configuration of the Motion Prediction and Compensation Section]

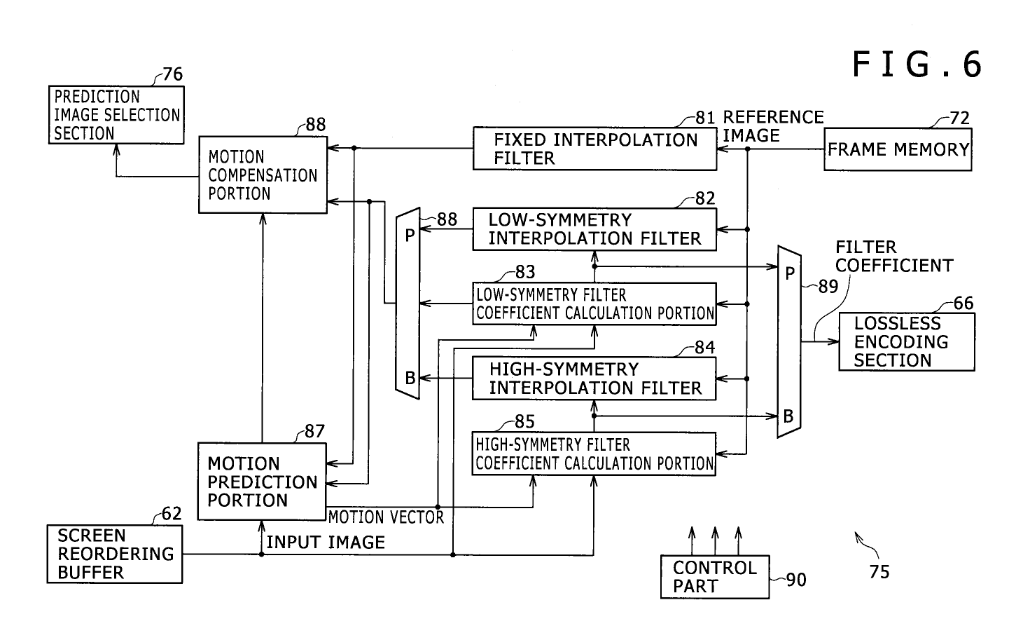

FIG. 6 is a block diagram showing an example of a configuration of the motion prediction and compensation section 75. It is to be noted that, in FIG. 6, the switch 73 of FIG. 5 is omitted.

In the example of FIG. 6, the motion prediction and compensation section 75 is configured from a fixed interpolation filter 81, a low-symmetry interpolation filter 82, a low-symmetry filter coefficient calculation portion 83, a high-symmetry interpolation filter 84, a high-symmetry filter coefficient calculation portion 85, a selector 86, a motion prediction portion 87, a motion compensation portion 88, another selector 89 and a control part 90.

An input image (image to be inter processed) from the screen reordering buffer 62 is inputted to the low-symmetry filter coefficient calculation portion 83, high-symmetry filter coefficient calculation portion 85 and motion prediction portion 87. A reference image from the frame memory 72 is inputted to the fixed interpolation filter 81, low-symmetry interpolation filter 82, low-symmetry filter coefficient calculation portion 83, high-symmetry interpolation filter 84 and high-symmetry filter coefficient calculation portion 85.

The fixed interpolation filter 81 is a six-tap interpolation filter of fixed coefficients prescribed, for example, by the H.264/AVC method. The fixed interpolation filter 81 carries out a filter process for the reference image from the frame memory 72 and outputs the reference image after the fixed filter process to the motion prediction portion 87 and the motion compensation portion 88.

The low-symmetry interpolation filter 82 is an interpolation filter of variable filter coefficients wherein the number of pixels to which symmetry determined in advance is to be applied is smaller than that of the high-symmetry interpolation filter 84. While, for example, the AIF filter described in Non-Patent Document 2 is used as the low-symmetry interpolation filter 82, since the low-symmetry interpolation filter 82 is a filter used in a case of the P slice, the number of filter coefficients may be increased rather than that of the AIF filter described in Non-Patent Document 2. By this, in the case of the P slice, the encoding efficiency is enhanced.

The low-symmetry interpolation filter 82 carries out a filter process for the reference image from the frame memory 72 using low-symmetry filter coefficients calculated by the low-symmetry filter coefficient calculation portion 83 and outputs the reference image after the variable filter process to the selector 86.

The low-symmetry filter coefficient calculation portion 83 uses the input image from the screen reordering buffer 62, the reference image from the frame memory 72 and a motion vector for the first time from the motion prediction portion 87 to calculate, for example, 51 filter coefficients for approximating the reference image after the filter process of the low-symmetry interpolation filter 82 to the input image. The low-symmetry filter coefficient calculation portion 83 supplies the calculated filter coefficients to the low-symmetry interpolation filter 82 and the selector 89.

The high-symmetry interpolation filter 84 is an interpolation filter of variable filter coefficients wherein the number of pixels to which symmetry determined in advance is to be applied is greater than that of the low-symmetry interpolation filter 82. For example, the high-symmetry interpolation filter 84 is used in the case of the B slice. The high-symmetry interpolation filter 84 carries out a filter process for the reference image from the frame memory 72 using high-symmetry filter coefficients calculated by the high-symmetry filter coefficient calculation portion 85 and outputs the reference image after the variable filter process to the selector 86.

The high-symmetry filter coefficient calculation portion 85 uses the input image from the screen reordering buffer 62, the reference image from the frame memory 72 and a motion vector for the first time from the motion prediction portion 87 to calculate, for example, 18 filter coefficients for approximating the reference image after the filter process of the high-symmetry interpolation filter 84 to the input image. The high-symmetry filter coefficient calculation portion 85 supplies the calculated filter coefficients to the high-symmetry interpolation filter 84 and the selector 89.

The selector 86 selects, in the case where the slice of the processing object is a P slice, the reference image after the variable filtering from the low-symmetry interpolation filter 82 and outputs the selected reference image to the motion prediction portion 87 and the motion compensation portion 88 under the control of the control part 90. In the case where the slice of the processing object is a B slice, the selector 86 selects the reference image after the variable filtering from the high-symmetry interpolation filter 84 and outputs the selected reference image to the motion prediction portion 87 and the motion compensation portion 88 under the control of the control part 90.

In particular, the selector 86 selects, in the case where the slice of the processing object is a P slice, low-symmetry, but select, in the case where the slice of the processing object is a B slice, high-symmetry.

The motion prediction portion 87 produces a motion vector for the first time for all candidate inter prediction modes based on the input image from the screen reordering buffer 62 and the reference image after the fixed filtering from the fixed interpolation filter 81, and outputs the produced motion vectors to the low-symmetry filter coefficient calculation portion 83, the high-symmetry filter coefficient calculation portion 85 and the motion compensation portion 88. Further, the motion prediction portion 87 produces a motion vector for the second time for all candidate inter prediction modes based on the input image from the screen reordering buffer 62 and the reference image after the variable filter from the selector 86 and outputs the produced motion vectors to the motion compensation portion 88.

The motion compensation portion 88 uses the motion vectors for the first time to carry out a compensation process for the reference image after the fixed filtering from the fixed interpolation filter 81 to produce a prediction image. Then, the motion compensation portion 88 calculates a cost function value for each block to determine an optimum inter prediction mode and calculates a cost function value for the first time of an object slice in the determined optimum inter prediction mode.

The motion compensation portion 88 subsequently uses the motion vectors for the second time to carry out a compensation process for the reference image after the variable filtering from the selector 86 to produce a prediction image. Then, the motion compensation portion 88 calculates a cost function value for each block to determine an optimum inter prediction mode and calculates a cost function value for the second time of the object slice in the determined optimum inter prediction mode.

Then, the motion compensation portion 88 compares the cost function value for the first time and the cost function value for the second time with each other with regard to the object slice and determines to use that one of the filters which exhibits a lower value. In particular, in the case where the cost function value for the first time is lower, the motion compensation portion 88 determines to use the fixed filter with regard to the object slice and supplies the prediction image and the cost function value produced with the reference image after the fixed filtering to the predicted image selection section 76 and then sets the value of the AIF use flag to 0 (not used). On the other hand, in the case where the cost function value for the second time is lower, the motion compensation portion 88 determines to use a variable filter with regard to the object slice. Then, the motion compensation portion 88 supplies the prediction image and the cost function value produced with the reference image after the variable filtering to the predicted image selection section 76 and sets the value of the AIF use flag to 1 (used).

In the case where the predicted image selection section 76 selects an inter prediction image, the motion compensation portion 88 outputs the information of the optimum inter prediction mode, information of the slice header which includes the kind of the slice and AIF use flag, motion vector, information of the reference image and so forth to the lossless encoding section 66 under the control of the control part 90.

In the case where an inter predicted image is selected in the predicted image selection section 76 and a variable filter is to be used in the object slice, when the object slice is a P slice, the selector 89 outputs a filter coefficient from the low-symmetry filter coefficient calculation portion 83 to the lossless encoding section 66 under the control of the control part 90. In the case where an inter predicted image is selected in the predicted image selection section 76 and a variable filter is to be used in the object slice, when the object slice is a B slice, the selector 89 outputs filter coefficients from the high-symmetry filter coefficient calculation portion 85 to the lossless encoding section 66 under the control of the control part 90.

The control part 90 selects, in response to a kind of the object slice, pixel positions in fractional accuracy at which same filter coefficients are to be individually used for pixels, and controls the selectors 86 and 89. In particular, the control part 90 selects, where the object slice is the P slice, that the symmetry determined in advance is applied to a number of pixel positions of fractional accuracy smaller than that in the case of the B slice, but selects, where the object slice is the B slice, that the symmetry determined in advance is applied to a number of pixel positions of fractional accuracy greater than that in the case of the P slice.

On the other hand, if a signal representing that an inter prediction image from the predicted image selection section 76 is selected is received, then the control part 90 carries out control of causing the motion compensation portion 88 and the selector 89 to output necessary information to the lossless encoding section 66.

### [Number of Filter Coefficients]

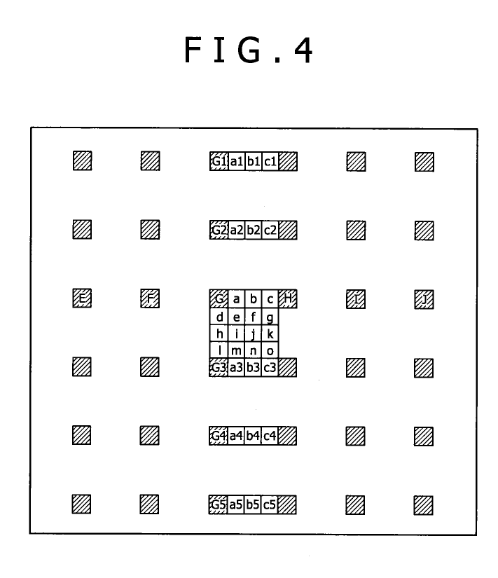

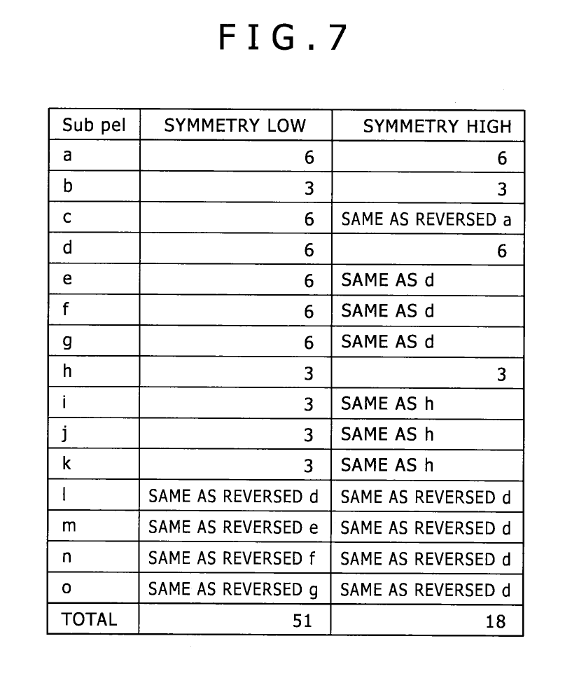

FIG. 7 is a view illustrating the number of filter coefficients in the low-symmetry interpolation filter 82 used in the case of the P slice and the high-symmetry interpolation filter 84 used in the case of the B slice. It is to be noted that, in the example of FIG. 7, the example of the case of the Separable AIF described hereinabove with reference to FIG. 4 is illustrated. Further, the sub pels of FIG. 7 represent pixel values at the positions to which the alphabetical letters shown in FIG. 4 described above are applied.

In particular, in the case where the pixel value a in FIG. 4 is to be determined, six filter coefficients are required for both of the low-symmetry interpolation filter 82 and the high-symmetry interpolation filter 84, and, where the pixel value b is to be determined, three filter coefficients are required for both of the low-symmetry interpolation filter 82 and the high-symmetry interpolation filter 84.

In the case where the pixel value c is to be determined, six filter coefficients are required for the low-symmetry interpolation filter 82. On the other hand, where the pixel value c is to be determined, since the symmetry determined in advance is applied to the position of the pixel value c and the position of the pixel value a and the filter coefficients when the pixel value a is determined is used in a reversed state, the filter coefficients are not required for the high-symmetry interpolation filter 84. Here, use of the filter coefficients in the reversed state signifies that the filter coefficients reversed around the center position of the pixels at integral positions used for the AIF described hereinabove are used.

In the case where the pixel value d is to be determined, six filter coefficients are required for both of the low-symmetry interpolation filter 82 and the high-symmetry interpolation filter 84.

In the case where the pixel values e, f and g are to be determined, six filter coefficients are required for the low-symmetry interpolation filter 82. On the other hand, in the high-symmetry interpolation filter 84, since the symmetry determined in advance is applied to the positions of the pixel values e, f and g and the position of the pixel value d and the same filter coefficients as those in the case in which the pixel value d is determined are used, the filter coefficients are not required.

In the case where the pixel value h is to be determined, three filter coefficients are required for both of the low-symmetry interpolation filter 82 and the high-symmetry interpolation filter 84.

In the case where the pixel values i, j and k are to be determined, three filter coefficients are required for the low-symmetry interpolation filter 82. On the other hand, in the high-symmetry interpolation filter 84, since the symmetry determined in advance is applied to the positions of the pixel values i, j and k and the position of the pixel value h and the same filter coefficients as those in the case in which the pixel value h is determined are used, the filter coefficients are not required.

In the case where the pixel value l is to be determined, in the low-symmetry interpolation filter 82 and the high-symmetry interpolation filter 84, since the symmetry determined in advance is applied to the position of the pixel value l and the position of the pixel value d and the filter coefficients when the pixel value d is determined are used in a reversed state, the filter coefficients are not required.

Where the pixel value m is to be determined, in the low-symmetry interpolation filter 82, the symmetry determined in advance is applied to the position of the pixel value m and the position of the pixel value e and the filter coefficients when the pixel value e is determined are used in a reversed state. On the other hand, in the case where the pixel value m is to be determined, in the high-symmetry interpolation filter 84, the symmetry determined in advance is applied to the position of the pixel value m and the position of the pixel value l. Here, the filter coefficients when the pixel value d is determined are used in a reversed state as the filter coefficients for the pixel value l. As a result, in the case where the pixel value m is to be determined, since, in the high-symmetry interpolation filter 84, the filter coefficients when the pixel value d is determined are used in a reversed state, the filter coefficients are not required.

In the case where the pixel value n is to be determined, in the low-symmetry interpolation filter 82, the symmetry determined in advance is applied to the position of the pixel value n and the position of the pixel value f and the filter coefficients when the pixel value f is determined are used in a reversed state. On the other hand, in the case where the pixel value n is to be determined, in the high-symmetry interpolation filter 84, the symmetry determined in advance is applied to the position of the pixel value n and the position of the pixel value l. Here, the filter coefficients when the pixel value d is determined are used in a reversed state as the filter coefficients for the pixel value l. As a result, in the case where the pixel value n is determined, since, in the high-symmetry interpolation filter 84, the filter coefficients when the pixel value d is determined are used in a reversed state, the filter coefficients are not required.

In the case where the pixel value o is to be determined, in the low-symmetry interpolation filter 82, the symmetry determined in advance is applied to the position of the pixel value o and the position of the pixel value g and the filter coefficients when the pixel value g is determined are used in a reversed state. On the other hand, in the case where the pixel value o is to be determined, in the high-symmetry interpolation filter 84, the symmetry determined in advance is applied to the position of the pixel value o and the position of the pixel value l. Here, the filter coefficients when the pixel value d is determined are used in a reversed state as the filter coefficients for the pixel value l. As a result, in the case where the pixel value o is to be determined, since, in the high-symmetry interpolation filter 84, the filter coefficients when the pixel value d is determined are used in a reversed state, the filter coefficients are not required.

As described above, while the number of the filter coefficients necessary for the low-symmetry interpolation filter 82 is 51, the number of the filter coefficients necessary for the high-symmetry interpolation filter 84 is 18. Accordingly, in the case of the high-symmetry interpolation filter 84 (B slice), the number of the filters is smaller than that in the case of the low-symmetry interpolation filter 82 (P slice).

As described above, in the case of the high-symmetry interpolation filter 84 (B slice), the symmetry determined in advance is applied to the pixels of the 11 fractional positions and the same filter coefficients or the reversed filter coefficients are used. On the other hand, in the case of the low-symmetry interpolation filter 82 (P slice), the symmetry determined in advance is applied to the pixels at the four fractional positions and the reversed filter coefficients are used. In particular, pixel positions in fractional accuracy at which same filter coefficients are to be individually used for pixels are selected depending upon a kind of the slice. Consequently, in the case of the B slice, the overhead can be reduced in the stream information.

It is to be noted that the low-symmetry interpolation filter 82 carries out an interpolation process by the Separable adaptive interpolation filter (hereinafter referred to as Separable AIF) described in Non-Patent Document 2 in accordance with, for example, the expression (4) given hereinabove. Here, the Separable AIF carried out by the high-symmetry interpolation filter 84 is described once again with reference to FIG. 4.

Also in the Separable AIF carried out by the high-symmetry interpolation filter 84, similarly as in the case of the low-symmetry interpolation filter 82, interpolation of non-integral positions in the transverse direction is carried out as the first step and interpolation of non-integral directions in the vertical direction is carried out as the second step. It is to be noted that also it is possible to reverse the order of the process in the transverse direction and the process in the vertical direction.

First, as the first step, the pixel values a, b and c of the pixels at fractional positions are calculated in accordance with the following expression (7) by the FIR filter from the pixel values E, F, G, H and I of the pixels at integral positions. Here, h[pos][n] indicates a filter coefficient, and pos indicates a position of the sub pel shown in FIG. 3 and n indicates the number of the filter coefficient. The filter coefficient is included into stream information and used on the decoding side.

a=h[a][0]×E+h1[a][1]×F+h2[a][2]×G+h[a][3]×H+h[a][4]×I+h[a][5]×J

b=h[b][0]×E+h1[b][1]×F+h2[b][2]×G+h[b][3]×H+h[b][1]×I+h[b][0]×J

c=h[a][5]×E+h1[c][4]×F+h2[a][3]×G+h[a][2]×H+h[a][1]×I+h[a][0]×J (7)

It is to be noted that also pixel values (a1, b1, c1, a2, b2, c2, a3, b3, c3, a4, b4, c4, a5, b5, c5) of pixels at fractional positions in rows of the pixel values G1, G2, G3, G4 and G5 can be determined similarly to the pixel values a, b and c.

Then at the second step, the pixel values d to o other than the pixel values a, b and c are calculated in accordance with the following expression (8).

d=h[d][0]×G1+h[d][1]×G2+h[d][2]×G+h[d][3]×G3+h[d][4]*G4+h[d][5]×G5

h=h[h][0]×G1+h[h][1]×G2+h[h][2]×G+h[h][2]×G3+h[h][8]*G4+h[h][0]×G5

l=h[d][5]×G1+h[d][4]×G2+h[d][3]×G+h[d][2]×G3+h[d][1]*G4+h[d][0]×G5

e=h[d][0]×a1+h[d][1]×a2+h[d][2]×a+h[d][3]×a3+h[d][4]*a4+h[d][5]×a5

i=h[h][0]×a1+h[h][1]×a2+h[h][2]×a+h[h][3]×a3+h[h][1]*a4+h[h][0]×a5

m=h[d][5]×a1+h[d][4]×a2+h[d][3]×a+h[d][2]×a3+h[d][1]*a4+h[d][0]×a5

f=h[d][0]×b1+h[d][1]×b2+h[d][2]×b+h[d][3]×b3+h[d][4]*b4+h[d][5]×b5

j=h[h][0]×b1+h[h][1]×b2+h[h][2]×b+h[h][2]×b3+h[h][4]*b4+h[h][5]×b5

n=h[d][5]×b1+h[d][4]×b2+h[d][3]×b+h[d][2]×b3+h[d][1]*b4+h[d][0]×b5

g=h[d][0]×c1+h[d][1]×c2+h[d][2]×c+h[d][3]×c3+h[d][4]*c4+h[d][5]×c5

k=h[h][0]×c1+h[h][1]×c2+h[h][2]×c+h[h][3]×c3+h[h][1]*c4+h[h][5]×c5

o=h[d][5]×c1+h[d][4]×c2+h[d][3]×c+h[d][2]×c3+h[d][1]*c4+h[d][0]×c5 (8)

### [Calculation Method of Filter Coefficients]

Now, a calculation method of filter coefficients is described.

As regards the calculation method of a filter coefficient, since several types are available with the interpolation method of an AIF, although there are slight differences, they are same in such a basic portion that the least squares method is used. An interpolation method is described wherein, after a horizontal interpolation process, interpolation in the vertical direction is carried out at two stages by a Separable AIF (Adaptive Interpolation Filter), firstly as a representative.

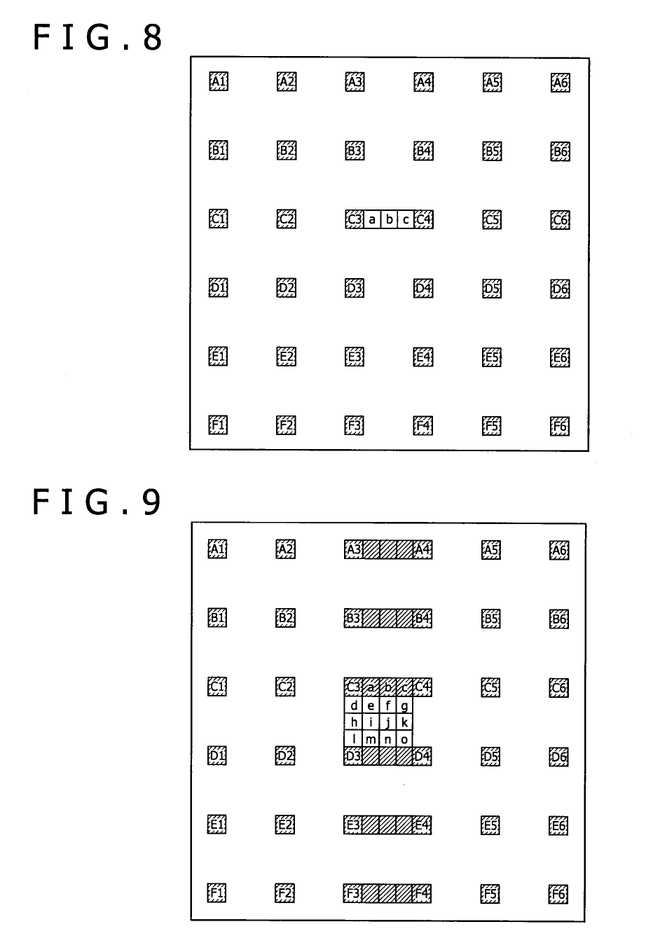

FIG. 8 represents a filter in the horizontal direction of the Separable AIF. In the filter in the horizontal direction shown in FIG. 8, a square to which slanting lines are applied represents a pixel at an integral position (Integer pel (Int. pel)), and a blank square represents a pixel at a fractional position (Sub pel). Further, an alphabetical letter in a square represents a pixel value of a pixel represented by the square.

First, interpolation in the horizontal direction is carried out, that is, filter coefficients for pixel positions of fractional positions of pixel values a, b and c of FIG. 8 are determined. Here, since a six-tap filter is used, in order to calculate the pixel values a, b and c at the fractional positions, pixel values C1, C2, C3, C4, C5 and C6 at integral positions are used, and the filter coefficients are calculated so as to minimize the following expression (9).

[Expression 1]

eₛₚ²=Σ_{x,y}[S_{x,y}−Σᵢ₌₀^{c}h_{sp,i}·P_{e+i,y}]² (9)

Here, e is a prediction error, sp one of the pixel values a, b and c at the fractional positions, S an original signal, P a decoded reference pixel value, and x and y are a pixel position of an object of the original signal.

Further, in the expression (9), \tilde{x} is the following expression (10).

[Expression 2]

\tilde{x}=x+MVₓ−FilterOffset (10)

MVₓ and sp are detected by motion prediction for the first time, and wherein MVₓ is a motion vector in the horizontal direction in integral accuracy and sp represents a pixel position of a fractional position and corresponds to a fraction part of the motion vector. FilterOffset corresponds to a value obtained by subtracting 1 from one half of the tap number of the filter, and here, 2=6/2−1. h is a filter coefficient, and i assumes a value from 0 to 5.

Optimum filter coefficients for the pixel values a, b and c can be determined as h which minimizes the square of e. As indicated by the following expression (11), simultaneous equations are obtained such that a value obtained by partial differentiation of the square of a prediction error by h is set to be 0. By solving the simultaneous equations, filter coefficients which are independent of each other with regard to i from 0 to 5 where the pixel value (sp) of a fractional position is a, b and c can be determined.

$$[ Expression 3 ]$$

$$\begin{matrix}0 = \frac{{( \partial {ε}_{sp} )}^{2}}{\partial {h}_{sp . i}} \\ = {\frac{\partial }{\partial {h}_{sp . i}} [ {\sum }_{x , y} [ {S}_{x , y} - {\sum }_{i = 0}^{3} {h}_{sp . i} {P}_{\tilde{x} + i , y} ] ]}^{2} - {\sum }_{x , y} [ {S}_{x , y} - {\sum }_{i = 0}^{3} {h}_{sp . i} {P}_{\tilde{x} + i , y} ] {P}_{\tilde{x} + i , y}\end{matrix} \\ ∀ sp ∈ \{ a , b , c \} \\ ∀ i ∈ \{ 0 , 1 , 2 , 3 , 4 , 5 \} \qquad ( 11 )$$

Describing more particularly, a motion vector is determined with regard to all blocks by a motion search for the first time. The pixel values a, b and c are determined such that the following expression (11) in the expression (12) is determined using a block whose fractional position is the pixel value a as input data in the motion vector and can be solved with regard to a filter coefficient h_{a,i}, ∀iε{0, 1, 2, 3, 4, 5} for the interpolation for the pixel position of the pixel value a.

[Expression 4]

P_{x-i,y},S_{x,y} (12)

Since the filter coefficients in the horizontal direction are determined and it becomes possible to carry out an interpolation process, if interpolation is carried out with regard to the pixel values a, b and c, then such a filter in the vertical direction illustrated in FIG. 9 is obtained. In FIG. 9, the pixel values a, b and c are interpolated using optimum filter coefficients, and interpolation is carried out also between the pixel values A3 and A4, between the pixel values B3 and B4, between the pixel values D3 and D4, between the pixel values E3 and E4 and between the pixel values F3 and F4 similarly.

In particular, in the filters in the horizontal direction of the Separable AIF illustrated in FIG. 9, a square to which slanting lines are applied represents a pixel at an integral position or a pixel at a fractional position determined already by a filter in the horizontal direction, and a blank square represents a pixel at a fractional position to be determined by a filter in the horizontal direction. Further, an alphabetical letter in a square represents a pixel value of a pixel represented by the square.

Also in the case of the vertical direction illustrated in FIG. 9, a filter coefficient can be determined so as to minimize the prediction error of the following expression (13) similarly as in the case of the horizontal direction.

[Expression 5]

eₑₚ²=Σ_{x,y}[S_{x,y}−Σⱼ₌₀³h_{sp,j}·\hat{P}_{\tilde{x},\tilde{y}+j}]² (13)

Here, the expression (14) represents a reference pixel encoded already or an interpolated pixel, an expression (15), and an expression (16).

[Expression 6]

\hat{P} (14)

[Expression 7]

\tilde{x}=4·x+MVₓ (15)

[Expression 8]

\tilde{y}=y+MV_{y}−FilterOffset (16)

Further, MV_{y} and sp are detected by motion prediction for the first time, and wherein MV_{y} is a motion vector in the vertical direction in integral accuracy and sp represents a pixel position of a fractional position and corresponds to the fraction part of the motion vector. FilterOffset corresponds to a value obtained by subtracting 1 from one half of the tap number of the filter, and here is 2=6/2−1. h is a filter coefficient, and j varies from 0 to 5.

Similarly as in the case of the horizontal direction, the filter coefficient h is calculated such that the square of the prediction error of the expression (13) may be minimized. Therefore, as seen from the expression (17), a result obtained by partial differentiation of the square of the prediction error by h is set to 0 to obtain simultaneous equations. By solving the simultaneous equations regarding the pixels at the fractional positions, that is, the pixel values d, e, f, g, h, l, j, k, l, m, n and o, optimum filter coefficients of interpolation filters in the vertical direction at the pixels at the fractional positions can be obtained.

$$[ Expression 9 ]$$

$$\begin{matrix}0 = \frac{{( \partial {ε}_{sp} )}^{2}}{\partial {h}_{sp . i}} \\ = {\frac{\partial }{\partial {h}_{sp . i}} [ {\sum }_{x , y} [ {S}_{x , y} - {\sum }_{j = 0}^{3} {h}_{sp . i} {\hat{P}}_{\tilde{x} , \tilde{y} + j} ] ]}^{2} \\ = {\sum }_{x , y} [ {S}_{x , y} - {\sum }_{j = 0}^{3} {h}_{sp . j} {\hat{P}}_{\tilde{x} , \tilde{y} + j} ] {\hat{P}}_{\tilde{x} , \tilde{y} + j}\end{matrix} \\ ∀ sp ∈ \{ d , e , f , g , h , i , j , k , l , m , n , o \} \qquad ( 17 )$$

Now, a calculation method of filter coefficients in the case where the number of filter coefficients is decreased by the high-symmetry filter coefficient calculation portion 85 is described. It is to be noted that, although an example of the calculation method of filter coefficients by the high-symmetry filter coefficient calculation portion 85 is described, filter coefficients can be calculated similarly also by the low-symmetry filter coefficient calculation portion 83.

For example, in the case where the same filter coefficient is used for a pixel at a fractional position of the pixel value a and another pixel at another factional position of the pixel value c as seen in FIG. 7, if symmetry in rotation by 180 degrees (symmetry to the left and right) is assumed, then such equal values as given by the following expression (18) are obtained.

[Expression 10]

h_{a,0}=h_{c,5}

h_{a,1}=h_{c,4}

h_{a,2}=h_{c,3}

h_{a,3}=h_{c,2}

h_{a,4}=h_{c,1}

h_{a,5}=h_{c,0} (18)

Calculation of squaring of a prediction error is given, with regard to the pixel values a and c, by the following expressions (19) and (20), respectively.

[Expression 11]

eₐ²=Σ_{x,y}[S_{x,y}−Σᵢ₌₀⁵h_{a,i}·P_{\tilde{x}+i,y}]² (19)

[Expression 12]

e_{c}²=Σ_{x,y}└S_{x,y}−Σᵢ₌₀⁵h_{a,5=i}·P_{\tilde{x}+i,y}┘² (20)

The simultaneous equations are subjected, with regard to the pixel values a and c, to change as expressions (21) and (22).

$$[ Expression 13 ]$$

$$\begin{matrix}\begin{matrix}0 = \frac{{( \partial {ε}_{s} )}^{2}}{\partial {h}_{s . i}} \\ = {\frac{\partial }{\partial {h}_{s . i}} [ {\sum }_{x , y} [ {S}_{x , y} - {\sum }_{i = 0}^{3} {h}_{s . i} {P}_{\tilde{x} + i , y} ] ]}^{2} \\ = {\sum }_{x , y} [ {S}_{x , y} - {\sum }_{i = 0}^{3} {h}_{s . i} {P}_{\tilde{x} + i , y} ] {P}_{\tilde{x} + i . y}\end{matrix} \\ ∀ i ∈ \{ 0 , 1 , 2 , 3 , 4 , 5 \} & ( 21 ) \\ [ Expression 14 ] & \\ \begin{matrix}0 = \frac{{( \partial {ε}_{s} )}^{2}}{\partial {h}_{a , s - i}} \\ = {\frac{\partial }{\partial {h}_{a , s - i}} [ {\sum }_{x , y} [ {S}_{x , y} - {\sum }_{i = 0}^{3} {h}_{a , s - i} {P}_{\tilde{x} + i , y} ] ]}^{2} \\ = {\sum }_{x , y} [ {S}_{x , y} - {\sum }_{i = 0}^{3} {h}_{a , s - i} {P}_{\tilde{x} + i , y} ] {P}_{\tilde{x} + i , y}\end{matrix} \\ ∀ i ∈ \{ 0 , 1 , 2 , 3 , 4 , 5 \} & ( 22 )\end{matrix}$$

If the expression (21) is used with regard to the pixel at a fractional position having the pixel value a of the motion vector in the motion compensation for the first time and the expression (22) is used with regard to the pixel, whose fractional position is the pixel value c, to determine the pixels at h_{a,0}, h_{a,1}, h_{a,2}, h_{a,3}, h_{a,4}, h_{a,5}, then the pixels at h_{c,0}, h_{c,1}, h_{c,2}, h_{c,3}, h_{c,4}, h_{c,5} can be determined from the expression (18) given hereinabove.

### [Example of the Symmetry of Fractional Pixel Positions]

Now, symmetry applied to filter coefficients of an interpolation filter is described. Filter coefficients can be reduced like the filter coefficients indicated by the expression (18) given hereinabove.

Although the symmetry of an image originally differs depending upon the image, reduction of filter coefficients described above is carried out by assuming symmetry depending upon the positions of fractional position pixels and applying the assumed symmetry to the positions of the fractional position pixels, that is, determining the symmetry. For the assumption of symmetry, a method of assuming symmetry when the distances from a pixel at an integral position to pixels at fractional positions to be produced from the pixel or a like method is used. In the following, as an example which uses the method described, symmetry of pixels at the fractional positions of the pixel values a and c is described with reference to FIGS. 10 and 11.

FIG. 10 represents a positional relationship between the pixel at the fractional position of the pixel value b and pixels at integral positions of the pixel values x0 to x5 necessary for the interpolation process. If the pixel positions are rotated by 180 degrees around the pixel at the fractional position of the pixel value b as indicated by an arrow mark, then the arrangement of the pixels at the integral positions is reversed in the leftward and rightward direction. The pixel at the fractional position of the pixel value b is the central position of the pixels at the integral positions used for the interpolation process (AIF).

The distances from the pixel of the pixel value b are equal with regard to the pixels at the pixel values x5 and x0, and similarly the distances from the pixel of the pixel value b to the pixels of the pixel values x4 and x1 and the distances from the pixel of the pixel value b to the pixels of the pixel values x3 and x2 are equal to each other.

Accordingly, in the example of FIG. 10, if an assumption of symmetry of rotation by 180 degrees around the central position of the pixels at the integral positions to be used for the interpolation process (that is, an AIF) is determined and applied, then the filter coefficients can be reduced as represented by the following expression (23).

[Expression 15]

h_{b,0}=h_{b,5}

h_{b,1}=h_{b,4}

h_{b,2}=h_{b,3} (23)

FIG. 11 represents a positional relationship between the pixels at the fractional positions of the pixel values a and c and the pixels at the integral positions of the pixel values x0 to x5 necessary for the interpolation process. If the positions are rotated by 180 degrees, then the distance between the position of the pixel value a and the position of the pixel value x2 and the distance between the position of the pixel value c and the position of the pixel value x3 are equal to each other. Accordingly, it can be recognized that the distances from the position of the pixel value a to the positions of the x0, x1, x2, x3, x4, x5 are equal to the distances from the position of the pixel value c to the positions of the x5, x4, x3, x2, x1, x0. Also in such a case, the filter coefficients can be reduced like the filter coefficients indicated by the expression (18).

Where the distance relationships between inputted pixels (pixels at integral positions) and pixels to be outputted (pixels at fractional positions) are equal, results of ordinary calculation of optimum filter coefficients described hereinabove with reference to FIGS. 8 and 9 do not exhibit fully equal values as described here because the symmetry is not assumed. However, they usually exhibit proximate values to each other.

It is to be noted that, while FIGS. 10 and 11 illustrate examples of the symmetry in the leftward and rightward direction, also symmetry in the upward and downward direction can be handled similarly as described below.

Now, symmetry of the pixels at the fractional positions of the pixel values d, e, f and g is described. In the example of FIG. 12, pixels after an interpolation process in the horizontal direction is carried out as in the example of FIG. 9 described hereinabove are shown. Accordingly, pixel values at positions of a, b, c, a1, b1, c1, a2, b2, c2, a3, b3, c3, a4, b4, c4, a5, b5 and c5 are obtained by the interpolation process.

If symmetry of filter coefficients can be assumed when the distances between fractional positions to be produced (fractional positions of the pixel values d, e, f and g) and the pixels to be used for interpolation are equal, then it can be recognized that the distances from the fractional position of the pixel value d to the integral positions of the pixel values G1, G2, G, G3, G4 and G5 are equal to the distances from the fractional position of the pixel value e to the pixel values a1, a2, a, a3, a4 and a5 as seen in FIG. 12. This similarly applies also to the case of the fractional positions of the pixel values f and g.

Accordingly, since the filter coefficients of the pixels at the fractional positions of the pixel values d, e, f and g can be made equal as given by the following expression (24), it is necessary to send only the coefficient h_{d,x} at the fractional position of the pixel value d to the decoding side.

[Expression 16]

h_{d,0}=h_{e,0}=h_{f,0}=h_{g,0}

h_{d,1}=h_{e,1}=h_{f,1}=h_{g,1}

h_{d,2}=h_{e,2}=h_{f,2}=h_{g,2}

h_{d,3}=h_{e,3}=h_{f,3}=h_{g,3}

h_{d,4}=h_{e,4}=h_{f,4}=h_{g,4}

h_{d,5}=h_{e,5}=h_{f,5}=h_{g,5} (24)

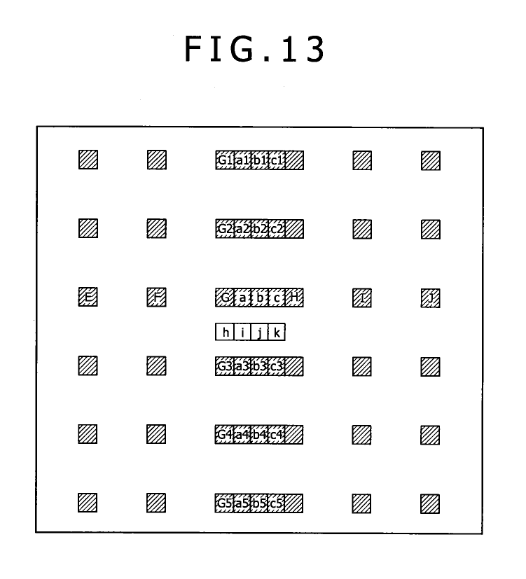

Now, symmetry of the pixels at the fractional positions of the pixel values h, i, j and k is described. In the example of FIG. 13, pixels after an interpolation process in the horizontal direction is carried out and then an interpolation process of pixels at the fractional positions of the pixel values d, e, f and g of FIG. 12 is carried out are shown.

It can be recognized that, similarly to the fractional positions of the pixel values d, e, f and g, with regard to the fractional positions of the pixel values h, i, j and k to be processed, the distances from the fractional position of the pixel value h to the integral positions of the pixel values G1, G2, G, G3, G4 and G5 are equal to the distances from the fractional position of the pixel value i to the pixel values a1, a2, a, a3, a4, a5, as shown in FIG. 13. This similarly applies also to the case of the fractional positions of the pixel values j and k.

Further, the distance from the fractional position of the pixel value h to the integral position of the pixel value G1 and the distance from the fractional position of the pixel value h to the integral position of the pixel value G5 are equal to each other, and the distance from the fractional position of the pixel value h to the integral position of the pixel value G2 and the distance from the fractional position of the pixel value h to the integral position of the pixel value G4 are equal to each other. Moreover, the distance from the fractional position of the pixel value h to the integral position of the pixel value G and the distance from the fractional position of the pixel value h to the integral position of the pixel value G3 are equal to each other. Therefore, symmetry is applied also to the filter coefficients of them. By assuming the symmetry of them, the filter coefficients finally become such as given by the following expression (25). Accordingly, only it is necessary to send the three coefficients h_{d,0}, h_{d,1} and h_{d,2} at the fractional positions of the pixel value h to the decoding side.

[Expression 17]

h_{b,0}=h_{i,0}=h_{j,0}=h_{k,0}h_{b,3}h_{i,3}=h_{j,3}=h_{k,3}

h_{b,1}=h_{i,1}=h_{j,1}=h_{k,1}h_{b,4}h_{i,4}=h_{j,4}=h_{k,4}

h_{b,2}=h_{i,2}=h_{j,2}=h_{k,2}h_{b,5}h_{i,5}=h_{j,5}=h_{k,5} (25)

Further, symmetry of the pixels at the fractional positions of the pixel values l, m, n and o is described. As described hereinabove in regard to the symmetry of the pixels at the fractional positions of the pixel values d, e, f and g with reference to FIG. 12, the filter coefficients at the fractional positions of the pixel values l, m, n and o are equal, and as described hereinabove that filter coefficients become same by rotation of the fractional positions of the pixel values a and c by 180 degrees with reference to FIGS. 10 and 11, filter coefficients become same by reversal of the fractional positions of the pixel values d and l by 180 degrees.

After all, only if the coefficient h_{d,x} at the fractional position of the pixel value d is sent, then there is no necessity to send the filter coefficients at the fractional positions of the pixel values l, m, n and to the decoding side especially.

In the image encoding apparatus 51, such symmetry as described above is assumed and determined and applied to corresponding fractional positions.

### [Description of the Encoding Process of the Image Encoding Apparatus]

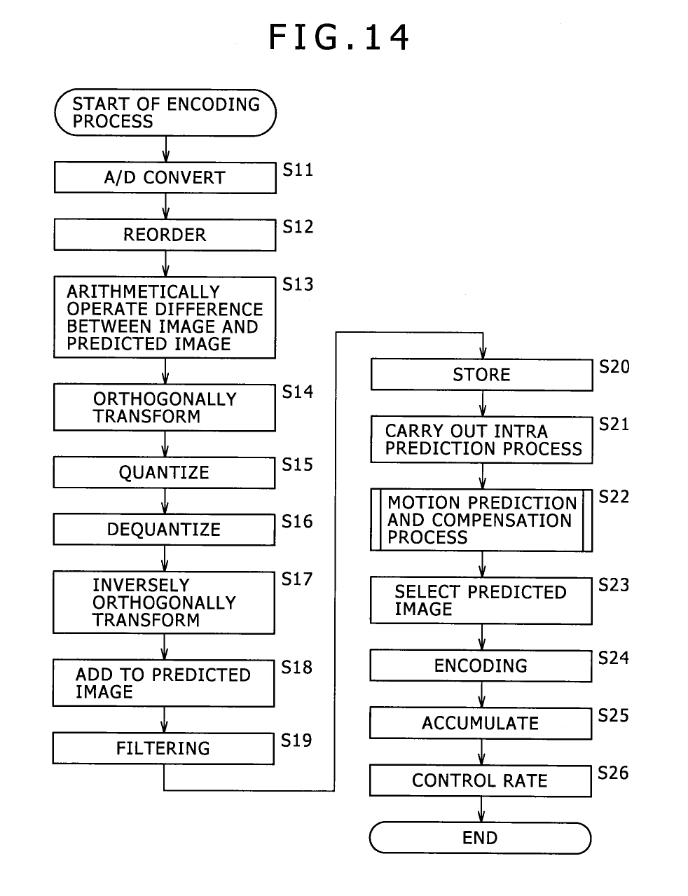

Now, an encoding process of the image encoding apparatus 51 of FIG. 5 is described with reference to a flow chart of FIG. 14.

At step S11, the A/D converter 61 A/D converts an image inputted thereto. At step S12, the screen reordering buffer 62 stores the image supplied thereto from the A/D converter 61 and carries out reordering of pictures from a displaying order to an encoding order.

At step S13, the arithmetic operation section 63 arithmetically operates the difference between the image reordered at step S12 and a predicted image. The predicted image is supplied, in the case where inter prediction is to be carried out, from the motion prediction and compensation section 75, but is supplied, in the case where intra prediction is to be carried out, from the intra prediction section 74, to the arithmetic operation section 63 through the predicted image selection section 76.

The difference data has a data amount reduced in comparison with the original data. Accordingly, the data amount can be compressed in comparison with an alternative case in which an image is encoded as it is.

At step S14, the orthogonal transform section 64 orthogonally transforms the difference information supplied thereto from the arithmetic operation section 63. In particular, orthogonal transform such as discrete cosine transform or Karhunen-Loeve transform is carried out, and transform coefficients are outputted. At step S15, the quantization section 65 quantizes the transform coefficients. Upon this quantization, the rate is controlled as described in a process at step S26 hereinafter described.

The difference information quantized in such a manner as described above is substantially decoded locally. In particular, at step S16, the dequantization section 68 dequantizes the transform coefficients quantized by the quantization section 65 with a characteristic corresponding to the characteristic of the quantization section 65. At step S17, the inverse orthogonal transform section 69 inversely orthogonally transforms the transform coefficients dequantized by the dequantization section 68 with a characteristic corresponding to a characteristic of the orthogonal transform section 64.

At step S18, the arithmetic operation section 70 adds a predicted image inputted thereto from the predicted image selection section 76 to the locally decoded difference information to produce a locally decoded image (image corresponding to the input to the arithmetic operation section 63). At step S19, the deblock filter 71 filters the image outputted from the arithmetic operation section 70. Consequently, block distortion is removed. At step S20, the frame memory 72 stores the filtered image. It is to be noted that also the image not filtered by the deblock filter 71 is supplied from the arithmetic operation section 70 to and stored into the frame memory 72.

At step S21, the intra prediction section 74 carries out an intra prediction process. In particular, the intra prediction section 74 carries out an intra prediction process of all candidate intra prediction modes based on the image read out from the screen reordering buffer 62 so as to be intra predicted and the image supplied thereto from the frame memory 72 through the switch 73 to produce an intra predicted image.

The intra prediction section 74 calculates a cost function value for all candidate intra prediction codes. The intra prediction section 74 determines that one of the intra prediction modes which exhibits a minimum value from among the calculated cost function values as an optimum intra prediction mode. Then, the intra prediction section 74 supplies the intra predicted image produced in the optimum intra prediction mode and the cost function value to the predicted image selection section 76.

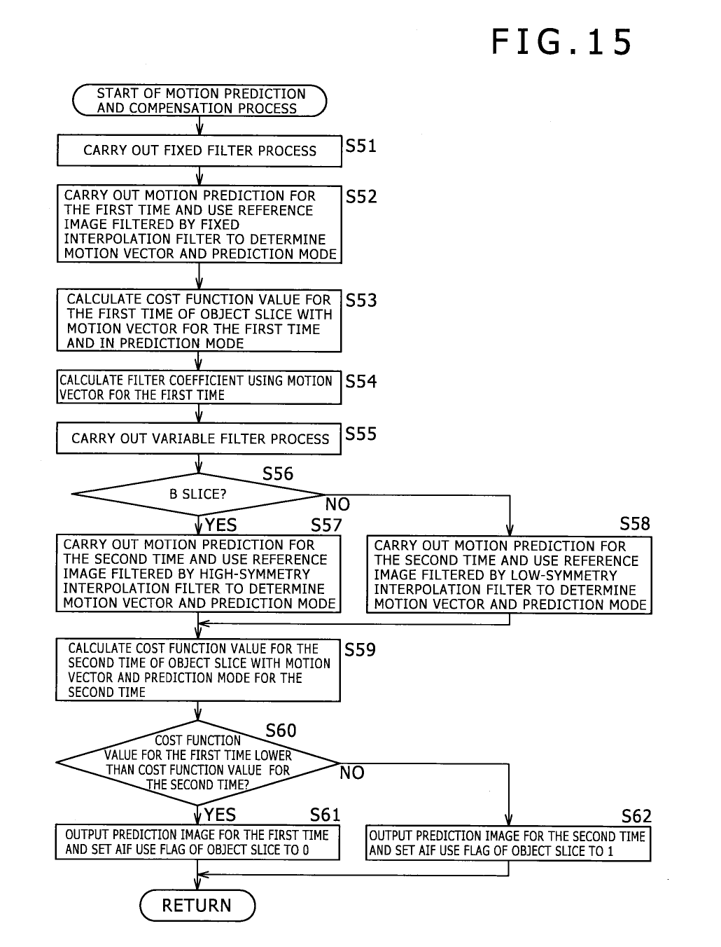

At step S22, the motion prediction and compensation section 75 carries out a motion prediction and compensation process. Details of the motion prediction and compensation process at step S22 are hereinafter described with reference to FIG. 15.

By this process, a fixed filter and a high-symmetry or low-symmetry variable filter suitable for the kind of the slice are used to carry out a filter process, and the filtered reference image is used to determine a motion vector and a prediction mode for each block to calculate a cost function value of the object slice. Then, the cost function value of the object slice by the fixed filter and the cost function value of the object slice by the variable filter are compared with each other, and it is decided based on a result of the comparison whether or not an AIF (variable filter) is to be used. Then, the motion prediction and compensation section 75 supplies the predicted image corresponding to the determination and the cost function value to the predicted image selection section 76.

At step S23, the predicted image selection section 76 determines, based on the cost function values outputted from the intra prediction section 74 and the motion prediction and compensation section 75, one of the optimum intra prediction mode and the optimum inter prediction mode as an optimum prediction mode. Then, the predicted image selection section 76 selects the predicted image of the determined optimum prediction mode and supplies the predicted image to the arithmetic operation sections 63 and 70. This predicted image is utilized for the arithmetic operation at steps S13 and S18 as described hereinabove.

It is to be noted that this selection information of the predicted image is supplied to the intra prediction section 74 or the motion prediction and compensation section 75. In the case where the predicted image of the optimum intra prediction mode is selected, the intra prediction section 74 supplies the information representative of the optimum intra prediction mode (that is, the intra prediction mode information) to the lossless encoding section 66.

In the case where the predicted image of the optimum inter prediction mode is selected, the motion compensation portion 88 of the motion prediction and compensation section 75 outputs the information indicative of the optimum inter prediction mode, motion vector information and reference frame information to the lossless encoding section 66. Further, the motion compensation portion 88 outputs information of the kind of the slice and the slice header information which includes the AIF use flag information for each slice to the lossless encoding section 66.

Further, in the case where the predicted image selection section 76 selects the inter predicted image and a variable filter is to be used in the object slice, when the object slice is a P slice, the selector 89 outputs 51 filter coefficients from the low-symmetry filter coefficient calculation portion 83 to the lossless encoding section 66 under the control of the control part 90. In the case where the predicted image selection section 76 selects the inter predicted image and a variable filter is to be used in the object slice, when the object slice is a B slice, the selector 89 outputs 18 filter coefficients from the high-symmetry filter coefficient calculation portion 85 to the lossless encoding section 66 under the control of the control part 90.

At step S24, the lossless encoding section 66 encodes a quantized transform coefficient outputted from the quantization section 65. In particular, a difference image is reversibly encoded by variable length encoding, arithmetic encoding or the like and compressed. At this time, also the intra prediction mode information from the intra prediction section 74 or the optimum inter prediction mode from the motion prediction and compensation section 75 and such various kinds of information as described above, which are inputted to the lossless encoding section 66 at step S23 described hereinabove, are encoded and added to the header information.

For example, the information indicative of the inter prediction mode is encoded for each macro block. The motion vector information or the reference frame information is encoded for each object block. Further, the slice information, AIF use flag information and filter coefficient in accordance with the slice are encoded for each slice.

At step S25, the accumulation buffer 67 accumulates the difference signal as a compressed signal. The compressed image accumulated in the accumulation buffer 67 is read out suitably and transmitted to the decoding side through a transmission path.

At step S26, the rate controlling section 77 controls the rate of the quantization operation of the quantization section 65 based on the compressed image accumulated in the accumulation buffer 67 so that an overflow or an underflow may not occur.

### [Description of the Motion Prediction and Compensation Process]

Now, the motion prediction and compensation process at step S22 of FIG. 14 is described with reference to a flow chart of FIG. 15.

In the case where the image of the processing object supplied from the screen reordering buffer 62 is an image to be inter processed, an image to be referred to is read out from the frame memory 72 and supplied to the fixed interpolation filter 81 through the switch 73. Further, the image to be referred to is inputted also to the low-symmetry interpolation filter 82, low-symmetry filter coefficient calculation portion 83, high-symmetry interpolation filter 84 and high-symmetry filter coefficient calculation portion 85.

At step S51, the fixed interpolation filter 81 carries out a fixed filter process for the reference image. In particular, the fixed interpolation filter 81 carries out a filter process for the reference image from the frame memory 72 and outputs the reference image after the fixed filter process to the motion prediction portion 87 and the motion compensation portion 88.

Since the reference image after the fixed filtering from the fixed interpolation filter 81 is inputted to the motion prediction portion 87 and the motion compensation portion 88, at step S52, the motion prediction portion 87 and the motion compensation portion 88 carry out motion prediction for the first time and determine a motion vector and a prediction mode using the reference image filtered by the fixed interpolation filter 81.

In particular, the motion prediction portion 87 produces motion vectors for the first time for all candidate inter prediction modes based on the input image from the screen reordering buffer 62 and the reference image after the fixed filtering, and outputs the produced motion vectors to the motion compensation portion 88. It is to be noted that the motion vectors for the first time are outputted also to the low-symmetry filter coefficient calculation portion 83 and the high-symmetry filter coefficient calculation portion 85, by which they are used in a process at step S54 hereinafter described.

The motion compensation portion 88 carries out a compensation process for the reference image after the fixed filtering using the motion vectors for the first time to produce a predicted image. Then, the motion compensation portion 88 calculates a cost function value for each block and compares such function values with each other to determine an optimum inter prediction mode.

After the processes described above are carried out for each block and processing of all blocks in the object slice comes to an end, the motion compensation portion 88 calculates, at step S53, a cost function value for the first time of the object slice with the motion vectors for the first time and in the optimum inter prediction mode.

At step S54, the low-symmetry filter coefficient calculation portion 83 and the high-symmetry filter coefficient calculation portion 85 use the motion vectors for the first time from the motion prediction portion 87 to calculate low-symmetry filter coefficients and high-symmetry filter coefficients.

In particular, the low-symmetry filter coefficient calculation portion 83 uses the input image from the screen reordering buffer 62, reference image from the frame memory 72 and motion vectors for the first time from the motion prediction portion 87 to calculate low-symmetry filter coefficients for approximating the reference image after the filter process of the low-symmetry interpolation filter 82 to the input image, that is, the AIF filter coefficient described in Non-Patent Document 2. At this time, the 51 filter coefficients are calculated as shown in FIG. 7. The low-symmetry filter coefficient calculation portion 83 supplies the calculated filter coefficients to the low-symmetry interpolation filter 82 and the selector 89.

Meanwhile, the high-symmetry filter coefficient calculation portion 85 uses the input image from the screen reordering buffer 62, reference image from the frame memory 72 and motion vectors for the first time from the motion prediction portion 87 to calculate high-symmetry filter coefficients for approximating the reference image after the filter process of the high-symmetry interpolation filter 84 to the input image. At this time, 18 filter coefficients are calculated as shown in FIG. 7. The high-symmetry filter coefficient calculation portion 85 supplies the calculated filter coefficients to the high-symmetry interpolation filter 84 and the selector 89.

It is to be noted that the filter coefficients supplied to the selector 89 are outputted, when a predicted image of an optimum inter prediction mode is selected and a variable filter is used in the object slice at step S23 of FIG. 15 described hereinabove, to the lossless encoding section 66 in response to the kind of the object slice, and are encoded at step S24.

At step S55, the low-symmetry interpolation filter 82 and the high-symmetry interpolation filter 84 carry out a variable filter process for the reference image. In particular, the low-symmetry interpolation filter 82 carries out a filter process for the reference image from the frame memory 72 using the 51 filter coefficients calculated by the low-symmetry filter coefficient calculation portion 83 and outputs the reference image after the variable filter process to the selector 86.

Meanwhile, the high-symmetry interpolation filter 84 carries out a filter process for the reference image from the frame memory 72 using the 18 filter coefficients calculated by the high-symmetry filter coefficient calculation portion 85 and outputs the reference image after the variable filter process to the selector 86.

At step S56, the control part 90 decides whether or not the slice of the processing object is a B slice. If it is decided that the slice of the processing object is a B slice, then the control part 90 controls the selector 86 to select the reference image after the variable filtering from the high-symmetry interpolation filter 84. Then, the processing advances to step S57.

The reference image after the variable filtering from the high-symmetry interpolation filter 84 is inputted from the selector 86 to the motion prediction portion 87 and the motion compensation portion 88. The motion prediction portion 87 and the motion compensation portion 88 carry out, at step S57, motion prediction for the second time and use the reference image filtered by the high-symmetry interpolation filter 84 to determine motion vectors and a prediction mode.

In particular, the motion prediction portion 87 produces motion vectors for the second time for all candidate inter prediction modes based on the input image from the screen reordering buffer 62 and the reference image after the variable filtering from the selector 86 and outputs the produced motion vectors to the motion compensation portion 88.

The motion compensation portion 88 uses the motion vectors for the second time to carry out a compensation process for the reference image after the variable filtering from the selector 86 to produce a predicted image. Then, the motion compensation portion 88 calculates a cost function value for each block and compares such cost function values with each other to determine an optimum inter prediction mode.

On the other hand, if it is decided at step S56 that the slice of the processing object is not a B slice, that is, if it is decided that the slice of the processing object is a P slice, then the selector 86 selects the reference image after the variable filtering from the low-symmetry interpolation filter 82. Then, the processing advances to step S58.

Since the reference image after the variable filtering from the low-symmetry interpolation filter 82 is inputted from the selector 86 to the motion prediction portion 87 and the motion compensation portion 88. The motion prediction portion 87 and the motion compensation portion 88 carry out, at step S58, motion prediction for the second time and determine motion vectors and a prediction mode using the reference image filtered by the low-symmetry interpolation filter 82.

In particular, the motion prediction portion 87 produces motion vectors for the second time for all candidate inter prediction modes based on the input image from the screen reordering buffer 62 and the reference image after the variable filtering from the selector 86. Then, the motion prediction portion 87 outputs the produced motion vectors to the motion compensation portion 88.

The motion compensation portion 88 uses the motion vectors for the second time to carry out a compensation process for the reference image after the variable filtering from the selector 86 to produce a predicted image. Then, the motion compensation portion 88 calculates a cost function value for each block and compares such cost function values with each other to determine an optimum inter prediction mode.

Such processes as described above are carried out for each block, and after the processes for all blocks in the object slice come to an end, the motion compensation portion 88 calculates a cost function value for the second time of the object slice with the motion vectors for the second time and the optimum inter prediction mode at step S59.

At step S60, the motion compensation portion 88 compares the cost function value for the first time and the cost function value for the second time of the object slice with each other to decide whether or not the cost function value for the first time of the object slice is lower than the cost function value for the second time.

If it is decided that the cost function value for the first time of the object slice is lower than the cost function value for the second time, then the processing advances to step S61. At step S61, the motion compensation portion 88 determines to use a fixed filter for the object slice and supplies the prediction image for the first time (produced with the reference image after the fixed filtering) and the cost function value to the predicted image selection section 76 and then sets the AIF use flag of the object slice to 0.

If it is decided that the cost function value for the first time of the object slice is not lower than the cost function value for the second time, then the processing advances to step S62. At step S62, the motion compensation portion 88 determines to use a variable filter (AIF) for the object slice and supplies the predicted image for the second time (produced with the reference image after the variable filtering) and the cost function value to the predicted image selection section 76 and then sets the value of the AIF use flag of the object slice to 1.

The set information of the AIF use flag of the object slice is outputted, if the predicted image of the optimum inter prediction mode is selected at step S23 of FIG. 15 described hereinabove, to the lossless encoding section 66 together with the slice information under the control of the control part 90. Then, the information of the AIF use flag is encoded at step S24.

As described above, in the image encoding apparatus 51, in the case where symmetry determined in advance is assumed with regard to pixel positions of fractional accuracy and is applied to the pixel positions of the fractional accuracy, a filter process by a high-symmetry filter which uses same filter coefficients or filter coefficients obtained by reversing the filter coefficients with respect to the central position of pixels at integral positions to be used in an AIF is carried out.

Consequently, the number of filter coefficients to be included into stream information can be reduced further. As a result, the encoding efficiency can be improved.

Further, the filter process by the high-symmetry filter is carried out particularly when the object slice is a B slice. Since the B slice originally has a code bit amount smaller than that of the P slice, if filter coefficients of an AIF are included into the stream information, then the overhead becomes comparatively great in ratio. Accordingly, since, as the tap number of a filter decreases, also the number of filter coefficients becomes smaller, also the overhead of the filter coefficients to be included into the stream information can be reduced. As a result, the encoding ratio can be improved.

Further, since the necessity to include a description of symmetry, which represents which pixels resemble each other, into stream information as in Non-Patent Document 3 is eliminated, the overhead can be reduced.

Further, in the image encoding apparatus 51, the number of filter coefficients required when encoding of an object slice is to be started is decided. Accordingly, since the necessity to check the symmetry of filter coefficients and retry calculation as in Non-Patent Document 3 is eliminated, the arithmetic operation amount is reduced.

The encoded compressed image is transmitted through a predetermined transmission path and decoded by the image decoding apparatus.

### [Example of the Configuration of the Image Decoding Apparatus]

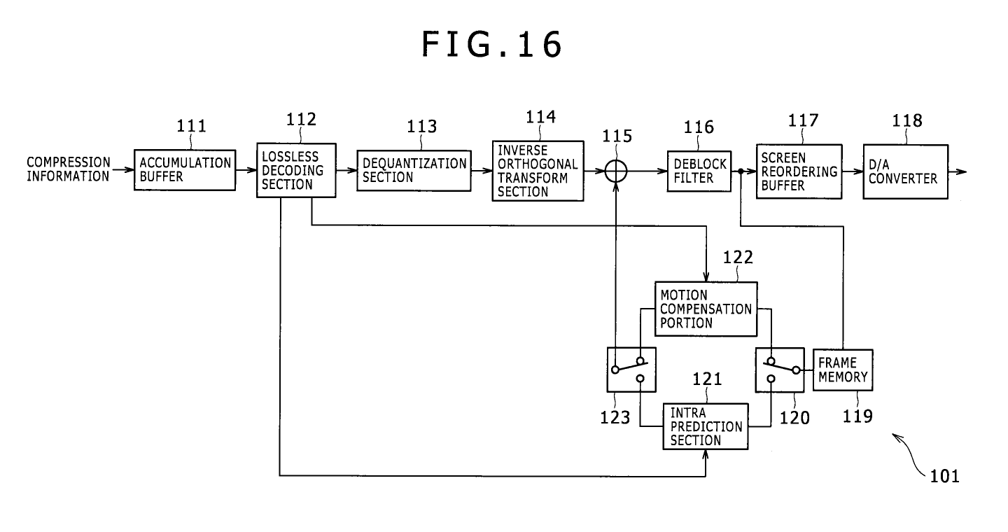

FIG. 16 shows a configuration of a first embodiment of an image decoding apparatus as an image processing apparatus to which the present invention is applied.

The image decoding apparatus 101 is configured from an accumulation buffer 111, a lossless decoding section 112, a dequantization section 113, an inverse orthogonal transform section 114, an arithmetic operation section 115, a deblock filter 116, a screen reordering buffer 117, a D/A converter 118, a frame memory 119, a switch 120, an intra prediction section 121, a motion compensation portion 122 and a switch 123.

The accumulation buffer 111 accumulates a compressed image transmitted thereto. The lossless decoding section 112 decodes information supplied thereto from the accumulation buffer 111 and encoded by the lossless encoding section 66 of FIG. 5 in accordance with a method corresponding to the encoding method of the lossless encoding section 66. The dequantization section 113 dequantizes an image decoded by the lossless decoding section 112 in accordance with a method corresponding to the quantization method of the quantization section 65 of FIG. 5. The inverse orthogonal transform section 114 inversely orthogonally transforms an output of the dequantization section 113 in accordance with a method corresponding to the orthogonal transform method of the orthogonal transform section 64 of FIG. 5.

The inversely orthogonally transformed output is added to a predicted image supplied thereto from the switch 123 and is decoded by the arithmetic operation section 115. The deblock filter 116 removes block distortion of the decoded image and supplies a resulting image to the frame memory 119 so as to be accumulated into the frame memory 119 and besides outputs the resulting image to the screen reordering buffer 117.

The screen reordering buffer 117 carries out reordering of an image. In particular, the order of frames reordered into the order for encoding by the screen reordering buffer 62 of FIG. 5 is reordered into the original displaying order. The D/A converter 118 D/A converts the image supplied thereto from the screen reordering buffer 117 and outputs the resulting image to a display unit not shown so as to be displayed on the display unit.

The switch 120 reads out an image to be referred to from the frame memory 119 and outputs the image to the motion compensation portion 122. Further, the switch 120 reads out an image to be used for intra prediction from the frame memory 119 and supplies the image to the intra prediction section 121.

To the intra prediction section 121, information representative of the intra prediction mode obtained by decoding header information is supplied from the lossless decoding section 112. The intra prediction section 121 produces a predicted image based on this information and outputs the produced predicted image to the switch 123.

To the motion compensation portion 122, the inter prediction mode information, motion vector information, reference frame information, AIF use flag information, filter coefficients and so forth from within the information obtained by decoding the header information are supplied from the lossless decoding section 112. The inter prediction mode information is transmitted for each macro block. The motion vector information and the reference frame information are transmitted for each object block. The information of the kind of the slice, the AIF use flag information, filter coefficients suitable for the slice and so forth are transmitted as slice header for each object slice.

In the case where the object slice uses an AIF, filter coefficients of two different types of interpolation filters are supplied from the lossless decoding section 112 to the motion compensation portion 122. For example, in the case where the object slice is a P slice, 51 filter coefficients determined by the encoding side because the number of pixels to which symmetry is applied is small, that is, the symmetry is low, are supplied. In contrast, 18 filter coefficients determined by the encoding side because it is decided that the number of pixels to which symmetry is applied is great, that is, the symmetry is high, are supplied.

The motion compensation portion 122 uses variable interpolation filters for which filter coefficients in accordance with the type of the object slice are used to carry out a variable filter process for the reference image from the frame memory 119. Then, the motion compensation portion 122 uses a motion vector from the lossless decoding section 112 to carry out a compensation process for the reference image after the variable filter process to produce a predictive image of the object block. The produced predicted image is outputted to the arithmetic operation section 115 through the switch 123.

Alternatively, if the object slice included in the object block is not to use an AIF, then the motion compensation portion 122 uses fixed interpolation filters to carry out a fixed filter process for the reference image from the frame memory 119. Then, the motion compensation portion 122 carries out a compensation process for the reference image after the fixed filter process using the motion vector from the lossless decoding section 112 to produce a predicted image of the objet block. The produced predicted image is outputted to the arithmetic operation section 115 through the switch 123.

The switch 123 selects a predicted image produced by the motion compensation portion 122 or the intra prediction section 121 and supplies the predicted image to the arithmetic operation section 115.

### [Example of the Configuration of the Motion Compensation Portion]

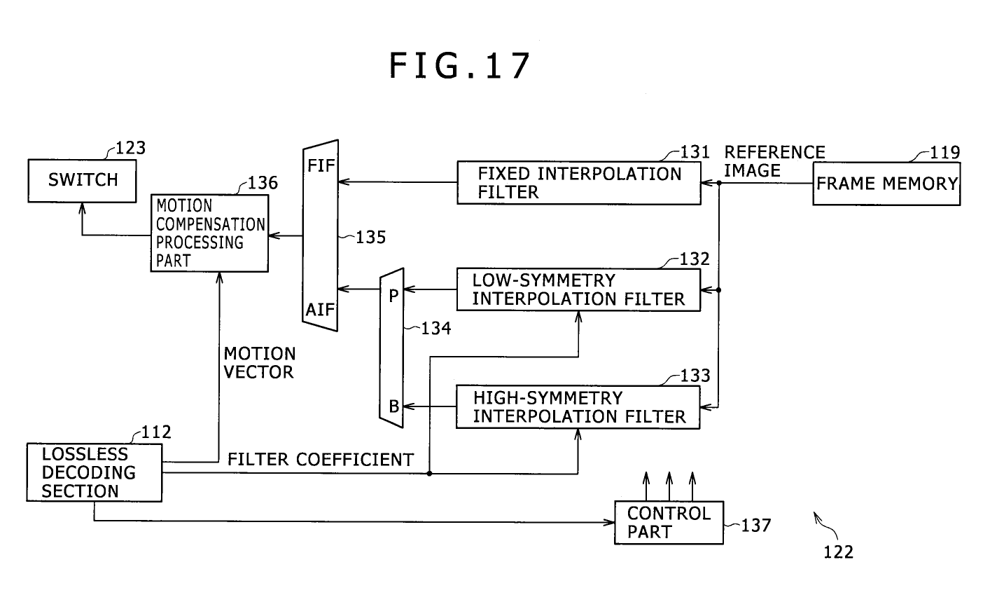

FIG. 17 is a block diagram showing an example of a detailed configuration of the motion compensation portion 122. It is to be noted that, in FIG. 17, the switch 120 of FIG. 16 is omitted.

In the example of FIG. 17, the motion compensation portion 122 is configured from a fixed interpolation filter 131, a low-symmetry interpolation filter 132, a high-symmetry interpolation filter 133, selectors 134 and 135, a motion compensation processing part 136 and a control part 137.

For each slice, slice information representative of a kind of the slice and AIF use flag information are supplied from the lossless decoding section 112 to the control part 137, and the filter coefficients are supplied to the low-symmetry interpolation filter 132 or the high-symmetry interpolation filter 133 according to the number of the kind of the slice. Also information representative of an inter prediction mode for each macro block or a motion vector for each block from the lossless decoding section 112 is supplied to the motion compensation processing part 136 while reference frame information is supplied to the control part 137.

A reference image from the frame memory 119 is inputted to the fixed interpolation filter 131, the low-symmetry interpolation filter 132, and the high-symmetry interpolation filter 133 under the control of the control part 137.

The fixed interpolation filter 131 is an interpolation filter of six taps having fixed coefficients prescribed in the H.264/AVC method, and carries out a filter process for the reference image from the frame memory 119 and outputs the reference image after the fixed filter process to the selector 135.

The low-symmetry interpolation filter 132 is an interpolation filter of variable filter coefficients which applies symmetry to a number of pixels smaller than that of the high-symmetry interpolation filter 133. For the low-symmetry interpolation filter 132, for example, the AIF filter disclosed in Non-Patent Document 2 is used. The low-symmetry interpolation filter 132 carries out a filter process for the reference image from the frame memory 119 using the 51 filter coefficients supplied from the lossless decoding section 112 and outputs the reference image after the variable filter process to the selector 134.

The high-symmetry interpolation filter 133 is an interpolation filter of variable filter coefficients which applies symmetry to a number of pixels greater than that of the low-symmetry interpolation filter 132. The high-symmetry interpolation filter 133 carries out a filter process for the reference image from the frame memory 119 using the 18 filter coefficients supplied from the lossless decoding section 112 and outputs the reference image after the variable filter process to the selector 134.

The selector 134 selects, in the case where the slice of the processing object is a P slice, the reference image after the variable filtering from the low-symmetry interpolation filter 132 and outputs the selected reference image to the selector 135 under the control of the control part 137. The selector 134 selects, in the case where the slice of the processing object is a B slice, the reference image after the variable filtering from the high-symmetry interpolation filter 133 and outputs the selected reference image to the selector 135 under the control of the control part 137.

The selector 135 selects, in the case where the slice of the processing object uses an AIF, the reference image after the variable filtering from the selector 134 and outputs the selected reference image to the motion compensation processing part 136 under the control of the control part 137. The selector 135 selects, in the case where the slice of the processing object does not use an AIF, the reference image after the fixed filtering from the fixed interpolation filter 131 and outputs the selected reference image to the motion compensation processing part 136 under the control of the control part 137.

The motion compensation processing part 136 uses motion vectors from the lossless decoding section 112 to carry out an interpolation process for the reference image after the filtering inputted from the selector 135 and produces a predicted image of the object block and then outputs the produced predicted image to the switch 123.

The control part 137 acquires, for each slice, information of a kind of the slice from the lossless decoding section 112 and the AIF use flag, and controls selection of the selector 134 based on the kind of the slice including the processing object block. In particular, in the case where the slice including the processing object block is a P slice, the control part 137 controls the selector 134 to select the reference image after the low-symmetry variable filtering. However, in the case where the slice including the processing object block is a B slice, the control part 137 controls the selector 134 to select a reference image after the high-symmetry variable filtering.

Further, the control part 137 refers to the acquired AIF use flag and controls selection of the selector 135 based on whether or not an AIF is used. In particular, in the case where the slice in which the processing object block is included uses an AIF, the control part 137 controls the selector 135 to select the reference image after the variable filtering from the selector 134. However, in the case where the slice in which the processing object block is included does not use an AIF, the control part 137 controls the selector 135 to select the reference image after the fixed filtering from the fixed interpolation filter 131.

### [Description of the Decoding Process of the Image Decoding Apparatus]

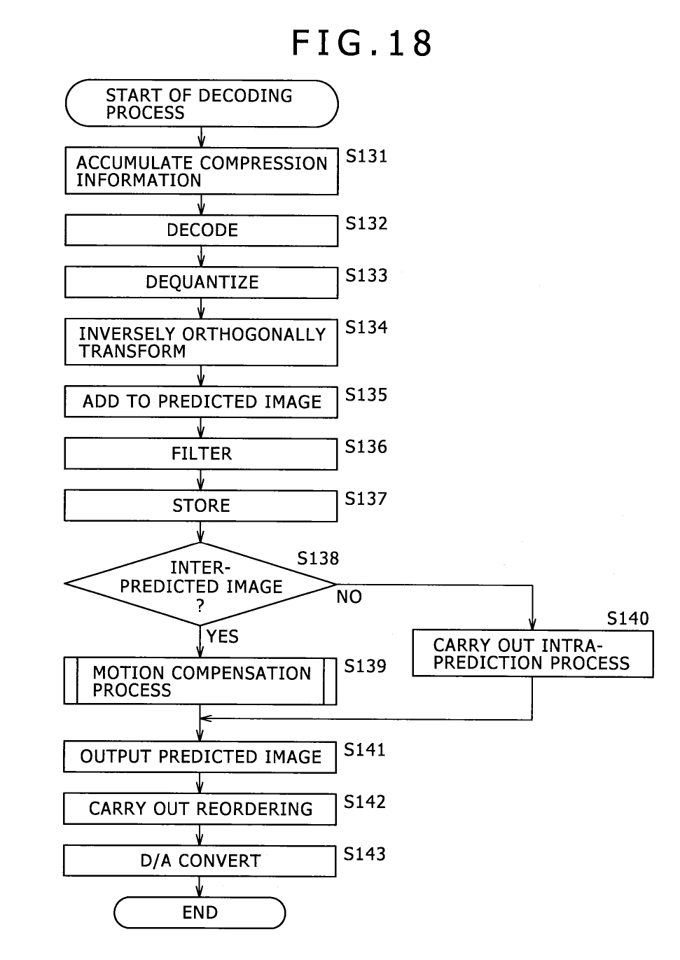

Now, a decoding process executed by the image decoding apparatus 101 is described with reference to a flow chart of FIG. 18.

At step S131, the accumulation buffer 111 accumulates an image transmitted thereto. At step S132, the lossless decoding section 112 decodes the compressed image supplied thereto from the accumulation buffer 111. In particular, I pictures, B pictures and P pictures encoded by the lossless encoding section 66 of FIG. 5 are decoded.

At this time, also motion vector information, reference frame information and so forth are decoded for each block. Further, for each macro block, also prediction mode information (information representative of the intra prediction mode or the inter prediction mode) and so forth are decoded. Furthermore, for each slice, also slice information including information of a kind of the slice, AIF use flag information, filter coefficients and so forth are decoded.

At step S133, the dequantization section 113 dequantizes transform coefficients decoded by the lossless decoding section 112 with a characteristic corresponding to the characteristic of the quantization section 65 of FIG. 5. At step S134, the inverse orthogonal transform section 114 inversely orthogonally transforms transform coefficients dequantized by the dequantization section 113 with a characteristic corresponding to the characteristic of the orthogonal transform section 64 of FIG. 5. Consequently, difference information corresponding to the input of the orthogonal transform section 64 (output of the arithmetic operation section 63) of FIG. 5 is decoded.

At step S135, the arithmetic operation section 115 adds a predicted image selected by a process at step S141 hereinafter described and inputted thereto through the switch 123 to the difference information, whereby the original image is decoded. At step S136, the deblock filter 116 filters the image outputted from the arithmetic operation section 115. By this, block distortion is removed. At step S137, the frame memory 119 stores the filtered image.

At step S138, the lossless decoding section 112 determines, based on a result of the lossless decoding of the header part of the compressed image, whether or not the compressed image is an inter prediction image, that is, whether or not the lossless decoding result includes information representative of an optimum inter prediction mode.

If it is determined at step S138 that the compressed image is an inter prediction image, then the lossless decoding section 112 supplies the motion vector information, reference frame information, information representative of the optimum inter prediction mode, information of the slice header (that is, information of the kind of the slice, AIF use flag information, filter coefficient) and so forth to the motion compensation portion 122.

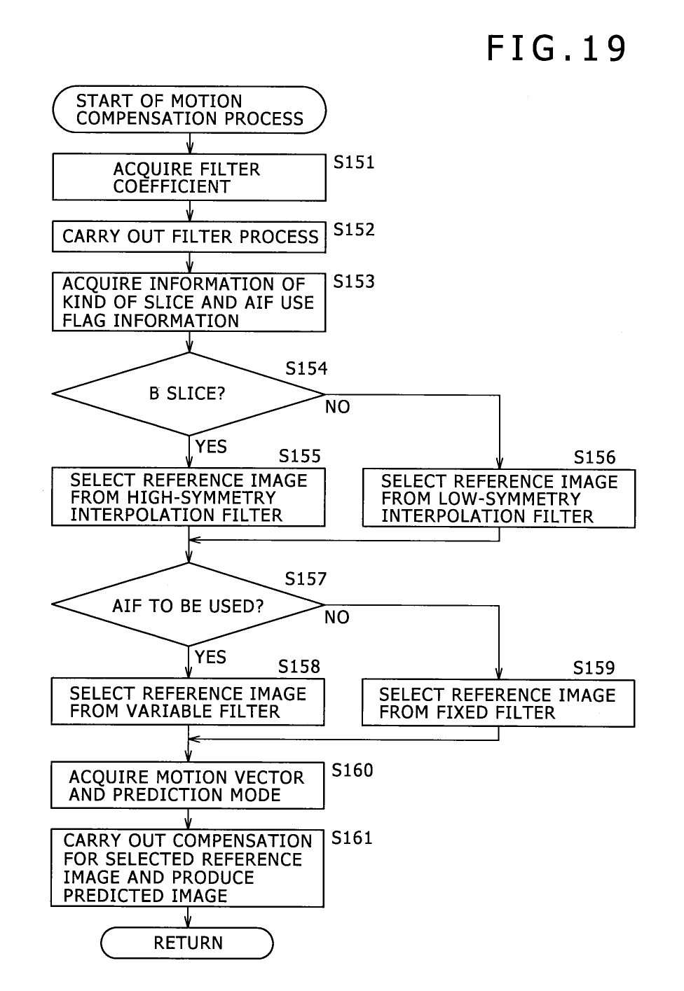

Then at step S139, the motion compensation portion 122 carries out a motion compensation process. Details of the motion compensation process at step S139 are hereinafter described with reference to FIG. 19.

By this process, when the object slice uses an AIF, the variable filter, in which filter coefficient has a number suitable for the kind of the slice, is used, that is, high-symmetry variable filter is used to carry out a filter process. In the case where the object slice does not yet use an AIF, the conventional fixed filter is used to carry out a filter process. Thereafter, a compensation process is carried out for the reference image after the filter process using motion vectors, and a prediction image produced thereby is outputted to the switch 123.

On the other hand, if it is determined at step S138 that the compressed image is not an inter prediction image, that is, in the case where the lossless decoding result includes information representative of an optimum intra prediction mode, the lossless decoding section 112 supplies information representative of the optimum intra prediction mode to the intra prediction section 121.

Then at step S140, the intra prediction section 121 carries out an intra prediction process for the image from the frame memory 119 in the optimum intra prediction mode representative of the information from the lossless decoding section 112 to produce an intra prediction image. Then, the intra prediction section 121 outputs the intra prediction image to the switch 123.

At step S141, the switch 123 selects and outputs a predicted image to the arithmetic operation section 115. In particular, a predicted image produced by the intra prediction section 121 or a predicted image produced by the motion compensation portion 122 is supplied to the switch 123. Accordingly, the predicted image supplied is selected and outputted to the arithmetic operation section 115 and is added to an output of the inverse orthogonal transform section 114 at step S135 as described hereinabove.

At step S142, the screen reordering buffer 117 carries out reordering. In particular, the order of frames reordered for encoding by the screen reordering buffer 62 of the image encoding apparatus 51 is reordered into the original displaying order.

At step S143, the D/A converter 118 D/A converts the image from the screen reordering buffer 117. This image is outputted to and displayed on a display unit not shown.

### [Description of the Motion Compensation Process of the Image Decoding Apparatus]

Now, the motion compensation process at step S139 of FIG. 18 is described with reference to a flow chart of FIG. 19.

At step S151, the low-symmetry interpolation filter 132 or the high-symmetry interpolation filter 133 acquires filter coefficients from the lossless decoding section 112. If 51 filter coefficients are sent thereto, then the low-symmetry interpolation filter 132 acquires the same, but if 18 filter coefficients are sent thereto, then the high-symmetry interpolation filter 133 acquires the same. It is to be noted that, since filter coefficients are transmitted for each slice only where an AIF is used, the process at step S151 is skipped in any other case.

A reference image from the frame memory 119 is inputted to the fixed interpolation filter 131, low-symmetry interpolation filter 132, and high-symmetry interpolation filter 133 under the control of the control part 137.

At step S152, the fixed interpolation filter 131, low-symmetry interpolation filter 132, and high-symmetry interpolation filter 133 carry out a filter process for the reference image from the frame memory 119.

In particular, the fixed interpolation filter 131 carries out a filter process for the reference image from the frame memory 119 and outputs the reference image after the fixed filter process to the selector 135.

The low-symmetry interpolation filter 132 carries out a filter process for the reference image from the frame memory 119 using the 51 filter coefficients supplied thereto from the lossless decoding section 112 and outputs the reference image after the variable filter process to the selector 134. The high-symmetry interpolation filter 133 carries out a filter process for the reference image from the frame memory 119 using an interpolation filter of the 18 filter coefficients supplied thereto from the lossless decoding section 112 and outputs the reference image after the variable filter process to the selector 134.

The control part 137 acquires the information of a kind of the slice and the AIF use flag information from the lossless decoding section 112 at step S153. It is to be noted that, since the information mentioned is transmitted to and acquired by the control part 137 for each slice as slice header, this process is skipped in any other case.

At step S154, the control part 137 determines whether or not the processing object slice is a B slice. If it is decided that the processing object slice is a B slice, then the processing advances to step S155.

At step S155, the selector 134 selects the reference image after the variable filtering from the high-symmetry interpolation filter 133 and outputs the selected reference image to the selector 135 under the control of the control part 137.

On the other hand, if it is determined at step S154 that the processing object slice is not a B slice, that is, if it is determined that the processing object slice is a P slice, then the processing advances to step S156.

At step S156, the selector 134 selects, if the processing object slice is a P slice, the reference image after the variable filtering from the low-symmetry interpolation filter 132 and outputs the selected reference image to the selector 135 under the control of the control part 137.

At step S157, the control part 137 refers to the AIF use flag information from the lossless decoding section 112 to determine whether or not the processing object slice uses an AIF, and if it is determined that the processing object slice uses an AIF, then the processing advances to step S158. At step S158, the selector 135 selects the reference image after the variable filtering from the selector 134 and outputs the selected reference image to the motion compensation processing part 136 under the control of the control part 137.

If it is determined at step S157 that the processing object slice does not use an AIF, then the processing advances to step S159. At step S159, the selector 135 selects the reference image after the fixed filtering from the fixed interpolation filter 131 and outputs the selected reference image to the motion compensation processing part 136 under the control of the control part 137.

At step S160, the motion compensation processing part 136 acquires motion vector information of the object block and inter prediction mode information of the macro block in which the object block is included.

At step S161, the motion compensation processing part 136 uses the acquired motion vectors to carry out compensation for the reference image selected by the selector 135 to produce a predicted image and outputs the produced predicted image to the switch 123.

As described above, in the image encoding apparatus 51 and the image decoding apparatus 101, the symmetry of pixel positions of fractional accuracy are determined in advance, and the same filter coefficient is used for pixels between which the symmetry is determined. Consequently, the number of filters to be included into stream information can be reduced further. As a result, the encoding efficiency can be improved.

Particularly, according to the present invention, the overhead of information of filter coefficients in a B slice is reduced, and the encoding efficiency can be improved. Since the filter coefficients of a B slice are reduced as described above, the number of bits of filter coefficient information which must be included into stream information when the object slice is a B slice can be reduced. Since the B slice is small in generation bit amount in comparison with the P slice, a situation in which the overhead by filter coefficients in a B slice cannot be ignored increases. Since the filter coefficients are reduced in such B slice, improvement of the encoding efficiency can be achieved effectively.

Further, the necessity for inclusion of a descriptor of symmetry into stream information as in Non-Patent Document 3 is eliminated, and also it is possible to reduce the overhead.

It is to be noted that, while, in the foregoing description, an example wherein, in the case of a B slice, the number of filter coefficients is reduced depending upon the symmetry determined in advance is described, the number of filter coefficients may be reduced by the symmetry determined in advance depending upon the magnitude of a quantization parameter QP. In this instance, for example, a threshold value is determined in advance for the quantization parameter QP, and when the value of the quantization parameter QP of a certain slice is higher than the threshold value, the interpolation method used in the case of the B slice described above is applied.

In the case where the slice QP is great, since the generation bit amount of the slice is small, the overhead by filter coefficients cannot be ignored any more. In the case where QP is great, since it is made possible to reduce the number of filter coefficients, it is possible to reduce the overhead and this can contribute to improvement of the encoding efficiency.

Further, it is possible to reduce the number of filter coefficients, in the case of other than a B slice, depending upon the image (image frame) size and depending upon the symmetry determined in advance. In this instance, a threshold value is determined in advance for the magnitude of the image size, and if the image size of the sequence is the threshold value or higher, then the interpolation method used in the case of the B slice described hereinabove is applied.

Also in the case where the image size is small, the bit generation amount of a picture is small. Accordingly, since the number of filter coefficients is reduced in the case where the image size is small, the overhead can be reduced, and this can be contribute to improvement in encoding efficiency.

While the foregoing description is given taking an interpolation filter of a Separable AIF as an example, the structure of the filter is not limited to the Separable AIF. In other words, even if the filter structure is different, the present invention can be applied to the filter. It is to be noted that, in the case of the Separable AIF, symmetry is determined as described hereinabove with reference to FIGS. 10 and 11 and the same filter coefficients are used for the pixels illustrated in FIG. 7. Similarly, in the case of different interpolation filters, symmetry in accordance with the interpolation filter is assumed and it is determined for which pixel positions the same filter coefficient is to be used.

Incidentally, also with an encoder and a decoder in which an AIF is used like the image encoding apparatus 51 of FIG. 5 and the image decoding apparatus 101 of FIG. 16, in the case where an AIF is not used as described above, an interpolation filter of the H.264/AVC method (fixed interpolation filter 81 of FIG. 6 and fixed interpolation filter 131 of FIG. 17) is used. Accordingly, it is necessary for the encoder and the decoder to include both of an interpolation filter for an AIF and an interpolation filter of the H.264/AVC method.

For example, in the motion compensation portion 122 of the image decoding apparatus 101 shown in FIG. 17, if the AIF use flag information from the encoding side is “1”: AIF use, then the selector selects an interpolation result of the low-symmetry interpolation filter 132 or the high-symmetry interpolation filter 133 (that is, an AIF) and outputs the selected interpolation result to the motion compensation processing part 136 under the control of the control part 137. On the other hand, if the AIF use flag information from the encoding side is “0”: AIF non-use, then the selector selects an interpolation result of the fixed interpolation filter 131 (that is, an interpolation filter of the H.264/AVC method) and outputs the selected interpolation result to the motion compensation processing part 136.

In the case where such interpolation processes are incorporated not in software but in hardware such as an LSI, it is necessary for both filters to be provided as circuits, and this results in increase of circuitry and increase in fabrication cost. Therefore, an example wherein a fixed interpolation filter is omitted is described below.

### [Example of the Configuration of the Motion Prediction and Compensation Section]

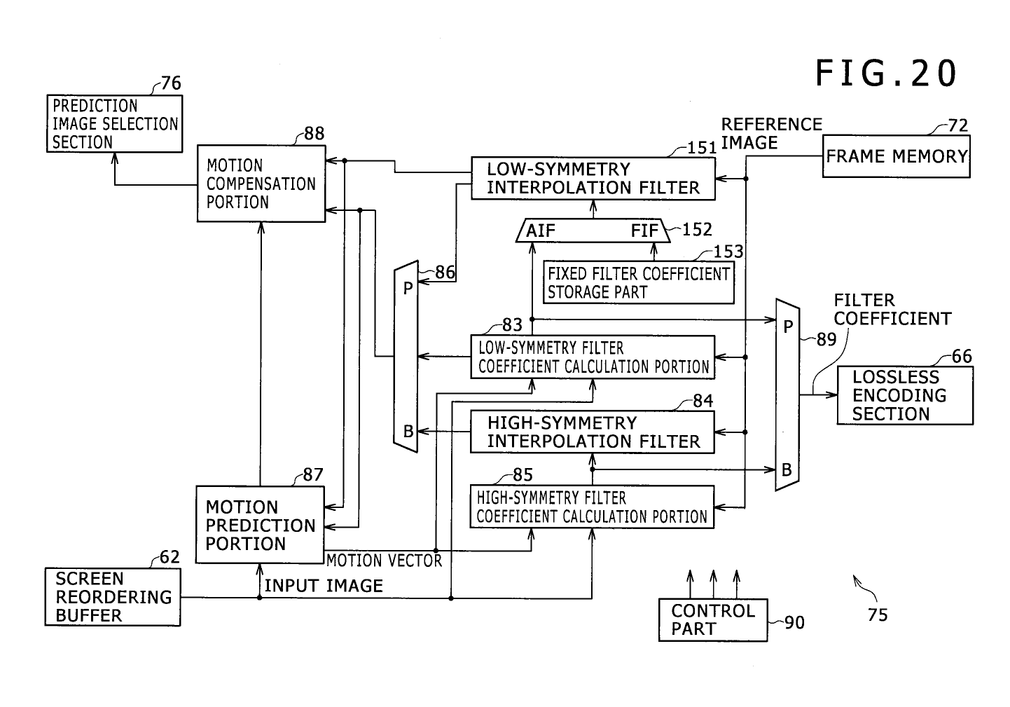

FIG. 20 shows an example of a configuration of the motion prediction and compensation section 75 of FIG. 5 in the case where a fixed interpolation filter is omitted. In the example of FIG. 20, the motion prediction and compensation section 75 is common to the example of FIG. 6 in that it includes a low-symmetry filter coefficient calculation portion 83, a high-symmetry interpolation filter 84, a high-symmetry filter coefficient calculation portion 85, a selector 86, a motion prediction portion 87, a motion compensation portion 88, a selector 89 and a control part 90. In the example of FIG. 20, the motion prediction and compensation section 75 is different in that the fixed interpolation filter 81 is omitted, a low-symmetry interpolation filter 151 is provided in place of the low-symmetry interpolation filter 82 and that a selector 152 and a fixed filter coefficient storage part 153 are additionally provided.

In particular, the low-symmetry interpolation filter 151 first uses predetermined filter coefficients supplied from the selector 152 and read out from the fixed filter coefficient storage part 153 to carry out a filter process for a reference image from the frame memory 72. Then, the low-symmetry interpolation filter 151 outputs the reference image after the fixed filter process to the motion prediction portion 87 and the motion compensation portion 88.

Further, the low-symmetry interpolation filter 151 uses filter coefficients calculated by the low-symmetry filter coefficient calculation portion 83 and supplied from the selector 152 to carry out a filter process for the reference image from the frame memory 72 and outputs the reference image after the variable filter process to the motion prediction portion 87 and the motion compensation portion 88.

It is to be noted that the filter structure of the low-symmetry interpolation filter 151 in the case where an AIF is not used is a filter structure which is implementable in the case where an AIF is used. Here, the implementable filter structure signifies a filter structure which can be processed only by changing the filter coefficients.

The selector 152 selects, in the case where an AIF is used, the filter coefficients calculated by the low-symmetry filter coefficient calculation portion 83 and supplies the selected filter coefficients to the low-symmetry interpolation filter 151 under the control of the control part 90. On the other hand, in the case where an AIF is not used, the selector 152 selects the filter coefficients read out from the fixed filter coefficient storage part 153 and supplies the selected filter coefficients to the low-symmetry interpolation filter 151 under the control of the control part 90.

The fixed filter coefficient storage part 153 has stored therein filter coefficients determined in advance with the decoding side (for example, filter coefficients of six taps determined in the H.264/AVC method, hereinafter referred to as fixed filter coefficients).

The control part 90 carries out, in addition to the processes described hereinabove with reference to FIG. 6, control of the selector 152 depending upon whether an AIF is used or a FIF is used to select filter coefficients from the low-symmetry filter coefficient calculation portion 83 or the fixed filter coefficient storage part 153.

### [Description of the Motion Detection and Compensation Process]

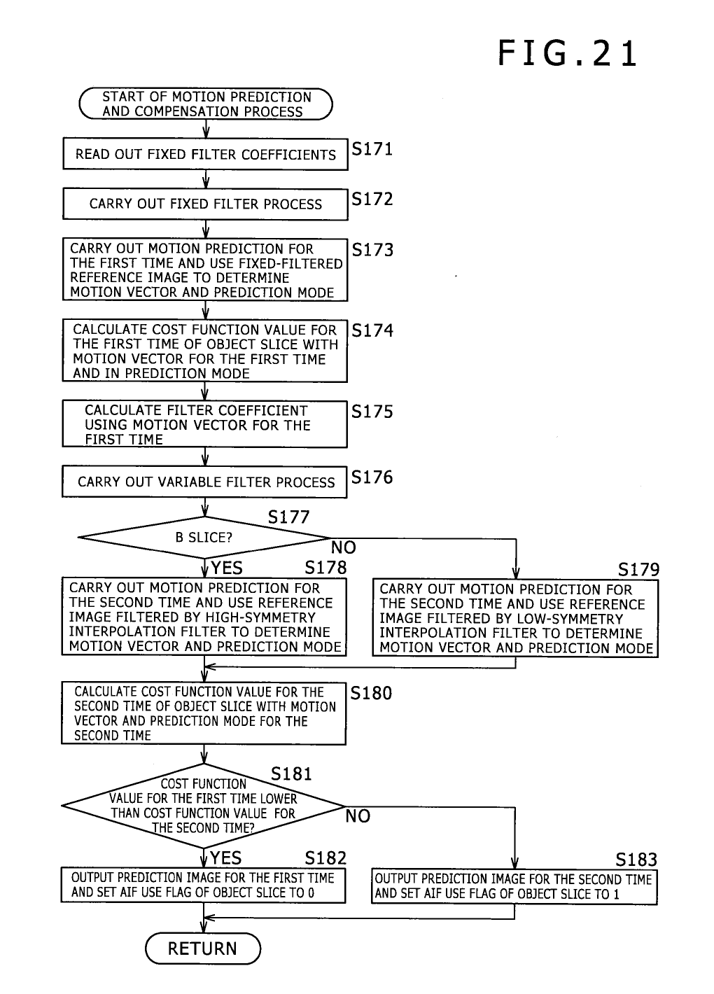

Now, a motion prediction and compensation process of the motion prediction and compensation section 75 of FIG. 20 is described with reference to a flow chart of FIG. 21.

At step S171, the fixed filter coefficient storage part 153 reads out fixed filter coefficients and outputs them to the selector 152. The selector 152 selects the fixed filter coefficients from the fixed filter coefficient storage part 153 and supplies them to the low-symmetry interpolation filter 151 under the control of the control part 90.

In the case where an image of a processing object supplied from the screen reordering buffer 62 is an image to be inter processed, an image to be referred to is read out from the frame memory 72 and inputted also to the low-symmetry interpolation filter 151, low-symmetry filter coefficient calculation portion 83, high-symmetry interpolation filter 84 and high-symmetry filter coefficient calculation portion 85 through the switch 73.

At step S172, the low-symmetry interpolation filter 151 carries out a fixed filter process for the reference image. In particular, the low-symmetry interpolation filter 151 carries out a filter process for the reference image from the frame memory 72 using the fixed filter coefficients and outputs the reference image after the fixed filter process to the motion prediction portion 87 and the motion compensation portion 88.

The reference image after the fixed filter from the low-symmetry interpolation filter 151 is inputted to the motion prediction portion 87 and the motion compensation portion 88. At step S173, the motion prediction portion 87 and the motion compensation portion 88 carry out motion prediction for the first time and use the reference image fixed filter processed by the low-symmetry interpolation filter 151 to determine a motion vector and a prediction mode.

In particular, the motion prediction portion 87 produces a motion vector for the first time in all candidate inter prediction modes based on the input image from the screen reordering buffer 62 and the reference image after the fixed filter from the low-symmetry interpolation filter 151 and outputs the produced motion vectors to the motion compensation portion 88. It is to be noted that the motion vectors for the first time are outputted also to the low-symmetry filter coefficient calculation portion 83 and the high-symmetry filter coefficient calculation portion 85 and are used also in a process at step S175 hereinafter described.

The motion compensation portion 88 carries out a compensation process for the reference image after the fixed filter from the low-symmetry interpolation filter 151 using the motion vectors for the first time to produce a predicted image. Then, the motion compensation portion 88 calculates a cost function value for each block and compares the calculated cost function values with each other to determine an optimum inter prediction mode.

The processes described above are carried out for each block, and after the processes for all blocks in the object slice comes to an end, the motion compensation portion 88 calculates a cost function value for the first time of the object slice with the motion vectors for the first time and in the optimum inter prediction mode.

At step S175, the low-symmetry filter coefficient calculation portion 83 and the high-symmetry filter coefficient calculation portion 85 use the motion vectors for the first time from the motion prediction portion 87 to calculate low-symmetry filter coefficients and high-symmetry filter coefficients, respectively.

The low-symmetry filter coefficient calculation portion 83 supplies the calculated 51 filter coefficients to the selector 152 and the selector 89, and the high-symmetry filter coefficient calculation portion 85 supplies the calculated 18 filter coefficients to the high-symmetry interpolation filter 84 and the selector 89.

The selector 152 selects the filter coefficients from the low-symmetry filter coefficient calculation portion 83 and supplies the selected filter coefficients to the low-symmetry interpolation filter 151 under the control of the control part 90.

At step S176, the low-symmetry interpolation filter 82 and the high-symmetry interpolation filter 84 carry out a variable filter process for the reference image. In particular, the low-symmetry interpolation filter 82 carries out a filter process for the reference image from the frame memory 72 using the 51 filter coefficients calculated by the low-symmetry filter coefficient calculation portion 83 and outputs the reference image after the variable filter process to the selector 86.

Further, the high-symmetry interpolation filter 84 carries out a filter process for the reference image from the frame memory 72 using the 18 filter coefficients calculated by the high-symmetry filter coefficient calculation portion 85 and outputs the reference image after the variable filter process to the selector 86.

It is to be noted that, since processes at steps S177 to S183 described below are same processes as the processes at steps S56 to S62 of FIG. 15, description of the same is omitted herein to avoid redundancy.

### [Example of the Configuration of the Motion Compensation Portion]

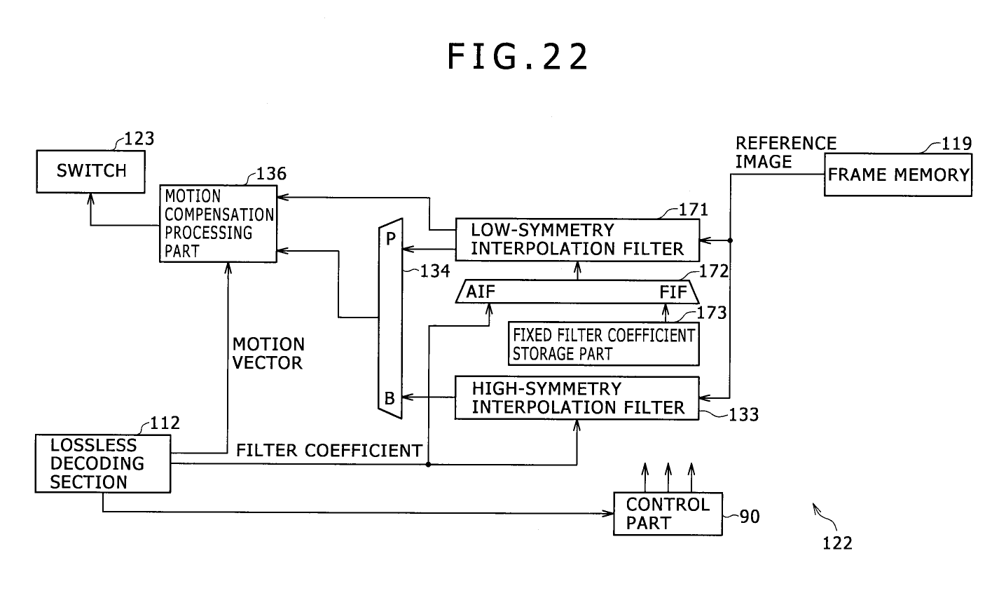

FIG. 22 shows an example of a configuration of the motion compensation portion 122 of FIG. 16 in the case where a fixed interpolation filter is omitted. In the example of FIG. 22, the motion compensation portion 122 is common to the example of FIG. 17 in that it includes a high-symmetry interpolation filter 133, a selector 134, a motion compensation processing part 136 and a control part 137. In the example of FIG. 22, the motion compensation portion 122 is different in that the fixed interpolation filter 131 and the selector 135 are omitted, that a low-symmetry interpolation filter 171 is provided in place of the low-symmetry interpolation filter 132 and that a selector 172 and a fixed filter coefficient storage part 173 are added.

In particular, a reference image from the frame memory 119 is inputted to the low-symmetry interpolation filter 171 and the high-symmetry interpolation filter 133 under the control of the control part 137.

The low-symmetry interpolation filter 171 uses, in the case where the slice of the processing object does not use an AIF, predetermined filter coefficients supplied from the selector 172 and read out from the fixed filter coefficient storage part 173 to carry out a filter process for the reference image from the frame memory 119 and outputs the reference image after the fixed filter process to the motion compensation processing part 136.

Further, the low-symmetry interpolation filter 171 uses, in the case where the slice of the processing object uses an AIF, 51 filter coefficients supplied from the selector 172 and decoded by the lossless decoding section 112 to carry out a filter process for the reference image from the frame memory 72 and outputs the reference image after the variable filter process to the selector 134.

It is to be noted that the filter structure of the low-symmetry interpolation filter 171 in the case where an AIF is not used preferably is a filter structure which is implementable in the case where an AIF is used. Here, the implementable filter structure signifies a filter structure which can be processed only by changing the filter coefficients.

In the case where the slice of the processing object uses an AIF, the selector 172 selects the 51 filter coefficients from the lossless decoding section 112 and outputs the selected filter coefficients to the low-symmetry interpolation filter 171 under the control of the control part 137. In the case where the slice of the processing object does not use an AIF, the selector 172 selects fixed filter coefficients read out from the fixed filter coefficient storage part 173 and outputs the selected fixed filter coefficients to the low-symmetry interpolation filter 171 under the control of the control part 137.

The fixed filter coefficient storage part 173 has stored therein filter coefficients determined in advance with the encoding side (for example, fixed filter coefficients of six taps determined in the H.264/AVC method).

The motion compensation processing part 136 uses the motion vectors from the lossless decoding section 112 to carry out a compensation process for the reference image after the filter inputted from the low-symmetry interpolation filter 171 or the selector 134 to produce a predicted image of the object block and outputs the produced predicted image to the switch 123.

The control part 137 carries out, in addition to control of the selector 134 based on the information of the slice described hereinabove with reference to FIG. 17, reference to the acquired AIF use flag and control of selection of the selector 172 based on whether or not an AIF is used. In particular, in the case where the slice in which a block of the processing object is included uses an AIF, the control part 137 controls the selector 172 to select the 51 filter coefficients from the lossless decoding section 112, but controls, in the case where the slice in which the block of the processing object is included does not use an AIF, the selector 172 to select the fixed filter coefficients read out from the fixed filter coefficient storage part 173.

### [Description of the Motion Prediction and Compensation Process]

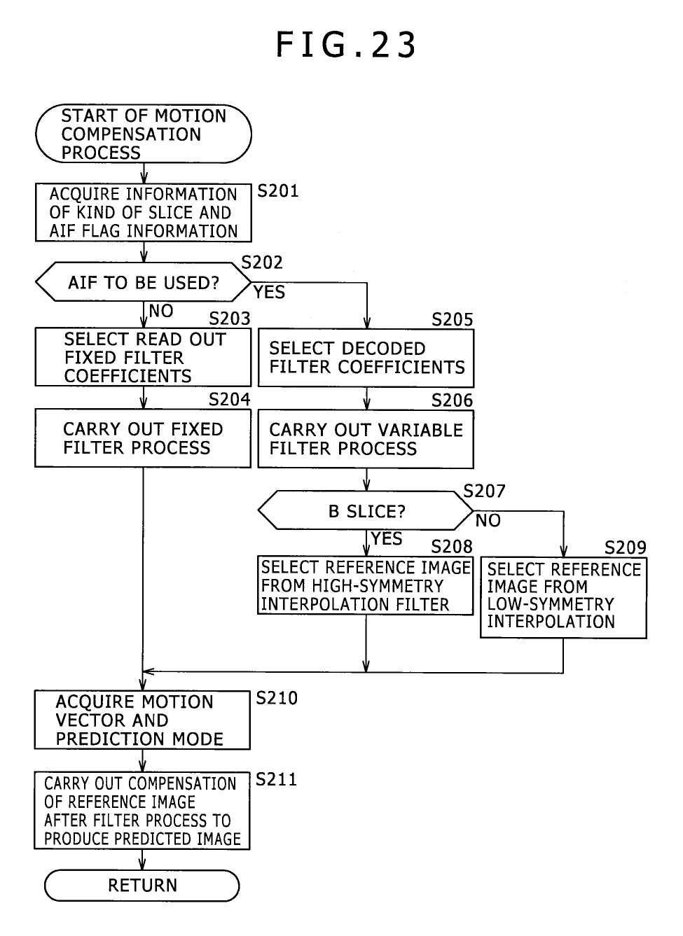

Now, a motion compensation process of the motion compensation portion 122 is described with reference to a flow chart of FIG. 23.

At step S201, the control part 137 acquires information of a kind of a slice and AIF use flag information from the lossless decoding section 112. It is to be noted that the information mentioned is transmitted and acquired as a slice header to and by each slice, and therefore, this process is skipped in any other case.

At this time, to the selector 172 or the high-symmetry interpolation filter 133, filter coefficients from the lossless decoding section 112 are inputted. In the case where 51 filter coefficients are sent from the lossless decoding section 112, they are inputted to the selector 172, but if 18 filter coefficients are sent from the lossless decoding section 112, they are inputted to the high-symmetry interpolation filter 133.

Meanwhile, a reference image from the frame memory 119 is inputted to the low-symmetry interpolation filter 171 and the high-symmetry interpolation filter 133 under the control of the control part 137.

At step S202, the control part 137 refers to the AIF use flag information from the lossless decoding section 112 and decides whether or not the slice of the processing object uses an AIF. If it is decided that the slice of the processing object does not use an AIF, then the processing advances to step S203. At step S203, the selector 172 selects the fixed filter coefficients read out from the fixed filter coefficient storage part 173 and outputs the read out fixed filter coefficients to the low-symmetry interpolation filter 171 under the control of the control part 137.

At step S204, the low-symmetry interpolation filter 171 uses the fixed filter coefficients supplied thereto from the selector 172 to carry out a filter process for the reference image from the frame memory 119 and outputs the reference image after the fixed filter process to the motion compensation processing part 136.

If it is decided at step S202 that the slice of the processing object uses an AIF, then the processing advances to step S205. At step S205, the selector 172 selects the 51 filter coefficients from the lossless decoding section 112 and outputs the selected filter coefficients to the low-symmetry interpolation filter 171 under the control of the control part 137.

At step S206, the low-symmetry interpolation filter 171 uses the 51 filter coefficients supplied thereto from the selector 172 to carry out a filter process for the reference image from the frame memory 72 and outputs the reference image after the variable filter process to the selector 134. Further, at this time, also the high-symmetry interpolation filter 133 uses the 18 filter coefficients from the lossless decoding section 112 to carry out a filter process for the reference image from the frame memory 72 and outputs the reference image after the variable filter process to the selector 134.

At step S207, the control part 137 decides whether or not the slice of the processing object is a B slice, and if it is decided that the slice of the processing object is a B slice, then the processing advances to step S208.

At step S208, the selector 134 selects the reference image after the variable filter process from the high-symmetry interpolation filter 133 and outputs the selected reference image to the motion compensation processing part 136 under the control of the control part 137.

On the other hand, if it is decided at step S207 that the slice of the processing object is not a B slice, that is, the slice of the processing object is a P slice, then the processing advances to step S209.

At step S209, the selector 134 selects, in the case where the slice of the processing object is a P slice, the reference image after the variable filter from the low-symmetry interpolation filter 132 and outputs the selected reference image to the motion compensation processing part 136 under the control of the control part 137.

At step S210, the motion compensation processing part 136 acquires motion vector information of the object block and inter prediction mode information of a macro block in which the object block is included from the lossless decoding section 112.

At step S211, the motion compensation processing part 136 uses the acquired motion vectors to carry out compensation for the reference image after the fixed filter from the low-symmetry interpolation filter 171 or the reference image after the variable filter from the selector 134 to produce a predicted image and outputs the produced predicted image to the switch 123.

As described above, by determining and storing filter coefficients for the case where an AIF is not used in advance, the motion prediction and compensation section 75 of FIG. 20 and the motion compensation portion 122 of FIG. 22 can carry out an interpolation process using the filter coefficients in an AIF filter in the case where an AIF is not used. In other words, by using a filter commonly for the H.264/AVC method and the AIF, the filter for exclusive use for the H.264/AVC method can be omitted.

Consequently, the necessity to incorporate the filter for exclusive use for the H.264/AVC method as a hardware circuit of an LSI is eliminated, and the fabrication cost can be lowered.

Further, in the case where the number of filters having different structures from each other is small, the easiness in verification of the individual filters is higher than that in the case where the number of such filters is great. In particular, since verification after incorporation is necessitated for each filter, if the number of filters is great, then the necessary verification operation is great and a high expense for development is required. However, improvement in this regard can be anticipated.

Further, usually in the case where an AIF is processed by software, if a plurality of filters having structures different from each other are involved, then there is the necessity to process individual processes by programs separate from each other. This increases the number of commands for determining operation of a processor and an increased region of a memory for storing the commands is used. In contrast, according to the present invention, even for a slice which does not use an AIF, a conventional AIF process can be applied only by setting filter coefficients to those determined in advance. In particular, usually the number of commands for setting filter coefficients determined in advance can be made much smaller than the number of commends for applying a simple filter process.

It is to be noted that, while an example wherein filter coefficients in the case where an AIF is not used are determined in advance and stored in the fixed filter coefficient storage portion is described in the foregoing description, in the case of an IDR (instantaneous decoding refresh) picture, also it is possible to reset filter coefficient information therefor determined in advance.

Here, the IDR picture is prescribed in the H.264/AVC method and signifies a picture at the top of an image sequence such that decoding can be started from the IDR picture. This mechanism makes random access possible.

Filter coefficients reset with the IDR picture can be overwritten into a memory, if stream information includes filter overwriting information, by reading out filter coefficients to be rewritten from the stream information. Thereafter, the stored filter coefficients are used as filter coefficients in the case where an AIF is not used until they are reset with an IDR picture or further overwriting information is inputted.

### [Description of Application to an Extended Macro Block Size]

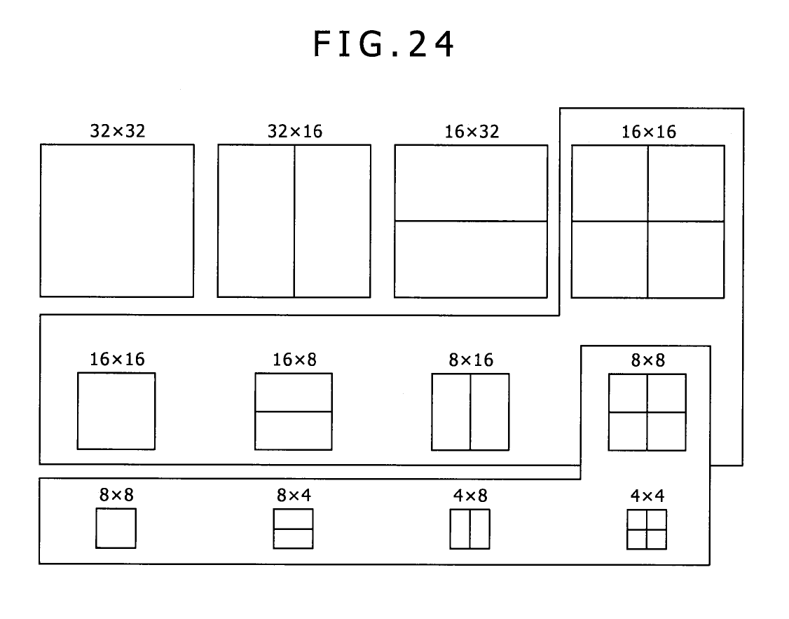

FIG. 24 is a view illustrating an example of a block size proposed in Non-Patent Document 4. In Non-Patent Document 4, the macro block size is extended to 32×32 pixels.

At an upper stage of FIG. 24, macro blocks configured from 32×32 pixels and divided into blocks (partitions) of 32×32 pixels, 32×16 pixels, 16×32 pixels and 16×16 pixels are shown in order from the left. At a middle stage of FIG. 24, blocks configured from 16×16 pixels and divided into blocks (partitions) of 16×16 pixels, 16×8 pixels, 8×16 pixels and 8×8 pixels are shown in order from the left. Further, at a lower stage of FIG. 24, blocks configured from 8×8 pixels and divided into blocks (partitions) of 8×8 pixels, 8×4 pixels, 4×8 pixels and 4×4 pixels are shown in order from the left.

In particular, a macro block of 32×32 pixels can be processed in a block of 32×32 pixels, 32×16 pixels, 16×32 pixels and 16×16 pixels shown at the upper stage of FIG. 24.

The block of 16×16 pixels shown on the right side at the upper stage can be processed in a block of 16×16 pixels, 16×8 pixels, 8×16 pixels and 8×8 pixels shown at the middle stage, similarly as in the H.264/AVC method.

The block of 8×8 pixels shown on the right side at the middle stage can be processed in a block of 8×8 pixels, 8×4 pixels, 4×8 pixels and 4×4 pixels shown at the lower stage, similarly as in the H.264/AVC method.

By such a hierarchical structure as described above, in the proposal of Non-Patent Document 4, while the compatibility with the H.264/AVC method is maintained with regard to the blocks of 16×16 pixels or less, a greater block is defined as a superset of them.

The present invention can be applied also to such an extended macro block size proposed as described above.

Further, while, in the foregoing description, the H.264/AVC method is used as the base for the encoding method, the present invention is not limited to this and can be applied to an image encoding apparatus/image decoding apparatus in which an encoding method/decoding method wherein any other motion prediction and compensation process is carried out are used.

It is to be noted that the present invention can be applied to an image encoding apparatus and an image decoding apparatus which are used to receive image information (a bit stream) compressed by orthogonal transform and motion compensation such as discrete cosine transform, for example, as in MPEG, H.26x through a network medium such as a satellite broadcast, cable television, the Internet or a portable telephone set. Further, the present invention can be applied to an image encoding apparatus and an image decoding apparatus which are used upon processing on a storage medium such as an optical or magnetic disk and a flash memory. Furthermore, the present invention can be applied also to a motion prediction compensation apparatus included in those image encoding apparatus and image decoding apparatus and so forth.

It is to be noted that, while the series of processes described above can be executed by hardware, it may otherwise be executed by software. In the case where the series of processes is executed by software, a program which constructs the software is installed into a computer. Here, the computer includes a computer incorporated in hardware for exclusive use, a personal computer for universal use which can execute various functions by installing various programs, and so forth.

### [Example of the Configuration of the Personal Computer]

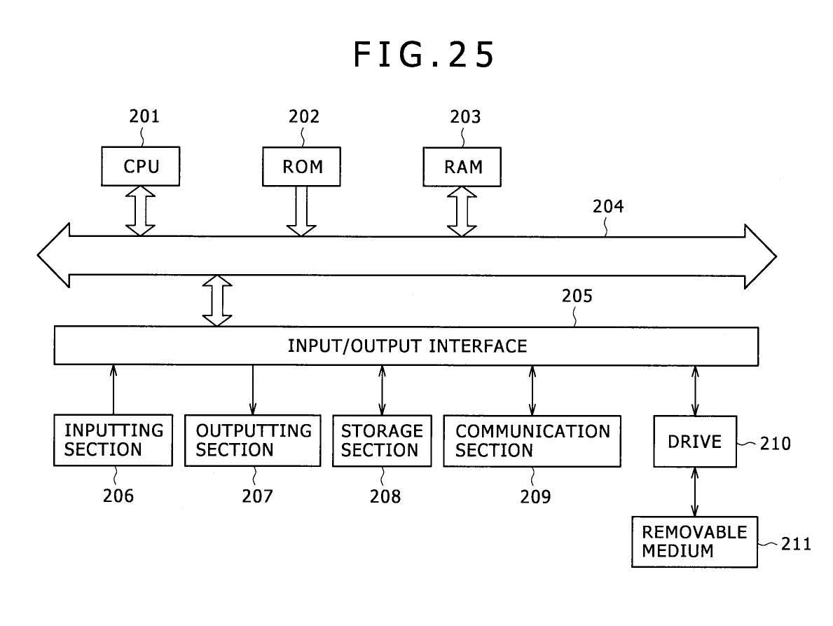

FIG. 25 is a block diagram showing an example of a configuration of hardware of a computer which executes the series of processes of the present invention in accordance with a program.

In the computer, a CPU (Central Processing Unit) 201, a ROM (Read Only Memory) 202 and a RAM (Random Access Memory) 203 are connected to each other by a bus 204.

To the bus 204, an input/output interface 205 is connected further. To the input/output interface 205, an inputting section 206, an outputting section 207, a storage section 208, a communication section 209 and a drive 210 are connected.

The inputting section 206 includes a keyboard, a mouse, a microphone and so forth. The outputting section 207 includes a display unit, a speaker and so forth. The storage section 208 includes a hard disk, a nonvolatile memory and so forth. The communication section 209 includes a network interface and so forth. The drive 210 drives a removable medium 211 such as a magnetic disk, an optical disk, a magneto-optical disk or a semiconductor memory.

In the computer configured in such a manner as described above, the CPU 201 loads a program stored, for example, in the storage section 208 into the RAM 203 through the input/output interface 205 and the bus 204 and executes the program to carry out the series of processes described hereinabove.

The program which is executed by the computer (CPU 201) can be recorded into or on and provided as the removable medium 211, for example, as a package medium or the like. Further, the program can be provided through a wired or wireless transmission medium such as a local area network, the Internet or a digital broadcast.

In the computer, the program can be installed into the storage section 208 through the input/output interface 205 by loading the removable medium 211 into the drive 210. Further, the program can be received by the communication section 209 through a wired or wireless transmission medium and installed into the storage section 208. Or else, the program can be installed in the ROM 202 or the storage section 208 in advance.

It is to be noted that the program to be executed by the computer may be a program whose processes are carried out in time series in accordance with an order described in the present specification or a program whose processes are carried out in parallel or at a necessary timing such as when they are invoked.

The embodiment of the present invention is not limited to the embodiment described hereinabove but can be modified in various manners without departing from the subject matter of the present invention.

For example, the image encoding apparatus 51 or the image decoding apparatus 101 described hereinabove can be applied to an arbitrary electronic apparatus. Several examples are described below.

### [Example of the Configuration of the Television Receiver]

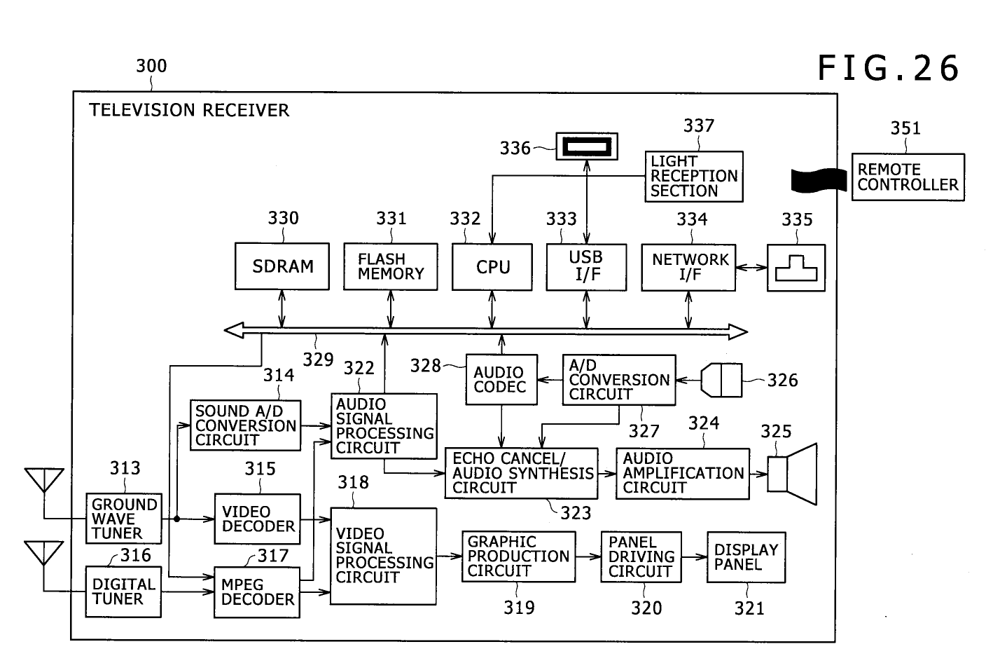

FIG. 26 is a block diagram showing an example of principal components of a television receiver which uses the image decoding apparatus to which the present invention is applied.

The television receiver 300 shown in FIG. 26 includes a ground wave tuner 313, a video decoder 315, a video signal processing circuit 318, a graphic production circuit 319, a panel driving circuit 320, and a display panel 321.

The ground wave tuner 313 receives a broadcasting wave signal of a terrestrial analog broadcast through an antenna, demodulates the broadcasting signal to acquire a video signal and supplies the video signal to the video decoder 315. The video decoder 315 carries out a decoding process for the video signal supplied thereto from the ground wave tuner 313 and supplies resulting digital component signals to the video signal processing circuit 318.

The video signal processing circuit 318 carries out a predetermined process such as noise removal for the video data supplied thereto from the video decoder 315 and supplies resulting video data to the graphic production circuit 319.

The graphic production circuit 319 produces video data of a program to be displayed on the display panel 321 or image data by a process based on an application supplied thereto through the network and supplies the produced video data or image data to the panel driving circuit 320. Further, the graphic production circuit 319 suitably carries out also such a process as to supply video data obtained by producing video data (graphic) for displaying a screen image to be used by a user for selection of an item and superposing the video data on the video data of the program to the panel driving circuit 320.

The panel driving circuit 320 drives the display panel 321 based on the data supplied thereto from the graphic production circuit 319 so that a video of the program or various kinds of screen images described hereinabove are displayed on the display panel 321.

The display panel 321 is formed from an LCD (Liquid Crystal Display) unit or the like and displays a video of a program under the control of the panel driving circuit 320.

The television receiver 300 further includes an audio A/D (Analog/Digital) conversion circuit 314, an audio signal processing circuit 322, an echo cancel/audio synthesis circuit 323, an audio amplification circuit 324 and a speaker 325.

The ground wave tuner 313 demodulates a received broadcasting wave signal to acquire not only a video signal but also an audio signal. The ground wave tuner 313 supplies the acquired audio signal to the audio A/D conversion circuit 314.

The audio A/D conversion circuit 314 carries out an A/D conversion process for the audio signal supplied thereto from the ground wave tuner 313 and supplies a resulting digital audio signal to the audio signal processing circuit 322.

The audio signal processing circuit 322 carries out a predetermined process such as noise removal for the audio data supplied thereto from the audio A/D conversion circuit 314 and supplies resulting audio data to the echo cancel/audio synthesis circuit 323.

The echo cancel/audio synthesis circuit 323 supplies the audio data supplied thereto from the audio signal processing circuit 322 to the audio amplification circuit 324.

The audio amplification circuit 324 carries out a D/A conversion process and an amplification process for the audio data supplied thereto from the echo cancel/audio synthesis circuit 323 to adjust the audio data to a predetermined sound level so that sound is outputted from the speaker 325.

Further, the television receiver 300 includes a digital tuner 316 and an MPEG decoder 317.

The digital tuner 316 receives a broadcasting wave signal of a digital broadcast (terrestrial digital broadcast, BS (Broadcasting Satellite)/CS (Communication Satellite) digital broadcast) through the antenna, demodulates the broadcasting wave signal to acquire an MPEG-TS (Moving Picture Experts Group-Transport Stream) and supplies the MPEG-TS to the MPEG decoder 317.

The MPEG decoder 317 cancels scrambling applied to the MPEG-TS supplied thereto from the digital tuner 316 to extract a stream including data of a program which is an object of reproduction (object of viewing). The MPEG decoder 317 decodes audio packets which configure the extracted stream and supplies resulting audio data to the audio signal processing circuit 322. Further, the MPEG decoder 317 decodes video packets which configure the stream and supplies resulting video data to the video signal processing circuit 318. Further, the MPEG decoder 317 supplies extracted EPG (Electronic Program Guide) data extracted from the MPEG-TS to a CPU 332 through a path not shown.

The television receiver 300 uses the image decoding apparatus 101 described hereinabove as the MPEG decoder 317 which decodes the video packets in this manner. Accordingly, the MPEG decoder 317 can reduce the overhead similarly as in the case of the image decoding apparatus 101 to improve the encoding efficiency.

The video data supplied from the MPEG decoder 317 are subjected to a predetermined process by the video signal processing circuit 318 similarly as in the case of the video data supplied from the video decoder 315. Then, on the video data to which the predetermined process is applied, video data produced by the graphic production circuit 319 or the like are suitably superposed, and resulting data are supplied to the display panel 321 through the panel driving circuit 320 so that an image of the data is displayed on the display panel 321.

The audio data supplied from the MPEG decoder 317 are subjected to a predetermined process by the audio signal processing circuit 322 similarly as in the case of the audio data supplied from the audio A/D conversion circuit 314. Then, the audio data subjected to the predetermined process are supplied through the echo cancel/audio synthesis circuit 323 to the audio amplification circuit 324, by which a D/A conversion process and an amplification process are carried out therefor. As a result, sound adjusted to a predetermined sound amount is outputted from the speaker 325.

The television receiver 300 includes a microphone 326 and an A/D conversion circuit 327 as well.

The A/D conversion circuit 327 receives a signal of voice of the user fetched by the microphone 326 provided for voice conversation in the television receiver 300. The A/D conversion circuit 327 carries out a predetermined A/D conversion process for the received voice signal and supplies resulting digital voice data to the echo cancel/audio synthesis circuit 323.

The echo cancel/audio synthesis circuit 323 carries out, in the case where data of voice of the user (user A) of the television receiver 300 are supplied from the A/D conversion circuit 327 thereto, echo cancellation for the voice data of the user A. Then, the echo cancel/audio synthesis circuit 323 causes data of the voice obtained by synthesis with other sound data or the like after the echo cancellation to be outputted from the speaker 325 through the audio amplification circuit 324.

Further, the television receiver 300 includes an audio codec 328, an internal bus 329, an SDRAM (Synchronous Dynamic Random Access Memory) 330, a flash memory 331, the CPU 332, a USB (Universal Serial Bus) I/F 333, and a network I/F 334 as well.

The A/D conversion circuit 327 receives a signal of voice of the user fetched by the microphone 326 provided for voice conversation in the television receiver 300. The A/D conversion circuit 327 carries out an A/D conversion process for the received voice signal and supplies resulting digital voice data to the audio codec 328.

The audio codec 328 converts the voice data supplied thereto from the A/D conversion circuit 327 into data of a predetermined format for transmission through a network and supplies the data to the network I/F 334 through the internal bus 329.

The network I/F 334 is connected to a network through a cable connected to a network terminal 335. The network I/F 334 transmits voice data supplied thereto from the audio codec 328, for example, to a different apparatus connected to the network. Further, the network I/F 334 receives sound data transmitted, for example, from the different apparatus connected thereto through the network, through the network terminal 335 and supplies the sound data to the audio codec 328 through the internal bus 329.

The audio codec 328 converts the sound data supplied thereto from the network I/F 334 into data of a predetermined format and supplies the data of the predetermined format to the echo cancel/audio synthesis circuit 323.

The echo cancel/audio synthesis circuit 323 carries out echo cancellation for the sound data supplied thereto from the audio codec 328 and causes data of sound obtained by synthesis with different sound data or the like to be outputted from the speaker 325 through the audio amplification circuit 324.

The SDRAM 330 stores various kinds of data necessary for the CPU 332 to carry out processing.

The flash memory 331 stores a program to be executed by the CPU 332. The program stored in the flash memory 331 is read out at a predetermined timing such as upon starting of the television receiver 300 by the CPU 332. Into the flash memory 331, also EGP data acquired through a digital broadcast, data acquired from a predetermined server through a network and so forth are stored.

For example, an MPEG-TS including contents data acquired from a predetermined server through a network is stored into the flash memory 331 under the control of the CPU 332. The flash memory 331 supplies, for example, the MPEG-TS to the MPEG decoder 317 through the internal bus 329 under the control of the CPU 332.

For example, the MPEG decoder 317 processes the MPEG-TS similarly as in the case of the MPEG-TS supplied from the digital tuner 316. In this manner, the television receiver 300 can receive contents data configured from a video, an audio and so forth through a network, decode the content data by using the MPEG decoder 317 and cause the video of the data to be displayed or the audio to be outputted.

Further, the television receiver 300 includes a light reception section 337 for receiving an infrared signal transmitted from a remote controller 351 as well.

The light reception section 337 receives infrared rays from the remote controller 351 and outputs a control code obtained by demodulation of the infrared rays and representative of the substance of a user operation to the CPU 332.

The CPU 332 executes a program stored in the flash memory 331 and controls general operation of the television receiver 300 in response to a control code supplied thereto from the light reception section 337. The CPU 332 and the other components of the television receiver 300 are connected to each other by a path not shown.

The USB I/F 333 carries out transmission and reception of data to and from an external apparatus to the television receiver 300 connected thereto through a USB cable connected to a USB terminal 336. The network I/F 334 is connected to a network through a cable connected to the network terminal 335 and carries out also transmission and reception of data other than audio data to and from various apparatus connected to the network.

The television receiver 300 can reduce the overhead and improve the encoding efficiency by using the image decoding apparatus 101 as the MPEG decoder 317. As a result, the television receiver 300 can acquire and display a decoded image of a higher definition at a higher speed from a broadcasting signal through the antenna or content data acquired through the network.

### [Example of the Configuration of the Portable Telephone Set]

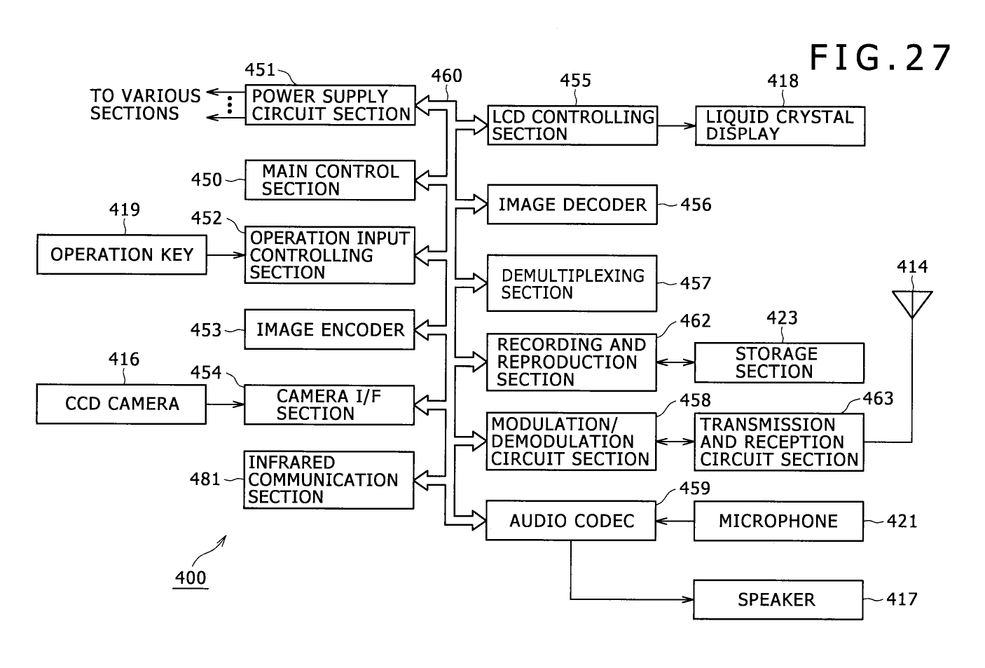

FIG. 27 is a block diagram showing an example of principal components of a portable telephone set which uses the image encoding apparatus and the image decoding apparatus to which the present invention is applied.

The portable telephone set 400 shown in FIG. 27 includes a main control section 450 for comprehensively controlling various components, a power supply circuit section 451, an operation input controlling section 452, an image encoder 453, a camera I/F section 454, an LCD controlling section 455, an image decoder 456, a multiplexing and demultiplexing section 457, a recording and reproduction section 462, a modulation/demodulation circuit section 458, and an audio codec 459. The components mentioned are connected to each other through a bus 460.

The portable telephone set 400 further includes an operation key 419, a CCD (Charge Coupled Devices) camera 416, a liquid crystal display unit 418, a storage section 423, a transmission and reception circuit section 463, an antenna 414, a microphone (mic) 421 and a speaker 417.

If a clearing and power supply key is placed into an on state by an operation of the user, then the power supply circuit section 451 supplies power to the components from a battery pack to start up the portable telephone set 400 into an operable state.

The portable telephone set 400 carries out various operations such as transmission and reception of an audio signal, transmission and reception of an electronic mail or image data, image pickup or data recording in various modes such as a voice call mode or a data communication mode under the control of the main control section 450 configured from a CPU, a ROM, a RAM and so forth.

For example, in the voice call mode, the portable telephone set 400 converts a voice signal collected by the microphone (mic) 421 into digital sound data by means of the audio codec 459, carries out a spectrum spreading process of the digital sound data by means of the modulation/demodulation circuit section 458, and carries out a digital to analog conversion process and a frequency conversion process by means of the transmission and reception circuit section 463. The portable telephone set 400 transmits a transmission signal obtained by the conversion process to a base station not shown through the antenna 414. The transmission signal (sound signal) transmitted to the base station is supplied to a portable telephone set of the opposite party of the call through a public telephone network.

Further, for example, in the voice call mode, the portable telephone set 400 amplifies a reception signal received by the antenna 414 by means of the transmission and reception circuit section 463 and further carries out a frequency conversion process and an analog to digital conversion process, carries out a spectrum despreading process by means of the modulation/demodulation circuit section 458 and converts the reception signal into an analog sound signal by means of the audio codec 459. The portable telephone set 400 outputs an analog sound signal obtained by the conversion from the speaker 417.

Further, for example, in the case where an electronic mail is to be transmitted in the data communication mode, the portable telephone set 400 accepts text data of an electronic mail inputted by an operation of the operation key 419 by means of the operation input controlling section 452. The portable telephone set 400 processes the text data by means of the main control section 450 and causes the liquid crystal display unit 418 to display the text data as an image through the LCD controlling section 455.

Further, the portable telephone set 400 produces electronic mail data based on text data, a user instruction or the like accepted by the operation input controlling section 452 by means of the main control section 450. The portable telephone set 400 carries out a spectrum spreading process of the electronic mail data by means of the modulation/demodulation circuit section 458 and carries out a digital to analog conversion process and a frequency conversion process by means of the transmission and reception circuit section 463. The portable telephone set 400 transmits a transmission signal obtained by the conversion process to a base station not shown through the antenna 414. The transmission signal (electronic mail) transmitted to the base state is supplied to a predetermined destination through the network, a mail server and so forth.

On the other hand, for example, in the case where an electronic mail is received in the data communication mode, the portable telephone set 400 receives a signal transmitted thereto from the base station by means of the transmission and reception circuit section 463 through the antenna 414, amplifies the signal and further carries out a frequency conversion process and an analog to digital conversion process. The portable telephone set 400 carries out a spectrum despreading process of the reception signal by means of the modulation/demodulation circuit section 458 to restore the original electronic mail data. The portable telephone set 400 causes the restored electronic mail data to be displayed on the liquid crystal display unit 418 through the LCD controlling section 455.

It is to be noted that also it is possible for the portable telephone set 400 to record (store) the received electronic mail data into the storage section 423 through the recording and reproduction section 462.

This storage section 423 is an arbitrary rewritable storage medium. The storage section 423 may be a semiconductor memory such as, for example, a RAM or a built-in type flash memory or may be a hard disk or else may be a removable medium such as a magnetic disk, a magneto-optical disk, an optical disk, a USB memory or a memory card. Naturally, the storage section 423 may be any other storage section.

Further, for example, in the case where image data are to be transmitted in the data communication mode, the portable telephone set 400 produces image data by image pickup by means of the CCD camera 416. The CCD camera 416 has optical devices such as a lens and a stop and a CCD unit as a photoelectric conversion element, and picks up an image of an image pickup object, converts the intensity of received light into an electric signal and produces image data of the image of the image pickup object. The image data are compression encoded in accordance with a predetermined encoding method of, for example, MPEG2, MPEG4 or the like by means of the image encoder 453 through the camera I/F section 454 to convert the image data into encoded image data.

The portable telephone set 400 uses the image encoding apparatus 51 described hereinabove as the image encoder 453 which carries out such processes as described above. Accordingly, the image encoder 453 can reduce the overhead similarly as in the case of the image encoding apparatus 51 and improve the encoding efficiency.

It is to be noted that the portable telephone set 400 simultaneously carries out, by means of the audio codec 459, analog to digital conversion of the voice collected by means of the microphone (mic) 421 during image pickup of the CCD camera 416 and further carries out encoding of the voice.

The portable telephone set 400 multiplexes encoded image data supplied thereto from the image encoder 453 and digital sound data supplied thereto from the audio codec 459 by a predetermined method by means of the multiplexing and demultiplexing section 457. The portable telephone set 400 carries out a spectrum spreading process of the multiplexed data obtained by the multiplexing by means of the modulation/demodulation circuit section 458 and further carries out a digital to analog conversion process and a frequency conversion process by means of the transmission and reception circuit section 463. The portable telephone set 400 transmits a transmission signal obtained by the conversion processes to the base station not shown through the antenna 414. The transmission signal (image data) transmitted to the base station is supplied to the opposite party of the communication through the network or the like.

It is to be noted that, in the case where the image data are not transmitted, also it is possible for the portable telephone set 400 to cause the image data produced by the CCD camera 416 to be displayed on the liquid crystal display unit 418 through the LCD controlling section 455 without interposition of the image encoder 453.

Further, in the case where, for example, in the data communication mode, data of a moving image file linked to a simple homepage or the like are to be received, the portable telephone set 400 receives the signal transmitted from the base station by means of the transmission and reception circuit section 463 through the antenna 414, amplifies the signal and further carries out a frequency conversion process and an analog to digital conversion process for the signal. The portable telephone set 400 carries out a spectrum despreading process for the reception signal by means of the modulation/demodulation circuit section 458 to restore the original multiplexed data. The portable telephone set 400 demultiplexes the multiplexed data into encoded image data and encoded sound data by means of the multiplexing and demultiplexing section 457.

The portable telephone set 400 decodes, by means of the image decoder 456, the encoded image data in accordance with a decoding method corresponding to the predetermined encoding method such as MPEG2 or MPEG4 to produce reproduced moving image data and causes the reproduced moving image data to be displayed on the liquid crystal display unit 418 through the LCD controlling section 455. Consequently, for example, video data included in the moving image file linked to the simple homepage are displayed on the liquid crystal display unit 418.

The portable telephone set 400 uses the image decoding apparatus 101 described hereinabove as the image decoder 456 which carries out such processes as described above. Accordingly, the image decoder 456 can reduce the overhead similarly as in the case of the image decoding apparatus 101 and improve the encoding efficiency.

At this time, the portable telephone set 400 simultaneously converts digital sound data into an analog sound signal by means of the audio codec 459 and causes the analog sound data to be outputted from the speaker 417. Consequently, for example, the sound data included in a video file linked to the simple homepage are reproduced.

It is to be noted that also it is possible for the portable telephone set 400 to record (store) the received data linked to the simple homepage or the like into the storage section 423 through the recording and reproduction section 462 similarly as in the case of an electronic mail.

Further, the portable telephone set 400 can analyze a two-dimensional code obtained by image pickup by the CCD camera 416 to acquire information recorded in the two-dimensional code by means of the main control section 450.

Furthermore, the portable telephone set 400 can communicate with an external apparatus using infrared rays by means of an infrared communication section 481.

The portable telephone set 400 can enhance the encoding efficiency by using the image encoding apparatus 51 as the image encoder 453. As a result, the portable telephone set 400 can provide encoded data (image data) of a high encoding efficiency to a different apparatus at a higher speed.

Further, the portable telephone set 400 can enhance the encoding efficiency by using the image decoding apparatus 101 as the image decoder 456. As a result, the portable telephone set 400 can obtain and display a decoded image of a higher definition, for example, from a video file linked to a simple homepage at a higher speed.

It is to be noted that, while it is described in the foregoing description that the portable telephone set 400 uses the CCD camera 416, it may otherwise use an image sensor (CMOS image sensor) in which a CMOS (Complementary Metal Oxide Semiconductor) camera is used in place of the CCD camera 416. Also in this instance, the portable telephone set 400 can pick up an image of an image pickup object and produce image data of the image of the image pickup object similarly as in the case where the CCD camera 416 is used.

Further, while it is described in the foregoing description that the electronic apparatus is formed as the portable telephone set 400, the image encoding apparatus 51 and the image decoding apparatus 101 can be applied to any apparatus which has an image pickup function and a communication function similar to those of the portable telephone set 400 such as, for example, a PDA (Personal Digital Assistants), a smartphone, a UMPG (Ultra Mobile Personal Computer), a network book, or a notebook type personal computer similarly as in the case of the portable telephone set 400.

### [Example of the Configuration of the Hard Disk Recorder]

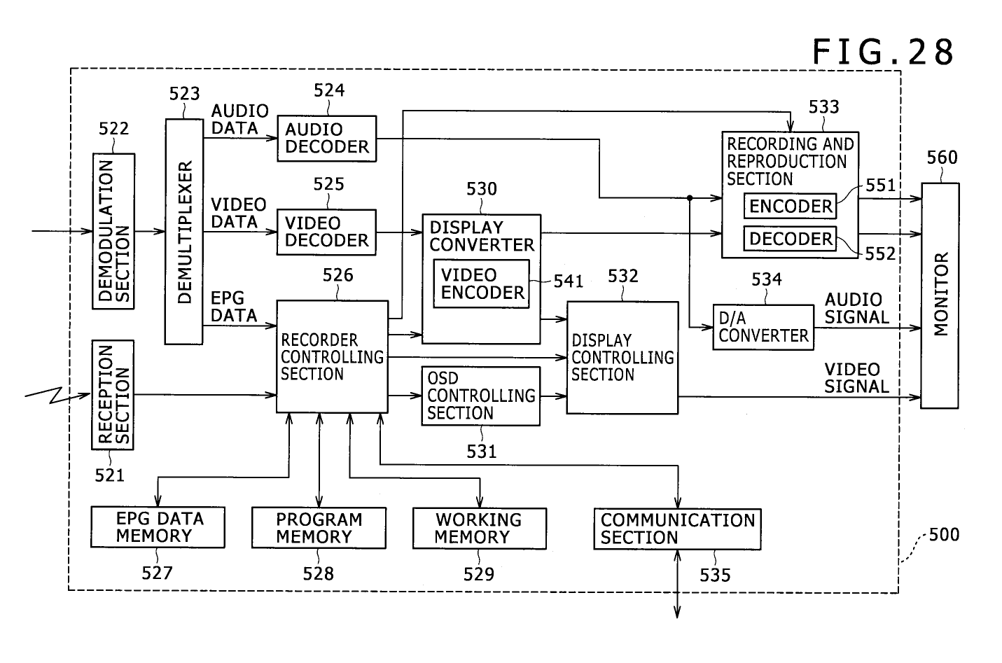

FIG. 28 is a block diagram showing an example of principal components of a hard disk recorder which uses the image encoding apparatus and the image decoding apparatus to which the present invention is applied.

The hard disk recorder (HDD recorder) 500 shown in FIG. 28 is an apparatus which saves audio data and video data of a broadcasting program included in a broadcasting wave signal (television signal) transmitted from a satellite, an antenna on the ground or the like and received by a tuner on a hard disk built therein and provides the saved data to a user at a timing in accordance with an instruction of the user.

The hard disk recorder 500 can extract audio data and video data, for example, from a broadcasting wave signal, suitably decode the audio data and the video data and store the audio data and the video data on the built-in hard disk. Also it is possible for the hard disk recorder 500 to acquire audio data and video data from a different apparatus, for example, through a network, suitably decode the audio data and the video data and store the audio data and the video data on the built-in hard disk.

Further, the hard disk recorder 500 decodes audio data and video data, for example, recorded on the built-in hard disk and supplies the audio data and the video data to a monitor 560 so that an image is displayed on the screen of the monitor 560. Further, the hard disk recorder 500 can cause sound of the audio data to be outputted from the monitor 560.

The hard disk recorder 500 decodes audio data and video data extracted from a broadcasting wave signal acquired, for example, through a tuner or audio data and video data acquired from a different apparatus through a network and supplies the audio data and the video data to the monitor 560 so that an image of the video data is displayed on the screen of the monitor 560. Also it is possible for the hard disk recorder 500 to output sound of the audio data from a speaker of the monitor 560.

Naturally, other operations can be carried out.

As shown in FIG. 28, the hard disk recorder 500 includes a reception section 521, a demodulation section 522, a demultiplexer 523, an audio decoder 524, a video decoder 525, and a recorder controller section 526. The hard disk recorder 500 further includes an EPG data memory 527, a program memory 528, a work memory 529, a display converter 530, an OSD (On Screen Display) controlling section 531, a display controlling section 532, a recording and reproduction section 533, a D/A converter 534 and a communication section 535.

The display converter 530 includes a video encoder 541. The recording and reproduction section 533 includes an encoder 551 and a decoder 552.

The reception section 521 receives an infrared signal from a remote controller (not shown), converts the infrared signal into an electric signal and outputs the electric signal to the recorder controller section 526. The recorder controller section 526 is configured, for example, from a microprocessor and so forth and executes various processes in accordance with a program stored in the program memory 528. At this time, the recorder controller section 526 uses the work memory 529 as occasion demands.

The communication section 535 is connected to a network and carries out a communication process with a different apparatus through the network. For example, the communication section 535 is controlled by the recorder controller section 526, and communicates with a tuner (not shown) and outputs a channel selection controlling signal principally to the tuner.

The demodulation section 522 demodulates a signal supplied thereto from the tuner and outputs the demodulated signal to the demultiplexer 523. The demultiplexer 523 demultiplexes the data supplied thereto from the demodulation section 522 into audio data, video data and EPG data and outputs them to the audio decoder 524, video decoder 525 and recorder controller section 526, respectively.

The audio decoder 524 decodes the audio data inputted thereto, for example, in accordance with the MPEG method and outputs the decoded audio data to the recording and reproduction section 533. The video decoder 525 decodes the video data inputted thereto, for example, in accordance with the MPEG method and outputs the decoded video data to the display converter 530. The recorder controller section 526 supplies the EPG data inputted thereto to the EPG data memory 527 so as to be stored into the EPG data memory 527.

The display converter 530 encodes the video data supplied thereto from the video decoder 525 or the recorder controller section 526 into video data, for example, of the NTSC (National Television Standards Committee) system by means of the video encoder 541 and outputs the encoded video data to the recording and reproduction section 533. Further, the display converter 530 converts the size of the screen of the video data supplied thereto from the video decoder 525 and the recorder controller section 526 to a size corresponding to the size of the monitor 560. The display converter 530 converts the video data, whose screen size has been converted, further into video data of the NTSC system by the video encoder 541, converts the video data into an analog signal, and outputs the analog signal to the display controlling section 532.

The display controlling section 532 superposes an OSD signal outputted from the OSD (On Screen Display) controlling section 531 on a video signal inputted thereto from the display converter 530 under the control of the recorder controller section 526 and outputs a resulting signal to the display unit of the monitor 560 so as to be displayed on the display unit.

Further, audio data outputted from the audio decoder 524 are converted into an analog signal by the D/A converter 534 and supplied to the monitor 560. The monitor 560 outputs the audio signal from a speaker built therein.

The recording and reproduction section 533 has a hard disk as a storage medium for storing video data, audio data and so forth.

The recording and reproduction section 533 encodes audio data supplied thereto, for example, from the audio decoder 524 in accordance with the MPEG method by means of the encoder 551. Further, the recording and reproduction section 533 encodes video data supplied thereto from the video encoder 541 of the display converter 530 in accordance with the MPEG method by means of the encoder 551. The recording and reproduction section 533 multiplexes encoded data of the audio data and encoded data of the video data by means of a multiplexer. The recording and reproduction section 533 channel encodes and amplifies the multiplexed data and writes resulting data on the hard disk through a recording head.

The recording and reproduction section 533 reproduces data recorded on the hard disk through a reproduction head, amplifies the reproduced data and demultiplexes the amplified reproduced data into audio data and video data by means of a demultiplexer. The recording and reproduction section 533 decodes the audio data and the video data in accordance with the MPEG method by means of the decoder 552. The recording and reproduction section 533 D/A converts the decoded audio data and outputs resulting audio data to the speaker of the monitor 560. Further, the recording and reproduction section 533 D/A converts the decoded video data and outputs resulting data to the display of the monitor 560.

The recorder controller section 526 reads out the latest EPG data from the EPG data memory 527 based on a user instruction indicated by an infrared signal from the remote controller received through the reception section 521, and supplies the read out EPG data to the OSD controlling section 531. The OSD controlling section 531 generates image data corresponding to the inputted EPG data and outputs the image data to the display controlling section 532. The display controlling section 532 outputs the video data inputted thereto from the OSD controlling section 531 to the display unit of the monitor 560 so as to be displayed on the display unit. Consequently, an EPG (electronic program guide) is displayed on the display unit of the monitor 560.

Further, the hard disk recorder 500 can acquire various data such as video data, audio data and EPG data supplied thereto from a different apparatus through a network such as the Internet.

The communication section 535 is controlled by the recorder controller section 526, and acquires encoded data such as video data, audio data and EPG data from the different apparatus through the network and supplies the encoded data to the recorder controller section 526. The recorder controller section 526 supplies the acquired encoded data such as, for example, video data and audio data to the recording and reproduction section 533 so as to be stored on the hard disk. At this time, the recorder controller section 526 and the recording and reproduction section 533 may carry out processes such as re-encoding as occasion demands.

Further, the recorder controller section 526 decodes the acquired encoded data such as video data and audio data and supplies resulting video data to the display converter 530. The display converter 530 processes the video data supplied thereto from the recorder controller section 526 and supplies resulting data to the monitor 560 through the display controlling section 532 so that an image of the video data is displayed on the monitor 560 similarly to video data supplied from the video decoder 525.

Further, the recorder controller section 526 may supply the decoded audio data to the monitor 560 through the D/A converter 534 so that sound of the audio is outputted from the speaker in accordance with the image display.

Further, the recorder controller section 526 decodes encoded data of the acquired EPG data and supplies the decoded EPG data to the EPG data memory 527.

Such a hard disk recorder 500 as described above uses the image decoding apparatus 101 as a decoder built in the video decoder 525, decoder 552 and recorder controller section 526. Accordingly, the decoder built in the video decoder 525, decoder 552 and recorder controlling section 526 can reduce the overhead similarly as in the case of the image decoding apparatus 101 and improve the encoding efficiency.

Accordingly, the hard disk recorder 500 can produce a predicted image of high accuracy. As a result, the hard disk recorder 500 can obtain a decoded image of a higher definition at a higher speed, for example, from encoded data of video data received through the tuner, encoded data of video data read out from the hard disk of the recording and reproduction section 533 or encoded data of video data acquired through the network and display the decoded image on the monitor 560.

Further, the hard disk recorder 500 uses the image encoding apparatus 51 as the encoder 551. Accordingly, the encoder 551 can reduce the overhead similarly as in the case of the image encoding apparatus 51 and improve the encoding efficiency.

Accordingly, the hard disk recorder 500 can improve the encoding efficiency, for example, of encoded data to be recorded on the hard disk. As a result, the hard disk recorder 500 can utilize the storage region of the hard disk with a higher efficiency and at a higher speed.

It is to be noted that, while, in the foregoing description, the hard disk recorder 500 wherein video data or audio data are recorded on the hard disk is described, naturally any recording medium may be used. For example, also to a recorder which applies a recording medium other than a hard disk such as, for example, a flash memory, an optical disk or a video tape, the image encoding apparatus 51 and the image decoding apparatus 101 can be applied similarly as in the case of the hard disk recorder 500 described hereinabove.

### [Example of the Configuration of the Camera]

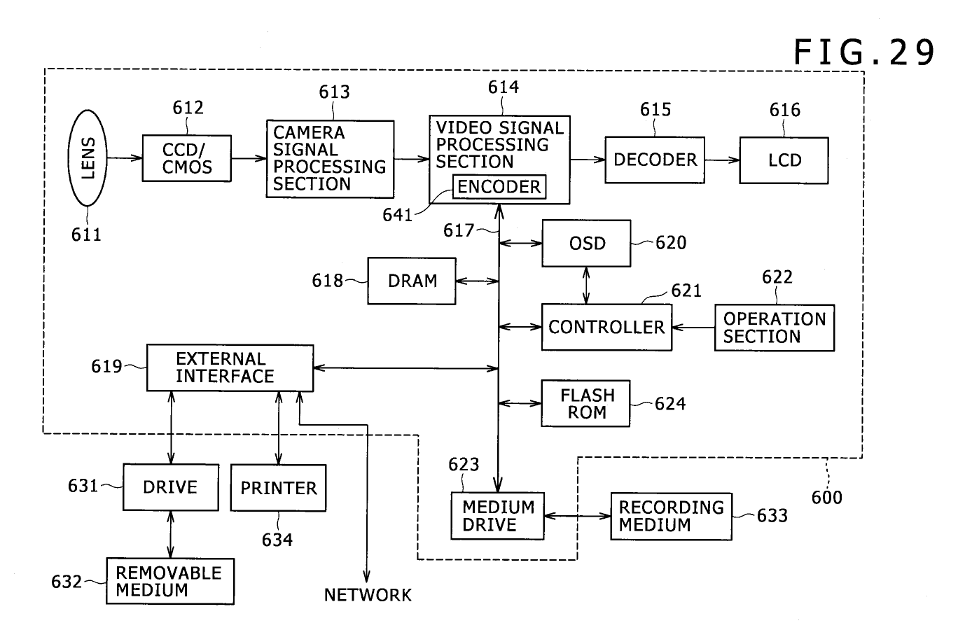

FIG. 29 is a block diagram showing an example of principal components of a camera which uses the image decoding apparatus and the image encoding apparatus to which the present invention is applied.

The camera 600 shown in FIG. 29 picks up an image of an image pickup object and causes the image of the image pickup object to be displayed on an LCD unit 616 or recorded as image data on or into a recording medium 633.

A lens block 611 allows light (that is, a video of an image pickup object) to be introduced into a CCD/CMOS unit 612. The CCD/CMOS unit 612 is an image sensor for which a CCD unit or a CMOS unit is used, and converts the intensity of received light into an electric signal and supplies the electric signal to a camera signal processing section 613.

The camera signal processing section 613 converts the electric signal supplied thereto from the CCD/CMOS unit 612 into color difference signals of Y, Cr and Cb and supplies the color difference signals to an image signal processing section 614. The image signal processing section 614 carries out a predetermined image process for the image signal supplied thereto from the camera signal processing section 613 or encodes the image signal, for example, in accordance with the MPEG method by means of an encoder 641 under the control of a controller 621. The image signal processing section 614 supplies encoded data produced by encoding the image signal to a decoder 615. Further, the image signal processing section 614 acquires display data produced by an on screen display (OSD) unit 620 and supplies the display data to the decoder 615.

In the processes described above, the camera signal processing section 613 suitably utilizes a DRAM (Dynamic Random Access Memory) 618 connected through a bus 617 and causes the DRAM 618 to retain image data, encoded data obtained by encoding the image data or the like as occasion demands.

The decoder 615 decodes the encoded data supplied thereto from the image signal processing section 614 and supplies resulting image data (decoded image data) to the LCD unit 616. Further, the decoder 615 supplies display data supplied thereto from the image signal processing section 614 to the LCD unit 616. The LCD unit 616 suitably synthesizes an image of the decoded image data and an image of the display data supplied thereto from the decoder 615 and displays the synthesized image.

The on screen display unit 620 outputs display data of a menu screen image formed from symbols, characters or figures or an icon to the image signal processing section 614 through the bus 617 under the control of the controller 621.

The controller 621 executes various processes based on a signal representative of the substance of an instruction issued by the user using an operation section 622 and controls the image signal processing section 614, the DRAM 618, and external interface 619, the on screen display unit 620, a medium drive 623 and so forth through the bus 617. In a FLASH ROM 624, a program, data and so forth necessary for the controller 621 to execute various processes are stored.

For example, the controller 621 can encode image data stored in the DRAM 618 or decode encoded data stored in the DRAM 618 in place of the image signal processing section 614 or the decoder 615. At this time, the controller 621 may carry out an encoding or decoding process in accordance with a method similar to the encoding or decoding method of the image signal processing section 614 or the decoder 615 or may carry out an encoding or decoding process in accordance with a method which is not compatible with the image signal processing section 614 or the decoder 615.

Further, for example, if an instruction to start image printing is issued from the operation section 622, then the controller 621 reads out image data from the DRAM 618 and supplies the image data to a printer 634 connected to the external interface 619 through the bus 617 so as to be printed by the printer 634.

Furthermore, for example, if an image recording instruction is issued from the operation section 622, then the controller 621 reads out encoded data from the DRAM 618 and supplies the encoded data to the recording medium 633 loaded in the medium drive 623 through the bus 617 so as to be stored into the recording medium 633.

The recording medium 633 is an arbitrary readable and writable removable medium such as, for example, a magnetic disk, a magneto-optical disk, an optical disk or a semiconductor memory. Naturally, also the type of the recording medium 633 as a type of a removable medium is arbitrary, and it may be a tape device or may be a disk or otherwise may be a memory card. Naturally, the recording medium 633 may be a contactless IC card or the like.

Further, the medium drive 623 and the recording medium 633 may be integrated with each other in such a manner as to be configured from a non-portable recording medium like, for example, a built-in type hard disk drive, an SSD (Solid State Drive) or the like.

The external interface 619 is configured, for example, from a USB input/output terminal and is connected to the printer 634 in the case where printing of an image is to be carried out. Further, the drive 631 is connected to the external interface 619 as occasion demands, and a removable medium 632 such as a magnetic disk, an optical disk or a magneto-optical disk is suitably loaded into the drive 631 such that a computer program read out from them is installed into the FLASH ROM 624 as occasion demands.

Further, the external interface 619 includes a network interface connected to a predetermined network such as a LAN or the Internet. The controller 621 reads out encoded data from the DRAM 618, for example, in accordance with an instruction from the operation section 622 and can supply the encoded data from the external interface 619 to a different apparatus connected thereto through the network. Further, the controller 621 can acquire encoded data or image data supplied from the different apparatus through the network through the external interface 619 and retain the acquired data into the DRAM 618 or supply the acquired data to the image signal processing section 614.

Such a camera 600 as described above uses the image decoding apparatus 101 as the decoder 615. Accordingly, the decoder 615 can reduce the overhead similarly as in the case of the image decoding apparatus 101 and improve the encoding efficiency.

Accordingly, the camera 600 can produce a predicted image of high accuracy. As a result, the camera 600 can obtain a decoded image of a higher definition at a higher speed, for example, from image data produced by the CCD/CMOS unit 612, encoded data of video data read out from the DRAM 618 or the recording medium 633 or encoded data of video data acquired through the network and cause the decoded image to be displayed on the LCD unit 616.

Further, the camera 600 uses the image encoding apparatus 51 as the encoder 641. Accordingly, the encoder 641 can reduce the overhead similarly as in the case of the image coding apparatus 51 and improve the encoding efficiency.

Accordingly, the camera 600 can improve the encoding efficiency, for example, of encoded data to be recorded on the hard disk. As a result, the camera 600 can use the storage region of the DRAM 618 or the recording medium 633 with a higher efficiency at a higher speed.

It is to be noted that the decoding method of the image decoding apparatus 101 carried out by the controller 621 may be applied. Similarly, the encoding method of the image encoding apparatus 51 may be applied to the encoding process carried out by the controller 621.

Further, the image data obtained by image pickup by the camera 600 may be a moving image or may be a still image.

Naturally, the image encoding apparatus 51 and the image decoding apparatus 101 can be applied also to an apparatus or a system other than the apparatus described above.

### DESCRIPTION OF REFERENCE NUMERALS

51 Image encoding apparatus, 66 Lossless encoding section, 75 Motion prediction and compensation section, 81 Fixed interpolation filter, 82 Low-symmetry interpolation filter, 83 Low-symmetry filter coefficient calculation portion, 84 High-symmetry interpolation filter, 85 High-symmetry filter coefficient calculation portion, 87 Motion prediction portion, 88 Motion compensation portion, 90 Control part, 101 Image decoding apparatus, 112 Lossless decoding section, 122 Motion compensation portion, 131 Fixed interpolation filter, 132 Low-symmetry interpolation filter, 133 High-symmetry interpolation filter, 136 Motion compensation processing part, 137 Control part, 151 Low-symmetry interpolation filter, 153 Fixed filter coefficient storage portion, 171 Low-symmetry interpolation filter, 173 Fixed filter coefficient storage portion

1-16. (canceled)

17. An image processing apparatus, comprising:
an interpolation filter for interpolating pixels of a reference image corresponding to an encoded image with fractional accuracy, said interpolation filter using, in the case where symmetry determined in advance is applied to a first pixel position of fractional accuracy and a second pixel position of fractional accuracy, the same filter coefficient as filter coefficients for determining a pixel at the first pixel position of the fractional accuracy and another pixel at the second pixel position of the fractional accuracy;
decoding means for decoding the encoded image, a motion vector corresponding to the encoded image and filter coefficients of said interpolation filter;
motion compensation means for producing a predicted image using the reference image interpolated by said interpolation filter of the filter coefficients decoded by said decoding means and the motion vector decoded by said decoding means; and
selection means for selecting, based on a kind of a slice of an image of an encoding object, pixel positions of the fractional accuracy at which same filter coefficients are to be individually used for pixels in a unit of a slice.

18. The image processing apparatus according to claim 17, wherein said interpolation filter further uses, as the filter coefficients for determining the pixel at the first pixel position of the fractional accuracy and the pixel at the second pixel position of the fractional accuracy, also filter coefficients reversed around a center position between the pixels at integral positions used by said interpolation filter.

19. The image processing apparatus according to claim 18, wherein, in the case where different symmetry determined in advance and different from the first-mentioned symmetry is applied to the first pixel position of the fractional accuracy and the second pixel position of the fractional accuracy, said interpolation filter further uses, as the filter coefficients for determining the pixel at the first pixel position of the fractional accuracy and the pixel at the second pixel position of the fractional accuracy, also filter coefficients reversed around the center position between the pixels at the integral positions used by said interpolation filter.

20. The image processing apparatus according to claim 17, further comprising:
storage means for storing determined filter coefficients; wherein
in the case where a slice of the image of the encoding object is a slice which does not use the filter coefficients decoded by said decoding means, said interpolation filter uses the filter coefficients stored in said storage means and said motion compensation means uses the reference image interpolated by said interpolation filter of the filter coefficients stored in said storage means and the motion vector decoded by said decoding means to produce a predicted image.

21. The image processing apparatus according to claim 17, further comprising:
arithmetic operation means for adding an image decoded by said decoding means and the predicted image produced by said motion compensation means to produce a decoded image.

22. An image processing method, comprising, carried out by an image processing apparatus:
decoding an encoded image, a motion vector corresponding to the encoded image and filter coefficients of an interpolation filter which interpolates pixels of a reference image corresponding to the encoded image with fractional accuracy and uses, in the case where symmetry determined in advance is applied to a first pixel position of fractional accuracy and a second pixel position of the fractional accuracy, the same filter coefficient as filter coefficients for determining a pixel at the first pixel position of the fractional accuracy and another pixel at the second pixel position of the fractional accuracy;
producing a predicted image using the reference image interpolated by the interpolation filter of the decoded filter coefficients and the decoded motion vector; and
selecting, based on a kind of a slice of an image of an encoding object, pixel positions of the fractional accuracy at which same filter coefficients are to be individually used for pixels in a unit of a slice.

23. A computer readable medium including computer executable instructions for causing a computer to function as:
decoding means for decoding an encoded image, a motion vector corresponding to the encoded image and filter coefficients of an interpolation filter which interpolates pixels of a reference image corresponding to the encoded image with fractional accuracy and uses, in the case where symmetry determined in advance is applied to a first pixel position of fractional accuracy and a second pixel position of the fractional accuracy, the same filter coefficient as filter coefficients for determining a pixel at the first pixel position of the fractional accuracy and another pixel at the second pixel position of the fractional accuracy;
motion compensation means for producing a predicted image using the reference image interpolated by the interpolation filter of the filter coefficients decoded by said decoding means and the motion vector decoded by said decoding means; and
selection means for selecting, based on a kind of a slice of an image of an encoding object, pixel positions of the fractional accuracy at which same filter coefficients are to be individually used for pixels in a unit of a slice.

24. An image processing apparatus, comprising:
motion prediction means for carrying out motion prediction between an image of an encoding object and a reference image to detect a motion vector;
an interpolation filter for interpolating pixels of the reference image with fractional accuracy, said interpolation filter using, in the case where symmetry determined in advance is applied to a first pixel position of fractional accuracy and a second pixel position of the fractional accuracy, the same filter coefficient as filter coefficients for determining a pixel at the first pixel position of the fractional accuracy and another pixel at the second pixel position of the fractional accuracy;
coefficient calculation means for calculating filter coefficients of said interpolation filter using the image of the encoding object, reference image and motion vector detected by said motion prediction means;
motion compensation means for producing a predicted image using the reference image interpolated by said interpolation filter of the filter coefficients calculated by said coefficient calculation means and the motion vector detected by said motion prediction means; and
selection means for selecting, based on a kind of a slice of an image of an encoding object, pixel positions of the fractional accuracy at which same filter coefficients are to be individually used for pixels in a unit of a slice.

25. The image processing apparatus according to claim 24, wherein said interpolation filter further uses, as the filter coefficients for determining the pixel at the first pixel position of the fractional accuracy and the pixel at the second pixel position of the fractional accuracy, also filter coefficients reversed around a center position between the pixels at integral positions used by said interpolation filter.

26. The image processing apparatus according to claim 26, wherein said interpolation filter further uses, in the case where different symmetry determined in advance and different from the first-mentioned symmetry is applied to the first pixel position of the fractional accuracy and the second pixel position of the fractional accuracy, also filter coefficients reversed around the center position between the pixels at the integral positions used by said interpolation filter as the filter coefficients for determining the pixel at the first pixel position of the fractional accuracy and the pixel at the second pixel position of the fractional accuracy.

27. The image processing apparatus according to claim 24, further comprising:
storage means for storing determined filter coefficients; wherein
in the case where a slice of the image of the encoding object is a slice which does not use the filter coefficients calculated by said coefficient calculation means, said interpolation filter uses the filter coefficients stored in said storage means and said motion compensation means uses the reference image interpolated by said interpolation filter of the filter coefficients stored in said storage means and the motion vector detected by said motion prediction means to produce a predicted image.

28. The image processing apparatus according to claim 24, further comprising:
encoding means for encoding a difference between the predicted image produced by said motion compensation means and the image of the encoding object and the motion vector detected by said motion prediction means.

29. An image processing method, comprising, carried out by an image processing apparatus:
carrying out motion prediction between an image of an encoding object and a reference image to detect a motion vector;
calculating filter coefficients of an interpolation filter which interpolates pixels of the reference image using the image of the encoding object, the reference image and the motion vector detected by the motion prediction means with fractional accuracy and uses, in the case where symmetry determined in advance is applied to a first pixel position of fractional accuracy and a second pixel position of the fractional accuracy, the same filter coefficient as filter coefficients for determining a pixel at the first pixel position of the fractional accuracy and another pixel at the second pixel position of the fractional accuracy;
producing a predicted image using the reference image interpolated by the interpolation filter of the calculated filter coefficients and the detected motion vector; and
selecting, based on a kind of a slice of an image of an encoding object, pixel positions of the fractional accuracy at which same filter coefficients are to be individually used for pixels in a unit of a slice.

30. A computer readable medium including computer executable instructions for causing a computer to function as:
motion prediction means for carrying out motion prediction between an image of an encoding object and a reference image to detect a motion vector;
coefficient calculation means for calculating filter coefficients of an interpolation filter which interpolates pixels of the reference image using the image of the encoding object, the reference image and the motion vector detected by said motion prediction means with fractional accuracy and uses, in the case where symmetry determined in advance is applied to a first pixel position of the fractional accuracy and a second pixel position of the fractional accuracy, the same filter coefficient as filter coefficients for determining the pixel at the first pixel position of the fractional accuracy and the pixel at the second pixel position of the fractional accuracy;
motion compensation means for producing a predicted image using the reference image interpolated by the interpolation filter of the filter coefficients calculated by said coefficient calculation means and the motion vector detected by said motion prediction means; and
selection means for selecting, based on a kind of a slice of an image of an encoding object, pixel positions of the fractional accuracy at which same filter coefficients are to be individually used for pixels in a unit of a slice.
